(19) United States
(12) Patent Application Publication
(10) Pub. No.: US 2026/0172226 A1
(43) Pub. Date: Jun. 18, 2026

(54) SYSTEMS, METHODS AND COMPUTER-READABLE MEDIA FOR DATA ENCRYPTION USING GENERATIVE AI

(71) Applicant: SHOPIFY INC., Ottawa (CA)

(72) Inventors: Neil Leonard Padgett, Toronto (CA); Eric Andrew Florenzano, San Francisco, CA (US); Ray Jayatunga, Toronto (CA); James Lepp, Ottawa (CA)

(21) Appl. No.: 19/046,137

(22) Filed: Feb. 5, 2025

Related U.S. Application Data
(60) Provisional application No. 63/733,679, filed on Dec. 13, 2024.

(51) Int. Cl. H04L 9/06

(52) U.S. Cl. CPC H04L 9/065

(57) ABSTRACT

A generative machine-learning model may be used for data encryption/decryption. In one example, a model may be configured based on at least one configuration setting. The model at an encoder may be prompted. The model may generate an array of values, each corresponding to a possible next symbol. A code word representing the index of the array at which there is a value corresponding to the next symbol of the information may be selected as an encrypted version of the symbol. The model at the decoder may be configured like the model at the encoder. The model at the decoder may be prompted. The model may generate an array of values, each corresponding to a possible next symbol. A decrypted symbol corresponding to a value at an index of the array represented by the code word may be selected.

### CROSS-REFERENCE TO RELATED APPLICATION

The present application claims the benefit of U.S. Provisional Patent Application Ser. No. 63/733,679 filed on Dec. 13, 2024, the contents of which are herein incorporated herein by reference in their entirety.

### FIELD

The present application relates to generative machine-learning models that are capable of prediction, such as large language models (LLMs), and more particularly using such models to provide data compression and/or encryption.

### BACKGROUND

In computing systems, storage space for data may be limited. Storing large amounts of data requires large amounts of available space on storage devices. The more data that needs to be stored, the higher storage costs may be. Another resource that may be limited is bandwidth to transmit information over a network. Transmitting large amounts of data over a network can result in long upload/download times, higher latency, and increased costs for network service. Additionally, accessing or processing large files may require a significant amount of computing resources. Some systems may not have enough resources available to access or process large files. Performance of systems may be negatively affected.

The effects of these problems can be reduced by compressing data into as few bits as possible. By making a large file smaller it may be less costly to store the file, it may be faster to transmit the file over a network, it may be less costly to transmit a file over a network, and performance of a system accessing the file may be improved.

In many systems it may be important that compressed information is identical to its decompressed version. For example, the smallest error in data representing financial transactions could have disproportional effects. In systems where this is important, lossless compression may be used, which requires every bit of data to be reconstructed when decompressed exactly like it was before it was compressed.

Regardless of whether or not compression is performed in some systems it may be important that data is protected, only being available to systems or actors who are authorized to access it. This may be important in systems handling data that contains sensitive data (e.g. personal information such as medical records, financial information, confidential information, etc.). When data is transmitted over a network it may be vulnerable to interception by unauthorized parties.

In order to mitigate the risk of data ending up in the hands of unauthorized parties, who may have malicious intentions, data may be encrypted, and the encrypted version of the data may be transmitted. The data may then be decrypted by only an authorized party. Encryption and decryption may be performed by many methods including symmetric encryption, where a single key, shared between and kept secret by both the sender of the data and the authorized parties, is used for both encryption and decryption. Encryption may be performed in conjunction with compression or separately.

### SUMMARY

A generative machine-learning model, such as a large language model (LLM), may be used for data compression/decompression and/or for data encryption/decryption.

In one example, a generative model capable of next symbol (e.g. next token) prediction can be used to compress data, such as text. The predictions of the generative model may be exploited in order to achieve compression. A generative model of an encoder may be prompted with at least one symbol, e.g. the first portion of the information to be compressed, and then the generative model may be relied upon to provide predictions as to the next symbols in the information to be compressed. Once prompted with at least one symbol, the generative model may generate a list of values, each corresponding to the probability of a possible next symbol being the next symbol to follow the prompt. The correct next symbol of the information to be compressed may correspond to a value in the list. Then, a code word representing the position in the list of the value corresponding to the correct next symbol may be selected. The code word may be included in a compressed version of the information in place of a full symbol. This may continue with subsequent symbols of the information with a code word obtained for each.

In another example, a generative model capable of next symbol (e.g. next token) prediction can also be used to decompress data compressed by an identically (or near-identically) configured generative model. A decoder, comprising the generative model, may obtain a prompt and a series of code words, such as code words generated as described above. The generative model may be prompted with the prompt and then may generate a list of values corresponding to the probability of a possible next symbol being the next symbol to follow the prompt. If the generative model at the decoder and the generative model at the encoder are configured such that given the same prompt they will generate the same list of values corresponding to probabilities, the first code word in the series of code word may be used to obtain its corresponding full symbol. The decoder may select, as the next symbol in a decompressed version of the information, the symbol corresponding to the value at the position in the identically ordered list represented by the code word. This may continue with subsequent code words in the series of code words.

As another example, the generative models at the encoder and decoder described above may also or instead be used to encrypt and decrypt data. The methods described above require that the generative model at the decoder and the generative model at the encoder are configured such that given the same prompt they will generate the same list of values corresponding to probabilities. Therefore, if the encoder and decoder keep at least one necessary configuration setting secret, it may be used as a basis for a secret key, as the at least one configuration setting is required to reconstruct the series of symbols from the series of code words. The code words act as the encrypted version of the symbols. An unauthorized party would not be able to decode the code words without the at least one configuration setting. In this way, at least the series of code words is encrypted information generated by the encoder and decrypted by the decoder.

In one aspect, there is provided a computer-implemented method for performing compression. The method for performing compression may include obtaining information represented as a series of symbols. The method for performing compression may further include prompting a generative model. The method for performing compression may further include determining a series of code words based on outputs of the generative model. Determining each or a code word in the series of code words may include obtaining an array comprising a plurality of values generated by the generative model. Each of the values may correspond to a respective possible next symbol in a sequence generated by the generative model. Determining each or a code word in the series of code words may further include selecting the code word representing an index of the array at which there is a value corresponding to a next symbol of the information. The method for performing compression may further include generating a compressed version of the information using the series of code words.

In some implementations, the information may include a first portion of the series of symbols and a second portion of the series of symbols. The generative model may be prompted using the first portion of the series of symbols. The second portion of the series of symbols may be represented by the series of code words. The first portion of the series of symbols may also be used to generate the compressed version of the information. In some implementations, for at least one of the code words the method may further comprise, prior to obtaining the array, prompting the generative model using the first portion and at least one symbol following the first portion. In some implementations, at least the first portion of the series of symbols may be compressed using a lossless compression method. In some implementations, the compressed version of the information may comprise at least one of: a first reserved symbol preceding the first portion indicating a start of the first portion, a second reserved symbol proceeding the first portion indicating an end of the first portion, a third reserved symbol indicating how many code words are in the series of code words, or a fourth reserved symbol proceeding the series of code words indicating an end of the series of code words.

In some implementations, each of the values in the array is indicative of a probability of the corresponding respective possible next symbol being a next symbol in the symbol sequence generated by the generative model. In some implementations, the method for performing compression may further include applying a mask to the values in the array. The mask may operate on each value that corresponds to a symbol other than the next symbol of the information to reduce or zero the probability of the corresponding symbol being the next symbol in the symbol sequence generated by the generative model. The next symbol in the symbol sequence generated by the generative model may be determined based on the values after the mask is applied.

In some implementations, a dictionary of code words may be used to determine the series of code words. The method of performing compression may further include, subsequent to determining the series of code words, and for a particular output of the generative model, determining that a code word in the dictionary cannot be used to represent the index of the array at which there is a value corresponding to the next symbol in the information. The method may further include, responsive to determining this, including the next symbol of the information, rather than a code word in the dictionary, as part of the compressed version of the information.

In some implementations, the method of performing compression may further include, prior to prompting the generative model, generating fine-tuning data that may be based on at least weighting information of the generative model and a plurality of symbols of the information. The method of performing compression may further include performing fine-tuning of the generative model based on the fine-tuning data. In some implementations, the method may further include storing or transmitting the fine-tuning data together with the compressed version of the information.

In some implementations, each of the values in the array may be indicative of a probability of the corresponding respective possible next symbol being a next symbol in the symbol sequence generated by the generative model. The method of performing compression may further include identifying a set of highest probable values in the array. The set of highest probable values may contain a number of vales equal to a number of code words in a code word dictionary. The next symbol of the information may correspond to one of the values in the set of highest probable values.

In some implementations, the method of performing compression may further include configuring the generative model based on at least one configuration setting. The method may further include storing or transmitting the at least one configuration setting along with the compressed version of the information.

In another aspect, there is provided a computer-implemented method for performing decompression. The method for performing decompression may include obtaining information comprising a series of code words. The method for performing decompression may further include performing decompression of the information. Performing decompression of the information may include prompting a generative model. Performing decompression of the information may further include determining a series of symbols based on outputs of the generative model. Determining each or a symbol in the series of symbols may include obtaining an array comprising a plurality of values generated by the generative model. Each of the values may correspond to a respective possible next symbol in a sequence generated by the generative model. Determining each or a symbol in the series of symbols may further include selecting the symbol corresponding to a value at an index of the array. The index of the array may be represented by a next code word in the series of code words. Performing decompression of the information may further include generating a decompressed version of the information using the series of symbols.

In some implementations, the information may include a first portion and a second portion. The generative model may be prompted using the first portion. The second portion may comprise the series of code words. The decompressed version of the information may be generated using both the first portion and the series of symbols. In some implementations, for at least one of the symbols in the series of symbols, the method may further comprise, prior to obtaining the array, prompting the generative model using the first portion and at least one symbol following the first portion. In some implementations, the information may comprise at least one of: a first reserved symbol preceding the first portion indicating a start of the first portion, a second reserved symbol proceeding the first portion indicating an end of the first portion, a third reserved symbol indicating how many code words are in the series of code words, or a fourth reserved symbol proceeding the series of code words indicating an end of the series of code words.

In some implementations, each of the values in the array is indicative of a probability of the corresponding respective possible next symbol being a next symbol in the symbol sequence generated by the generative model. In some implementations, the method for performing decompression may further include applying a mask to the values in the array. The mask may operate on each value at an index of the array other than the index of the array represented by the next code word to reduce or zero the probability of the corresponding symbol being the next symbol in the symbol sequence generated by the generative model. The next symbol in the symbol sequence generated by the generative model may be determined based on the values after the mask is applied.

In some implementations, the method of performing decompression may further include, subsequent to determining the series of symbols, obtaining a particular symbol from the information rather than a code word. The method of performing decompression may further include prompting the generative model using at least the first portion and the particular symbol.

In some implementations, the method of performing decompression may further include, prior to prompting the generative model, obtaining fine-tuning data that may be based on at least weighting information of the generative model. The method of performing decompression may further include performing fine-tuning of the generative model based on the fine-tuning data. In some implementations, the fine-tuning data may be obtained together with the information.

In some implementations, obtaining the information may include obtaining an at least partially compressed version of the information. Obtaining the information may further include performing decompression of the at least partially compressed version of the information using a lossless decompression method in order to obtain the information.

In some implementations, each of the values in the array is indicative of a probability of the corresponding respective possible next symbol being a next symbol in the symbol sequence generated by the generative model. The method of performing decompression may further include identifying a set of highest probable values in the array. The set of highest probable values may contain a number of vales equal to a number of code words in a code word dictionary. The selected symbol may correspond to one of the values in the set of highest probable values.

In some implementations, the method of performing decompression may further include obtaining at least one configuration setting for the generative model. The method of performing decompression may further include, prior to prompting the generative model, applying the at least one configuration setting to the generative model.

In another aspect, there is provided a computer-implemented method for performing encryption. The method for performing encryption may include configuring a generative model based on at least one configuration setting. The method for performing encryption may further include obtaining information represented as a series of symbols. The method for performing encryption may further include encrypting at least some of the information. Encrypting at least some of the information may include prompting the generative model. Encrypting at least some of the information may further include determining a series of code words based on outputs of the generative model. Each code word may be an encrypted respective symbol of the information. Determining each or a code word in the series of code words may include obtaining an array comprising a plurality of values generated by the generative model. Each of the values may correspond to a respective possible next symbol in a sequence generated by the generative model. Determining each or a code word in the series of code words may further include selecting the code word representing an index of the array at which there is a value corresponding to a next symbol of the information.

In some implementations, the information may include a first portion of the series of symbols and a second portion of the series of symbols. The generative model may be prompted using the first portion of the series of symbols. The second portion of the series of symbols may be represented by the series of code words. The method of performing encryption may further include encrypting the first portion of the series of symbols. In some implementations, the method of performing encryption may further include obtaining a secret key representative of the at least one configuration setting. The secret key may be used to at least encrypt the first portion of the series of symbols. In some implementations, obtaining the secret key may comprise obfuscating at least some of the at least one configuration setting. In some implementations, the generative model may be a first instance of a generative model. The method of performing encryption may further include securely providing the secret key to a decoder implementing a second instance of the generative model.

In some implementations, the at least one configuration setting, when applied to an instance of the generative model, may influence outputs of the generative model. In some implementations, the at least one configuration setting may comprise at least one of a temperature value, a generation seed, a presence penalty, a frequency penalty, or a quantization parameter. In some implementations, the at least one configuration setting may comprise a temperature value of zero.

In some implementations, the method of performing encryption may further include, prior to prompting the generative model, generating fine-tuning data that may be based on at least weighting information of the generative model and a plurality of symbols of the information. The method of performing encryption may further include performing fine-tuning of the generative model based on the fine-tuning data. In some implementations, the plurality of symbols of the information may comprise an initial portion of the information. In some implementations, the plurality of symbols of the information may comprise sampled symbols of the information.

In some implementations, the method of performing encryption may further include obtaining an identifier corresponding to a particular set of configuration settings. The method of performing encryption may further include determining the particular set of configuration settings corresponding to the identifier. The at least one configuration setting may comprise the particular set of configuration settings.

In another aspect, there is provided a computer-implemented method for performing decryption. The method for performing decryption may include configuring a generative model based on at least one configuration setting. The method for performing decryption may further include obtaining information comprising a series of code words. The method for performing decryption may further include decrypting the series of code words. Decrypting the series of code words may include prompting the generative model. Decrypting the series of code words may further include determining a series of symbols based on outputs of the generative model. Each symbol may be a decrypted respective code word. Determining each or a symbol in the series of symbols may include obtaining an array comprising a plurality of values generated by the generative model. Each of the values may correspond to a respective possible next symbol in a sequence generated by the generative model. Determining each or a symbol in the series of symbols may further include selecting the symbol corresponding to a value at an index of the array. The index of the array may be represented by a next code word in the series of code words.

In some implementations, the information may include a first portion and a second portion. The second portion may comprise the series of code words. The method of performing decryption may further include decrypting the first portion. The generative model may be prompted using the first portion after decryption of the first portion. In some implementations, the method of performing decryption may further include obtaining a secret key representative of the at least one configuration setting. The secret key may be used to at least decrypt the first portion. In some implementations, obtaining the secret key may comprise obfuscating at least some of the at least one configuration setting. In some implementations, the generative model may be a second instance of the generative model. Obtaining the secret key may comprise securely receiving the secret key from an encoder implementing a first instance of the generative model.

In some implementations, the at least one configuration setting, when applied to an instance of the generative model, may influence outputs of the generative model. In some implementations, the at least one configuration setting may comprise at least one of a temperature value, a generation seed, a presence penalty, a frequency penalty, or a quantization parameter. In some implementations, the at least one configuration setting may comprise a temperature value of zero.

In some implementations, the method of performing decryption may further include, prior to prompting the generative model, obtaining fine-tuning data that may be based on at least weighting information of the generative model. The method of performing decryption may further include performing fine-tuning of the generative model based on the fine-tuning data. In some implementations, the fine-tuning data may be obtained together with the information. In some implementations, the fine-tuning data may be encrypted. The method of performing decryption may further include, prior to performing fine-tuning of the generative model, decrypting the fine-tuning data.

In some implementations, the method of performing decryption may further include obtaining an identifier corresponding to a particular set of configuration settings. The method of performing decryption may further include determining the particular set of configuration settings corresponding to the identifier. The at least one configuration setting may comprise the particular set of configuration settings.

In another aspect, there is provided a computer readable medium having stored thereon computer-executable instructions that, when executed by a computer, cause the computer to perform any of the methods disclosed herein. The computer readable medium may be non-transitory.

In another aspect, a system is provided that is configured to perform the methods disclosed herein. For example, the system may include at least one processor and a memory storing processor-executable instructions that, when executed by the at least one processor, cause the system to perform any of the methods disclosed herein.

### BRIEF DESCRIPTION OF THE DRAWINGS

Embodiments will be described, by way of example only, with reference to the accompanying figures wherein:

FIG. 1A is a simplified block diagram of an example simplified convolutional neural network;

FIG. 1B is a simplified block diagram of an example transformer neural network;

FIG. 2 is a block diagram of an example computing system;

FIG. 3 illustrates an example system for compressing and decompressing data using a generative model.

FIG. 4 illustrates an example state diagram for the encoder system of FIG. 3.

FIG. 5 illustrates an example method performed by the encoder system of FIG. 3.

FIG. 6 illustrates an example method of representing information to be compressed as a series of symbols.

FIGS. 7 to 12 illustrate examples corresponding to steps of the method of FIG. 5.

FIG. 13 illustrates an example state diagram for the decoder system of FIG. 3.

FIG. 14 illustrates an example method performed by the decoder system of FIG. 3.

FIGS. 15 to 20 illustrate examples corresponding to steps of the method of FIG. 14.

FIG. 21 illustrates an example system for encryption and decryption of data using a generative model.

FIG. 22 illustrates an example method performed by the encryption system of FIG. 21.

FIG. 23 illustrates an example method of generating an encrypted version of information.

FIG. 24 illustrates an example method performed by the decryption system of FIG. 21.

### DETAILED DESCRIPTION

For illustrative purposes, specific embodiments will now be explained in greater detail below in conjunction with the figures.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

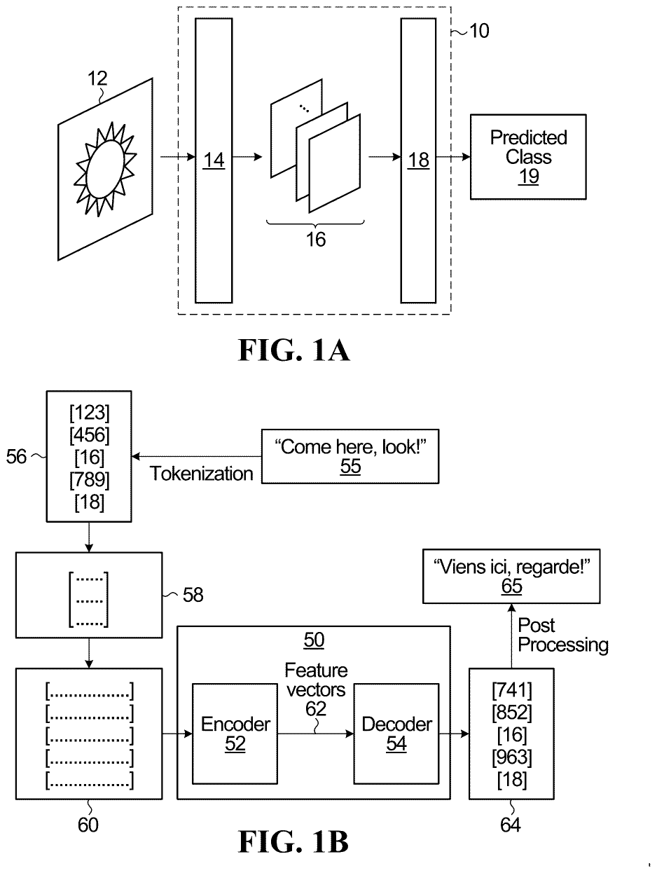

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc. In the context of other data formats (e.g. images, video frames etc.), data may also be parsed into a sequence of tokens that represent the data.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

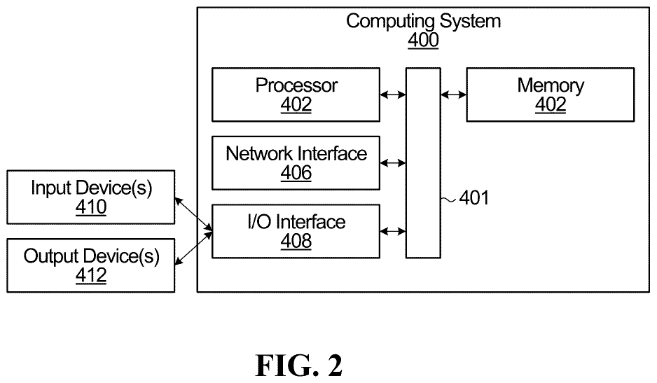

FIG. 2 illustrates an example computing system 400, which may be used to implement examples of the present disclosure, such as a prompt generation engine to generate prompts to be provided as input to a language model such as a LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### Data Compression and/or Encryption Using Generative AI

Generative AI, such as the LLM described above, or another LLM or generative machine-learning model, may be used to perform compression/decompression and/or encryption/decryption.

As described above, in many computing systems, it may be desirable for data to be made smaller. A smaller amount of data may consume less storage space, may require less bandwidth to be transmitted over a network, and may require fewer computing resources to access or process. In some systems it may be important that data is protected, only being available to entities who are authorized to access it. To address these problems compression and encryption may be used respectively.

The LLM discussed above is an example of a generative model. A generative model is a model that utilizes machine learning to generate content, e.g. in response to an input prompt. A generative model does not need to be limited to a generative language model such as an LLM. For example, a generative model might additionally or instead generate other content, e.g. an image or multimedia that includes more than just language.

In some implementations, a generative model capable of next symbol (e.g. next token) prediction may be used to compress data, such as text. The predictions of the generative model may be exploited in order to achieve compression. In one example, a generative model of an encoder may be prompted with at least one symbol from the input text and then the generative model may be relied upon to provide predictions as to the next symbols in the input text. These predictions may comprise values where each value indicates the probability of a corresponding symbol being the next symbol in a sequence of symbols generated by the generative model. The prompting may be referred to as “priming”, and the one or more symbols used as part of the prompt may be referred to as the “priming symbols”. If the priming symbols were then transmitted to an identically (or near-identically) configured generative model at a decoder to be decompressed, with randomness of the model suppressed or mitigated so that the model is (or is more) deterministic (e.g., temperature is set to 0), that generative model would make the same predictions as the generative model at the encoder did. So, instead of sending every symbol in the input text, only a first portion of the symbols needs to be transmitted, along with an indication that each predicted next symbol is correct.

The term “identically configured” as used herein means that the generative model at the encoder and the generative model at the decoder will produce the same or substantially the same output when provided the same input. This may be achieved by ensuring that every setting that can be configured is always configured to the same value at both the encoder side and decoder side, although this need not always be the case. For example, one or more configuration settings at both the encoder and decoder may be different or slightly different if it does not impact the outputs of the generative model.

The phrase “the same or substantially the same output” as used herein means that the portion(s) of the output of both generative models that is relevant to the methods described herein is the same. For example, the generative models may output slightly different ordering for extremely low probability predictions, e.g. due to hardware differences, but as these predictions are not relevant for the methods described herein, the generative models will be considered to produce substantially the same output. In another example, the values output by the generative models may differ, but as long as the ordering of the relevant corresponding symbols is the same in each output, e.g. the top 16 most probable next symbols are the same in each output, the outputs of the generative model will be considered to produce substantially the same output.

The technique described above of transmitting only a first portion of the symbols, along with an indication that each predicted next symbol is correct, may only achieve minimal or poor compression. The prediction provided by the generative model (e.g., the symbol having the highest associated predicted probability of occurring next) often may not be the correct next symbol in the input text. This inexact/poor accuracy prediction may limit the amount of compression that can be achieved if the technique is reliant on the generative model always making the top prediction. However, the correct next symbol may often be within a limited set of the highly probable predictions, e.g. the top 8 or 16 most probable next symbols. To address the technical problem of inexact prediction explained above, and to therefore assist in achieving a more desirable compression ratio, in one example a system treats a list of predictions generated by the generative model as a dynamic dictionary. The system may generate a series of code words, where each code word corresponds to a symbol of the information to be compressed and acts as a compressed version of that symbol. Instead of mapping each code word to a particular symbol in a dictionary, a given code word may represent a position in the list of predicted possible next symbols generated by the generative model, which in turn may be mapped to any symbol in the dictionary.

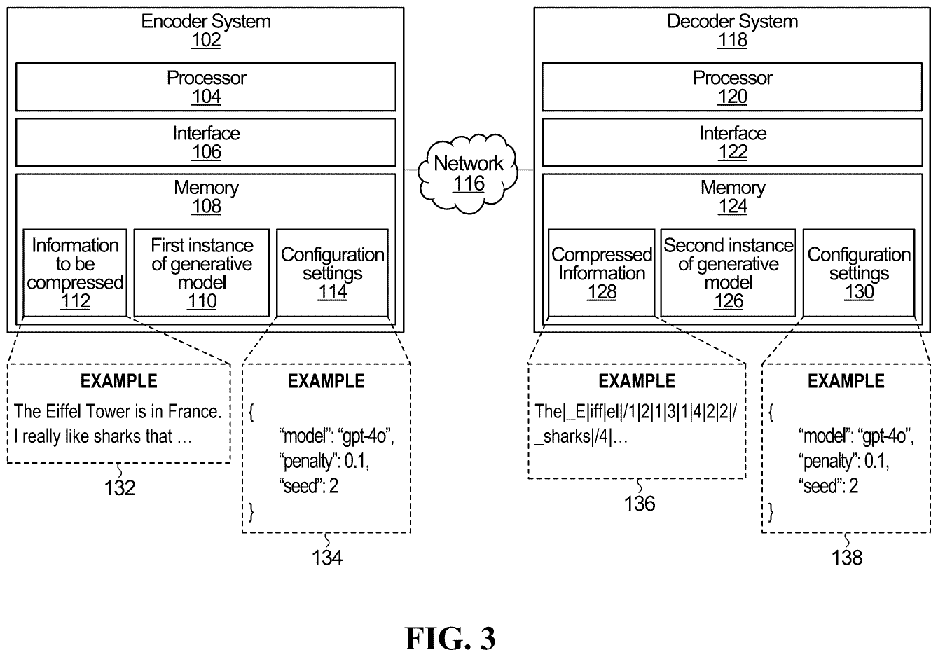

FIG. 3 illustrates an example system for compressing and decompressing data using a generative model. The system includes an encoder system 102, alternatively referred to as an encoder. The encoder system 102 includes a processor 104, a memory 108, and an interface 106. The processor 104 controls the operations of the encoder system 102. The processor 104 may be implemented by one or more processors that execute instructions stored in the memory 108. Alternatively, some or all of the processor 104 may be implemented using dedicated circuitry, such as an application specific integrated circuit (ASIC), a graphics processing unit (GPU), or a programmed field programmable gate array (FPGA). The memory 108 stores information (e.g. content and/or instructions, etc.). The interface 106 interfaces with a network 116 to perform communication (transmit/receive) over the network 116. The network 116 may be, for example, the Internet or an Intranet or local network. The structure of the interface 106 will depend on how the encoder system 102 interfaces with the network 116. For example, if the encoder system 102 is connected to the network 116 with a network cable, the interface 106 may comprise a network interface card (NIC), and/or a computer port (e.g. a physical outlet to which a plug or cable connects), and/or a network socket, etc. If the encoder system 102 is part of a wireless device, such as a mobile phone or laptop, the interface 106 might be or include a transmitter/receiver with an antenna to send and receive wireless transmissions to/from the network 116.

In some implementations, the encoder system 102 may be distributed, e.g. it may comprise one or more servers or computing devices, in which case processor 104 might actually consist of multiple processors communicating with each other over a communication link (e.g. over a network), and similarly memory 108 might be distributed across multiple servers or computing devices.

In the example system, the memory 108 further stores a first instance of a generative model, referred to as generative model 110. By “storing” the generative model 110, it is meant that the parameters and other values that make up the model and that are required for execution of the model are stored. The parameters depend upon how the generative model 110 is implemented. For example, assuming the generative model 110 utilizes one or more neural networks, the weights and biases of the one or more neural networks are stored.

The generative model 110 may be implemented as or using an LLM. In some implementations, generative model 110 may have the example LLM structure described earlier in relation to FIG. 1B, or it may have another structure. The exact structure of the generative model 110 is implementation specific, although in the example system of FIG. 3 it is assumed that the generative model 110 has at least one neural network. The generative model 110 may generate thousands of different symbols, or more. A “symbol”, as used herein, refers to a unit of output from a generative model. For example, a symbol may be a token, or a segment or chunk of text, or one or more pixels, or one or more characters, or a numerical representation of characters or text, such as American standard code for information interchange (ASCII) or Unicode characters, etc. In some implementations, the generative model 110 may have a symbol (e.g. token) dictionary, comprising a list of symbols which may be generated by the generative model 110. Each symbol (e.g. token) in the dictionary may represent a piece of a word or a word and may also include trailing spaces or sub-words.

Textual data may be transformed into symbols (e.g. tokens) by a process of tokenization. Generative models (e.g. generative model 110) may have a corresponding tokenization scheme. A tokenization scheme may operate by splitting an input text into smaller segments, each one a symbol. A tokenization scheme (e.g. a scheme employing subword tokenization) may keep commonly used words found in the input text together as a complete symbol (e.g. “slow” may be a represented within a single symbol) while decomposing less common words into subwords (e.g. “slowly” may be represented by two symbols where one represents “slow” and a second represents “ly”). Each symbol may additionally include non-word content of the input text such as whitespace and/or punctuation. Some tokenization schemes may have more than one tokenization algorithm, e.g. more than one way to tokenize the same input text. Generative models (e.g. generative model 110) may use vectors (e.g. embeddings) to represent tokens. These vectors may be stored in a matrix where each row of the matrix corresponds to a vector representation of a token. The vectors (e.g. embeddings) may capture semantic meanings of tokens and/or relationships between tokens.

The generative model 110 may be implemented by the processor 104. In some implementations, the processor 104 may be a specialized processing unit, e.g. one designed to accelerate computer operations of a generative model through parallelization of operations, which may allow for faster execution of the generative model compared to a more general-purpose processing unit. For example, the processor 104 may be or include a GPU or a tensor processing unit (TPU) or a neural processing unit (NPU) or a hardware accelerator. In some implementations, the processor 104 may comprise a specialized processing unit paired with a general-purpose processing unit, e.g. a computer, central processing unit (CPU), and/or other computing device such as a server. In some implementations, the processor 104 will be monolithic such as, for example, a single computing device or a single integrated circuit of such a device. However, this is not required. In other implementations, the processor 104 may comprise one or more computing devices acting in cooperation. For example, the processor 104 may consist of a general purpose computing device (e.g., a conventional server) communicatively coupled to a specialized computing device adapted for execution of generative models.

In some implementations, the generative model 110 may be stored/executed separately, not on the encoder system 102. This, for example, may be another form of arrangement involving cooperating computing devices. In a particular example, the encoder system 102 may communicate with the generative model 110 by sending prompts over a network, e.g. network 116, via a generative model interface, e.g. interface 106 (which may be an API), to the generative model 110 and receiving response back from the generative model 110. In some implementations, the generative model 110 may be provided by a software-as-a-service (SaaS) provider, e.g. OpenAI™, Microsoft Azure™, etc.

The memory 108 may further store information to be compressed 112. Information to be compressed 112 may be text, or a representation of text, represented as a series of symbols. Information to be compressed 112 may be represented as a series of symbols where each symbol is found in the symbol dictionary of generative model 110. The example information to be compressed shown in box 132 is a string (“The Eiffel Tower is in France. I really like sharks that . . . ”). In the example shown in box 132, the information to be compressed is truncated, i.e. the “. . . ” represents additional text that is not illustrated for ease of explanation. In some implementations, the information to be compressed 112 may be represented by bits. In some implementations, the information to be compressed 112 may be represented as a series of symbols, where each symbol is represented by one or more bits, e.g. 16 bits per symbol. In some implementations, information to be compressed 112 may be stored somewhere other than memory 108. For example, information to be compressed 112 may be stored in an external data source and may be accessed by encoder system 102 over a network, e.g. network 116, via an interface, e.g. interface 106.

The memory 108 may further store configuration settings 114. Configuration settings 114 may comprise at least one configuration setting for a generative model. In some implementations, the generative model 110 is configured based on the configuration settings 114. Examples of configuration settings 114 may include settings that control the length, style, and/or content output from the generative model, e.g. maximum or minimum number of tokens, and/or randomness/entropy of the output (e.g. temperature, top_k, top_p, min_p, entropix, varentropy, etc.), and/or a stopping criteria, and/or a generation seed (such that if the same seed is used, the model returns the same output), and/or a quantization parameter etc. The temperature parameter, minimum length of the output and/or maximum length of the output, the frequency penalty parameter, and the “best of” parameter discussed earlier are examples of configuration settings. Sampler parameters are examples of configuration settings.

In some implementations, the configuration settings 114 may comprise fine-tuning data for a generative model. Fine-tuning data may comprise weights and/or biases. Fine-tuning data may comprise a set of model weights or a layer of a neural network. In some implementations, fine-tuning data may comprise at least one instance of a low-rank adaptation model (LoRA).

A computer system, e.g. the system of FIG. 3, may use LoRAs to customize LLM text generation. LoRAs are models with a significantly lower rank than an LLM (e.g., having hundreds of parameters instead of hundreds of billions of parameters) but that when applied to an LLM modify parameters of the LLM. Given their smaller rank, it can be faster to train LoRAs than to fine-tune an LLM, and the LoRAs typically have a smaller size than the fine-tuned model. In at least some cases, LoRAs can perform better than fine-tuned LLMs when generating text with desired properties. Accordingly, the use of LoRAs to modify an LLM can enable flexible customization of the LLM for a desired purpose. In particular, each LoRA model includes a set of weights that are configured to modify parameters of the LLM to cause the LLM to generate text having a specified property. LoRAs are generally composable, meaning that multiple LoRAs can be applied to an LLM at the same time to change multiple properties of the LLM-generated text. A plurality of LoRA models can be trained based on different text properties, such that each of the trained LoRA models when applied to an LLM will cause the LLM to produce text with a certain property.

In some implementations, the configuration settings 114 may comprise an identifier that corresponds to a particular set of configuration settings and/or a particular instance of fine-tuning data that is accessible to the encoder system 102. For example, the particular set of configuration settings and/or particular instance of fine-tuning data may be stored in memory 108.

Stippled box 134 (which has a dashed border) shows an example of configuration settings 114. In this example, configuration settings 114 are represented with JSON and comprise key value pairs that define a version of the model, a penalty, and a generation seed. When these configuration settings are applied to the generative model 110, the outputs of generative model 110 are influenced. In the illustrated example, configuration settings 114 are represented with JSON. However, other representations are possible. For example, configuration settings 114 may be represented by any data record with fixed fields and/or by data in a defined order with delimiters, e.g. configuration settings 114 may be represented using Avro, XML, protocol buffers, MessagePack, etc.

The system of FIG. 3 further includes a decoder system 118 (alternatively referred to as a decoder) which may communicate with encoder system 102 via network 116. In some implementations, the encoder system 102 and the decoder system 118 may communicate in another way. In some implementations, encoder system 102 and decoder system 118 may form part of the same system. For example, information may be compressed using encoder system 102, may be stored (e.g. on a disk), and then may be retrieved from storage by decoder system 118.

The decoder system 118 includes a processor 120, a memory 124, and an interface 122. The processor 120 controls the operations of the decoder system 118. The processor 120 may be implemented by one or more processors that execute instructions stored in the memory 124. Alternatively, some or all of the processor 120 may be implemented using dedicated circuitry, such as an application specific integrated circuit (ASIC), a graphics processing unit (GPU), or a programmed field programmable gate array (FPGA). The memory 124 stores information (e.g. content and/or instructions, etc.). The interface 122 interfaces with network 116 to perform communication (transmit/receive) over the network 116. The structure of the interface 122 will depend on how the decoder system 118 interfaces with the network 116. For example, if the decoder system 118 is connected to the network 116 with a network cable, the interface 122 may comprise a network interface card (NIC), and/or a computer port (e.g. a physical outlet to which a plug or cable connects), and/or a network socket, etc. If the decoder system 118 is part of a wireless device, such as a mobile phone or laptop, the interface 122 might be or include a transmitter/receiver with an antenna to send and receive wireless transmissions to/from the network 116.

In some implementations, the decoder system 118 may be distributed, e.g. it may comprise one or more servers or computing devices, in which case processor 120 might actually consist of multiple processors communicating with each other over a communication link (e.g. over a network), and similarly memory 124 might be distributed across multiple servers or computing devices.

In the example system, the memory 124 further stores a second instance of a generative model, referred to as generative model 126. By “storing” the generative model 126, it is meant that the parameters and other values that make up the model and that are required for execution of the model are stored. The parameters depend upon how the generative model 126 is implemented. For example, assuming the generative model 126 utilizes one or more neural networks, the weights and biases of the one or more neural networks are stored.

“First instance of a generative model” and “second instance of a generative model” are used herein to mean separate implementations of the same generative model that are configured in the same way, such that given the same input they produce the same or substantially the same output. Each instance may be stored separately. Each instance may be accessed independently and may take a different form. For example, one instance of the generative model might be stored in memory and accessed directly while another instance of the generative model is accessed via a third-party API.

The generative model 126 may be implemented as an LLM. In some implementations, generative model 126 may have the example LLM structure described earlier in relation to FIG. 1B, or it may have another structure. The exact structure of the generative model 126 is implementation specific, although in the example decoder system 118 of FIG. 3 it is assumed that the generative model 126 has at least one neural network. The generative model 126 may generate thousands of different symbols, or more. In some implementations, the generative model 126 may have a symbol (e.g. token) dictionary, comprising a list of symbols which may be generated by the generative model 126.

The generative model 126 may be implemented by the processor 120. In some implementations, the processor 120 may be a specialized processing unit, e.g. one designed to accelerate computer operations of a generative model through parallelization of operations, which may allow for faster execution of the generative model compared to a more general-purpose processing unit. For example, the processor 120 may be a GPU or a tensor processing unit (TPU) or a neural processing unit (NPU) or a hardware accelerator. In some implementations, the processor 120 may comprise a specialized processing unit paired with a general-purpose processing unit, e.g. a computer, central processing unit (CPU), and/or other computing device such as a server.

In some implementations, the generative model 126 may be stored separately, not on the decoder system 118. For example, the decoder system 118 may communicate with the generative model 126 by sending prompts over a network, e.g. network 116, via a generative model interface, e.g. interface 122 (which may be an API), to the generative model 126 and receiving response back from the generative model. In some implementations, the generative model 126 may be provided by a software-as-a-service (SaaS) provider, e.g. Open AI™, Microsoft Azure™, etc.

The memory 124 may further store compressed information 128. The compressed information may be a string, e.g. a string of bits representing symbols and/or code words. The compressed information 128 may comprise at least one series of code words. A series of code words may be represented by bits. For example, each code word may comprise a fixed number of bits. The series of code words may be represented by a data structure. For example, the series of code words may be a tree generated by applying a variable length encoding method, e.g. Huffman coding, to a series of values. In some implementations, the compressed information 128 may additionally comprise at least one symbol. Each symbol may represent a word, a portion of a word, or some other portion of data. For example, the compressed information 128 may comprise at least one symbol representing a portion of the information to be compressed 112 used to prime generative model 110. In some implementations, the compressed information 128 may comprise a portion of the information to be compressed 112 represented in a format other than a series of symbols, e.g. represented as plaintext. In some implementations, the compressed information 128 may comprise an encoded version of a portion of the information to be compressed 112 used to prime generative model 110.

In some implementations, the compressed information 128 may include at least one reserved symbol. The at least one reserved symbol may be used to represent the length of a series of symbols and/or the length of a series of code words. In some implementations, a reserved symbol may be inserted in the compressed information 128 to indicate at least one of the start and end of a series and therefore the length of the series. In some implementations, the reserved symbol may represent a numerical value corresponding to the length of a series. In some implementations, another method of indicating the length of a series of symbols and/or a series of code words may be used.

In some implementations, compressed information 128 may be stored somewhere other than memory 124. For example, compressed information 128 may be stored in an external data source and may be accessed by decoder system 118 over a network, e.g. network 116, via an interface, e.g. interface 122.

One example of compressed information 128 is shown in stippled box 136. In the example, the compressed information comprises a first series of priming symbols, followed by a first reserved symbol (“/”) indicating the length of the first series of priming symbols, followed by a first series of code words, followed by a second reserved symbol (“/”) indicating the length of the first series of code words, followed by a second series of priming symbols (“sharks”), followed by a third reserved symbol (“/”) indicating the length of the second series of code words, followed by the start of a second series of code words. The use of “/” to represent all four reserved symbols is merely an example. Other reserved symbols may be used, e.g. those in forms similar to “<|reserved_special_token_0|>”. In some implementations, each of the first, second, third, and fourth reserved symbols may each be represented differently, e.g. with different symbols. In some implementations, each reserved symbol may comprise more than one symbol. The choice of reserved symbols may be based at least in part on the encoding scheme used.

In the example shown in stippled box 136, the first series of priming symbols comprises four symbols which break down as follows: “The|_E|iff|el|”, where “|” is used herein to delineate an end of a symbol and the end of a code word, and “_” is used herein to indicate a blank space. The use of “|” and “_” in the illustrated examples are merely depictions in the drawings used to aid in understanding. Other delimiters may be used to indicate the end of a symbol and or code word. Blank spaces may be indicated in a different way. This corresponds to the first portion of the example information to be compressed shown in stippled box 132. In the example shown in stippled box 136, the first series of code words comprises eight code words, each represented by a single digit integer (i.e. the series is 1, 2, 1, 3, 1, 4, 2, 2). Each code word in the example first series of code words corresponds to a symbol of the example information to be compressed 112 shown in stippled box 132. For example, the first code word in the series (“1”) corresponds to the symbol “_Tower|”, and the second code word in the series (“2”) corresponds to the symbol “_is|”. In the example shown in stippled box 136, the second series of priming symbols includes only the symbol “_sharks”, which corresponds to the symbol of the example information to be compressed 112 shown in stippled box 132 that immediately follows the symbols represented by the first series of code words. In the example shown in stippled box 136, the second series of code words only contains one code word (“4”) which corresponds to the symbol “_that” as this symbol immediately follows the symbol “_sharks” in the example information to be compressed shown in stippled box 132.

The memory 124 may further store configuration settings 130. Configuration settings 130 may comprise at least one configuration setting for a generative model. In some implementations, the generative model 126 is configured based on the configuration settings 130. Examples of configuration settings 130 may include settings that control the length, style, and/or content output from the generative model, e.g. maximum or minimum number of tokens, and/or randomness of the output (e.g. temperature), and/or a stopping criteria, and/or a generation seed (such that if the same seed is used, the model returns the same output), and/or a quantization parameter etc. The temperature parameter, minimum length of the output and/or maximum length of the output, the frequency penalty parameter, and the “best of” parameter discussed earlier are examples of configuration settings. In some implementations, the configuration settings 130 may comprise fine-tuning data for a generative model. Fine-tuning data may comprise weights and/or biases. In some implementations, the configuration settings 130 may comprise an identifier that corresponds to a particular set of configuration settings and/or a particular instance of fine-tuning data that is accessible to the decoder system 118. For example, the particular set of configuration settings and/or particular instance of fine-tuning data may be stored in memory 124. In some implementations, fine-tuning data, e.g. at least one LoRA, may be accessible by both encoder system 102 and decoder system 118. For example, if a particular LoRA is stored in memory 124 the same LoRA may be stored in memory 108.

Stippled box 138 shows an example of configuration settings 130. In this example, configuration settings 130 are represented with JSON and comprise key value pairs that define a version of the model, a penalty, and a generation seed. When these configuration settings are applied to the generative model 126, the outputs of generative model 126 are influenced. In the illustrated example, configuration settings 130 are represented with JSON. However, other representations are possible. For example, configuration settings 130 may be represented by any data record with fixed fields and/or by data in a defined order with delimiters, e.g. configuration settings 130 may be represented using Avro, XML, protocol buffers, MessagePack, etc.

To ensure that the generative model 110, of the encoder system 102, and the generative model 126, of the decoder system 118, produce the same or substantially the same output when given the same input, configuration settings 114 may comprise the same information as configuration settings 130. An example of this is shown in stippled box 134 and stippled box 138.

Encoder system 102 and decoder system 118 may communicate with each other over network 116. In some implementations, decoder system 118 may receive compressed information 128 from encoder system 102 via network 116. In some implementations, decoder system 118 may receive configuration settings 130 from encoder system 102 via network 116. In some implementations, encoder system 102 may compress the information to be compressed 112 to generate a compressed version of the information, and then transmit the compressed version of the information to decoder system 118 via network 116. In some implementations, encoder system 102 may transmit configuration settings 114 to decoder system 118 via network 116. In some implementations, encoder system 102 may broadcast compressed information 128 and/or configuration settings 114 to a multiplicity of decoder systems 118 via network 116.

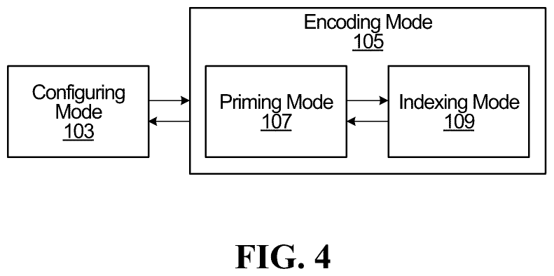

FIG. 4 illustrates an example state diagram for the encoder system 102 of FIG. 3. While performing the methods disclosed herein the encoder system 102 may be in a specific state. The encoder system 102 may be in configuring mode 103 when applying configuration settings 114, including fine-tuning data, to generative model 110. The encoder system 102 may be in encoding mode 105 when performing compression on information to be compressed 112. As in the illustrated example, encoding mode 105 may comprise nested states, namely priming mode 107 and indexing mode 109. Encoder system 102 may be in priming mode 107 when prompting generative model 110 and indexing mode 109 when generating code words. These states and the transitions between them will be further described below.

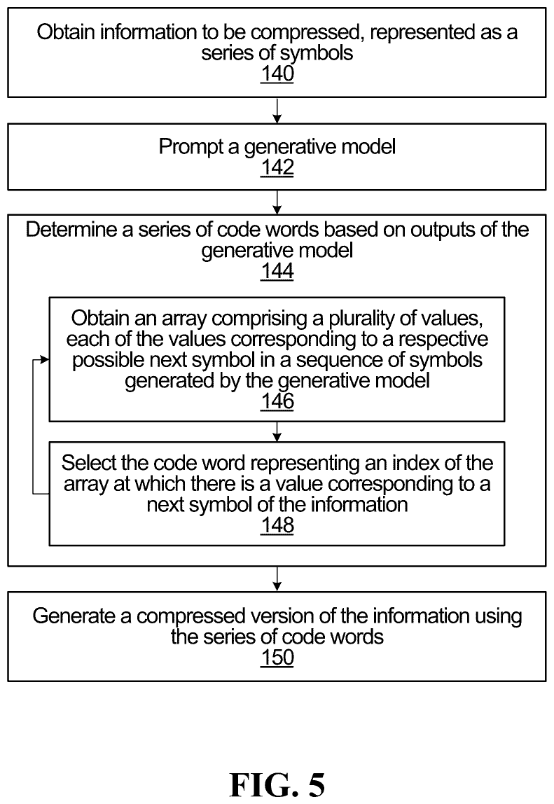

FIG. 5 illustrates an example method performed by encoder system 102. In the example method, the encoder system 102 performs lossless compression of the information to be compressed 112 by representing at least some of the information as a series of codewords, where each codeword can be represented by fewer bits (e.g. just three bits) compared to the number of bits required to represent each symbol of the original information.

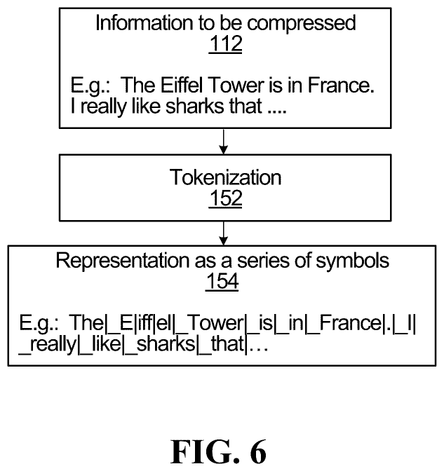

At step 140, the encoder system 102 obtains information to be compressed 112, represented as a series of symbols. In some implementations, the encoder system 102 may obtain information to be compressed 112 and then obtain its representation as a series of symbols. For example, a symbol may be a token, and the information may be represented as a series of symbols by tokenizing the information using the vocabulary of generative model 110. In the example of FIG. 6, information to be compressed 112 is a string of text, not represented as a series of symbols. Then, at tokenization step 152, this string is divided to become representation as a series of symbols 154, where “|” is used to delineate an end of a symbol, and “_” is used to indicate a blank space. The use of “|” and “_” in the illustrated examples are merely depictions used in the drawings to aid in understanding. Other delimiters may be used to indicate the end of a symbol and/or blank spaces may be indicated in a different way. The symbols determined at tokenization step 152 may be symbols found in the symbol dictionary of generative model 110. In some implementations, the information to be compressed 112 may be tokenized in stages. For example, only a first portion of the information to be compressed 112 may be tokenized before compression starts with subsequent portions of the information being tokenized on the fly, before compression of each subsequent portion. If the tokenization using the vocabulary of generative model 110 provides more than one way to tokenize input text (e.g. tokenization is non-deterministic), either the decoder system 118 must tokenize in the same way or any priming symbols received by decoder system 118 must have already been tokenized.

At step 142, the encoder system 102 prompts generative model 110. In some implementations, the generative model 110 may be prompted with a first portion of the information to be compressed 112. In some implementations, the generative model 110 may be prompted with a different series of symbols. While prompting generative model 110, the encoder system 102 may be in priming mode 107.

At step 144, the encoder system 102 determines a series of code words based on outputs of generative model 110. In some implementations, the encoder system 102 may determine more than one series of code words. While generating code words, the encoder system 102 may be in indexing mode 109.

Encoder system 102 may have a list of acceptable code words, referred to herein as a dictionary of code words. The term “code word” as used herein means any representation of which index of the array a particular symbol of the information is mapped to. In some implementations, a single code word may be a combination of more than one code word in the dictionary of code words. In some implementations, a plurality of symbols of the information may be represented by the same code word.

At sub-step 146, to determine a code word (e.g. each code word) in the series of code words, the encoder system 102 obtains an array comprising a plurality of values, each of the values corresponding to a respective possible next symbol in a sequence of symbols generated by the generative model 110. In some implementations, each of plurality of values in the array may be indicative of a probability of the corresponding respective possible next symbol being a next symbol in the symbol sequence generated by the generative model 110.

In some implementations, the array obtained at sub-step 146 may be processed (e.g. sorted) to obtain an ordered list of the top N values corresponding to the top N most probable next symbols in the sequence of symbols generated by the generative model 110. The value corresponding to the highest probability may be at the first index with the value corresponding to the second highest probability at the second index and so on. In another implementation, another ordering could be employed. For example, the top N probabilities could be identified and then presented in a data structure unsorted (i.e., in their natural order). This method may be beneficial in a system that uses code words of a fixed length where sorting the entire array may consume significant computing resources. In some implementations, the array obtained at sub-step 146 may be truncated to a length smaller than the length of the full dictionary of symbols known to the generative model 110.

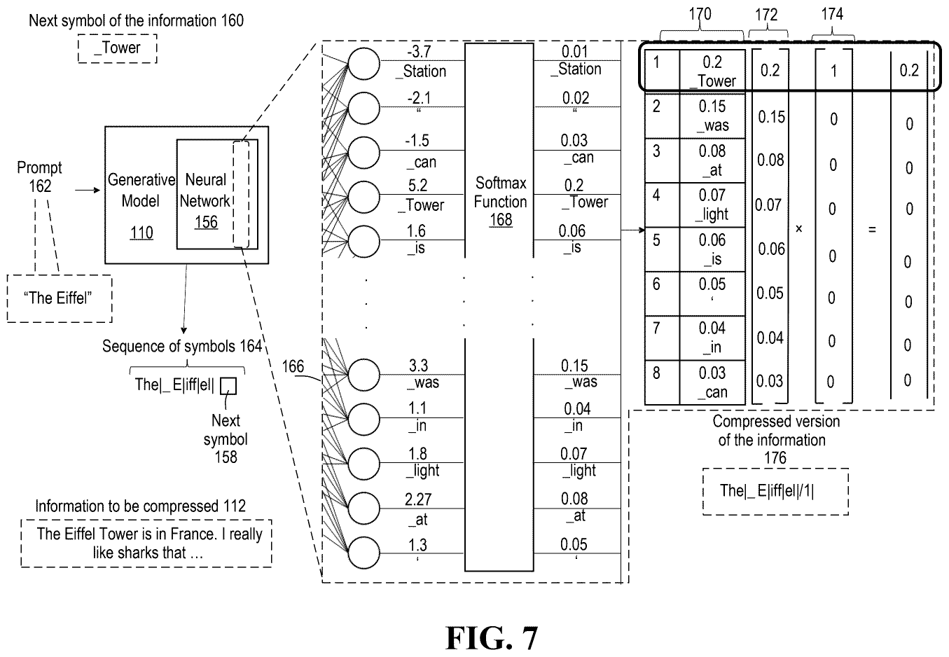

In some implementations, obtaining the array at sub-step 146 may comprise identifying a set of highest probable values based on the output of the generative model 110. The set of highest probable values may contain a number of values equal to a number of code words in the code word dictionary. The next symbol of the information to be compressed 112 may correspond to one of the values in the set of highest probable values. For example, in FIG. 7 described in detail below, the eight highest probable values are identified by array 170. In this example, the code word dictionary may comprise eight code words, e.g. the numbers 1-8 (or, alternatively, 0-7 in another example using 0-based indexing) or their representations, each representing an index into the array.

At sub-step 148, to determine a code word or each code word in the series of code words, the encoder system 102 selects the code word representing the index of the array at which there is a value corresponding to a next symbol of the information to be compressed 112. The term “index” as used herein means any representation of the position of a value in a data structure, such as in an array. Although some examples herein use 1-based indexing, other implementations, e.g. 0-based indexing, may be used.

In some implementations, a fixed length, e.g. a fixed number of bits, may be used to represent each code word. A more desirable compression ratio may be achieved if the next symbol of the information to be compressed 112 is in the top few most probable next symbols in the sequence of symbols generated by the generative model 110. For example, if the size of the symbol dictionary is 65,536 different symbols it may take 16 bits to represent the full next symbol of the information to be compressed 112. However, if the value corresponding to the next symbol of the information is in the top 8 or top 16 most probable values, its index may be represented with only 3 bits or only 4 bits respectively. As described below, if the value corresponding to the next symbol of the information is not in the desired number of top N most probable values, the encoder system 102 may return to priming mode 107.

In some implementations, a variable length encoding may be used for the code words (e.g. prefix code, Huffman code, run-length encoding etc.). Using a variable length encoding for the code words may make the encoder system 102 more flexible by enabling it to represent the occasional index corresponding to a less probable value while still minimizing the number of bits used to store each code word. For example, in an implementation where most values corresponding to a next symbol of the information are in the top eight most probable values, it may not be desirable to return to priming mode 107 just because the occasional value is not in this top eight. In such an example, variable length encoding may allow the occasional index corresponding to a less probable value to be encoded while avoiding the need to employ more than 4 bits to represent each of these occasional indices.

At step 150, the encoder system 102 generates a compressed version of the information using the series of code words. The compressed version of the information may then be stored and/or transmitted and eventually, when decompression is desired, processed by a decoder. In some implementations, the compressed version of the information may comprise at least one series of priming symbols and at least one series of code words. In some implementations, the at least one series of priming symbols may comprise a portion of the information to be compressed 112. For example, the at least one series of priming symbols may comprise the first portion of the information to be compressed 112 used to prompt generative model 110 at step 142 of the method of FIG. 5.

In some implementations, the compressed version of the information may include indications of the length of each series of priming symbols and/or each series of code words. These indications may enable a variable number of symbols to be included in each series of priming symbols and/or may enable a variable number of code words to be included in each series of code words. In some implementations, the compressed version of the information may include a flag, e.g. a reserved symbol, before the start and/or after the end of a series of priming symbols. In the illustrated examples, the symbol “/” is used to indicate the end of a series of priming symbols. In some implementations, the compressed version of the information may include a flag, e.g. a reserved symbol, before the start and/or after the end of a series of code words. In the illustrated examples, the symbol “/” is also used to indicate the end of a series of code words. In some implementations, the compressed version of the information may include at least one symbol that represents the length of a respective series of priming symbols and/or a respective series of priming symbols. The use of “/” to indicate both the end of a series of priming symbols and the end of a series of code words is merely an example. In some implementations, different symbols may be used to indicate the end of each type of series. In some implementations, each series of priming symbols and/or each series of code words may be a fixed length. In some implementations, the compressed version of the information may include a flag, e.g. a reserved symbol, that may indicate where the encoder system 102 transitioned between modes, e.g. priming mode 107 and indexing mode 109. In some implementations, the compressed version of the information may include a flag, e.g. a reserved symbol, indicating a transition to or from each of the modes, e.g. one reserved symbol may indicate a transition to priming mode 107, another reserved symbol may indicate a transition to indexing mode 109, and a further reserved symbol may indicate a transition out of encoding mode 105 and back to configuring mode 103.

In some implementations, the compressed version of the information may comprise at least one of the following: a first reserved symbol preceding the first portion, wherein the first reserved symbol indicates a start of the first portion; a second reserved symbol proceeding the first portion, wherein the second reserved symbol indicates an end of the first portion; a third reserved symbol indicating how many code words are in the series of code words; or a fourth reserved symbol proceeding the series of code words, wherein the fourth reserved symbol indicates an end of the series of code words.

An example of steps 142 to 150 is illustrated in FIG. 7. The generative model 110 is implemented as an LLM. The generative model 110 may have the example LLM structure described earlier in relation to FIG. 1B, or it may have another structure, e.g. it may only implement a decoder or an encoder, rather than both. The exact structure of the generative model 110 is implementation specific, although in the example of FIG. 7 it is assumed that the generative model 110 includes one or more neural networks, although only one is illustrated as neural network 156. As shown in stippled box 166, the neural network 156 includes a layer in which there is a respective node corresponding to each possible next symbol that may be output by the generative model 110. The output from each node is indicative of a probability of the respective symbol being the next symbol 158. The value output from each node may be a number representing an unnormalized probability, as is the case in the illustrated example. The value output from each node may be a logit value, normalized probability, log probability etc. The plurality of values output from the layer of nodes may be or form an array or a tensor, e.g. a tensor of logit values. In the example, a smaller number means a lower probability that the symbol is a next symbol. For example, the node corresponding to the symbol “_Station” outputs the number-3.7, meaning a low probability that “_Station” is the next symbol, whereas the node corresponding to the symbol “_Tower” outputs the number 5.2, meaning a high probability that “_Tower” is the next symbol. In some implementations, other ordering schemes for the values may be used, e.g. one in which a larger number may mean a lower probability that the symbol is a next symbol. In the illustrated example, the output of the layer is input into a softmax function 168 that maps/scales the numbers into a probability between 0 and 1. Then, in the illustrated example, array 170 is determined based on the output of softmax function 168. In some implementations, array 170 may instead be generated from the values before softmax function 168 is applied. Array 170 comprises the eight highest values corresponding to the top eight most probable next symbols in the sequence of symbols 164. For example, “_Tower” is the most probable next symbol in the sequence of symbols 164 and its corresponding value has an index of 1 in array 170.

In the example of FIG. 7, the information to be compressed 112, beginning with “The Eiffel Tower is in France. I really like sharks that . . . ” has been obtained and is represented by a series of symbols (not shown). The generative model 110 is in priming mode 107 and is prompted with prompt 162, which comprises a first portion of the information to be compressed 112, namely “The Eiffel”. In response to prompt 162, the generative model 110 generates a series of symbols 164 and the encoder system 102 transitions to indexing mode 109. In generating the series of symbols 164, the generative model 110 generates a next symbol 158 given one or more preceding symbols, e.g. “The|_E|iff|_el|”, where “|” is used to delineate an end of a symbol, and “_” is used to indicate a blank space. The use of “|” and “_” in the illustrated examples are merely depictions used in the drawings to aid in understanding. Other delimiters may be used to indicate the end of a symbol and/or blank spaces may be indicated in a different way. Based on outputs of the generative model 110, a code word may be selected. In the example shown, the code word “1” is selected as it represents the index of the array 170 at which there is a value corresponding to the next symbol of the information 160, which in the example is “_Tower”. A compressed version of the information 176 is generated and comprises this code word as the first code word in a series of code words. The process of generating code words may then continue for subsequent symbols of the information to be compressed 112, e.g. the generative model 110 may then be used to generate a second output that is mapped to a second code word corresponding to a subsequent symbol of the information to be compressed, and so on.

In some implementations, the method of FIG. 5 may further comprise, subsequent to determining a code word in the series of code words, forcing the generative model 110 to select the next symbol of the information to be compressed 112 as the next symbol in the sequence it generates, instead of another symbol that the generative model 110 would otherwise select (e.g. instead of the most probable next symbol). By forcing the generative model 110 to output the next symbol of the information to be compressed 112 as the next symbol in the sequence of symbols generated, the generative model 110 may effectively be kept primed with all symbols in the information that precede a subsequent symbol in the information. Due to this, the generative model 110 may be more likely to predict the subsequent symbol of the information as being within a limited set of the most probable next symbols in the sequence of symbols generated by the generative model as compared to if generative model 110 was not forced to output the next symbol of the information to be compressed 112 as the next symbol in the sequence of symbols generated, e.g. if generative model 110 instead output the most probable next symbol.

In some implementations, the encoder system 102 may force the generative model 110 to select the next symbol of the information to be compressed 112 as the next symbol in the sequence it generates by using a grammar-constraining data structure, which may be provided to the generative model 110. The “grammar” may be the information to be compressed 112, constraining the next symbol output by the generative model 110 to only be the next symbol of the information to be compressed 112. For example, the “grammar” may be a regex or a JSON schema that is able to enforce certain constraints by reducing or zeroing out invalid symbols, e.g. every symbol except for the next symbol of the information. In some implementations, the method of FIG. 5 may further comprise applying a mask to the values in the array. The mask may operate on each value that corresponds to a symbol other than the next symbol of the information to be compressed 112 to reduce or zero the probability of each other symbol being the next symbol in the sequence of symbols generated by the generative model. The next symbol in the sequence generated by the generative model 110 may be determined based on the values after the mask has been applied. The mask could be considered a grammar-constraining data structure, where the mask enforces the grammar.

One example of applying the mask is illustrated in FIG. 7. In this example, a mask 174 is applied to a vector 172, where the vector 172 comprises the values contained in array 170, each value indicative of a probability of the corresponding respective possible next symbol being the next symbol 158 in the sequence of symbols 164 generated by the generative model 110. Mask 174 zeros out each position in the vector 172 corresponding to a symbol other than the next symbol of the information 160, (“_Tower”). The mask 174 is a vector that has an identity element at the position corresponding to the next symbol of the information 160 and has a zero at each other position, and the masking is applied by vector multiplication of vector 172 and mask 174. The generative model will therefore select “_Tower” as the next symbol 158 in the sequence of symbols 164. The code word “1” will also therefore be selected as part of the series of code words. Compressed version of the information 176 comprises this code word as the first code word in a series of code words.

In an alternative implementation not illustrated, the vector 172 may instead comprise the logit values (unnormalized probabilities) prior to the softmax function 168, in which case the mask 174 may instead consist of values to make every unnormalized probability equal to a negative number of large magnitude (e.g. close to negative infinity), except for the unnormalized probability corresponding to the next symbol of information (“_Tower”), which would ensure that the next symbol of information (“_Tower”) was the one selected for output by the generative model 110. Similar remarks apply to the other illustrated examples where the mask is applied.

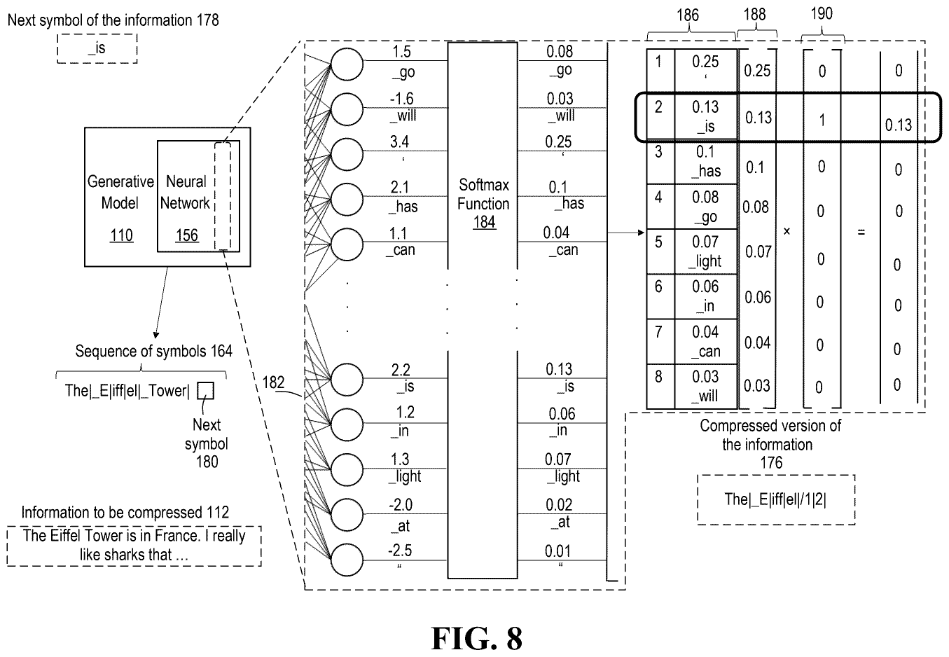

Once the generative model 110 has determined next symbol 158, the generative model 110 may generate a further next symbol. An example of this is shown in FIG. 8. Generative model 110 determines next symbol 180 in sequence of symbols 164. In the illustrated example, the generative model 110 has already generated a sequence with the immediately preceding portion of the sequence of symbols 164 being “_Tower”, the symbol that generative model 110 was forced to select in the example of FIG. 7 above. As shown in stippled box 182, the neural network 156 includes a layer in which there is a respective node corresponding to each possible next symbol that may be output by the generative model 110. The output from each node is indicative of a probability of the respective symbol being the next symbol 180. The value output from each node may be a number representing an unnormalized probability, as is the case in the illustrated example. The value output from each node may be a logit value, normalized probability, log probability etc. The plurality of values output from the layer of nodes may be or form a tensor, e.g. a tensor of logit values. In the example, a smaller number means a lower probability that the symbol is the next symbol 180.In the illustrated example, the output of the layer is input into a softmax function 184 that maps/scales the numbers into a probability between 0 and 1. Then, in the illustrated example, array 186 is determined based on the output of softmax function 184. In some implementations, array 186 may be generated from the values before softmax function 184 is applied. Array 186 comprises the eight highest values corresponding to the top eight most probable next symbols in the sequence of symbols 164.

In the example of FIG. 8, a mask 190 is applied to a vector 188, where the vector 188 comprises the values contained in array 186, each value indicative of a probability of the corresponding respective possible next symbol being the next symbol 180 in the sequence of symbols 164 generated by the generative model 110. Mask 190 zeros out each position in the vector 188 corresponding to a symbol other than the next symbol of the information 178, (“_is”). The mask 190 is a vector that has an identity element at the position corresponding to the next symbol of the information 178 and has a zero at each other position, and the masking is applied by vector multiplication of vector 188 and mask 190. The generative model will therefore select “_is” as the next symbol 180 in the sequence of symbols 164. The code word “2” will also therefore be selected as part of the series of code words. Compressed version of the information 176 comprises this code word as the second code word in a series of code words. With the sequence of symbols 164 now comprising the symbol “_is”, the method illustrated by FIG. 7 and FIG. 8 may then continue for subsequent symbols in the information to be compressed 112. For each, an array of probability values may be generated and a code word representing the index of the array corresponding to the next symbol of the information may be recorded in the series of code words.

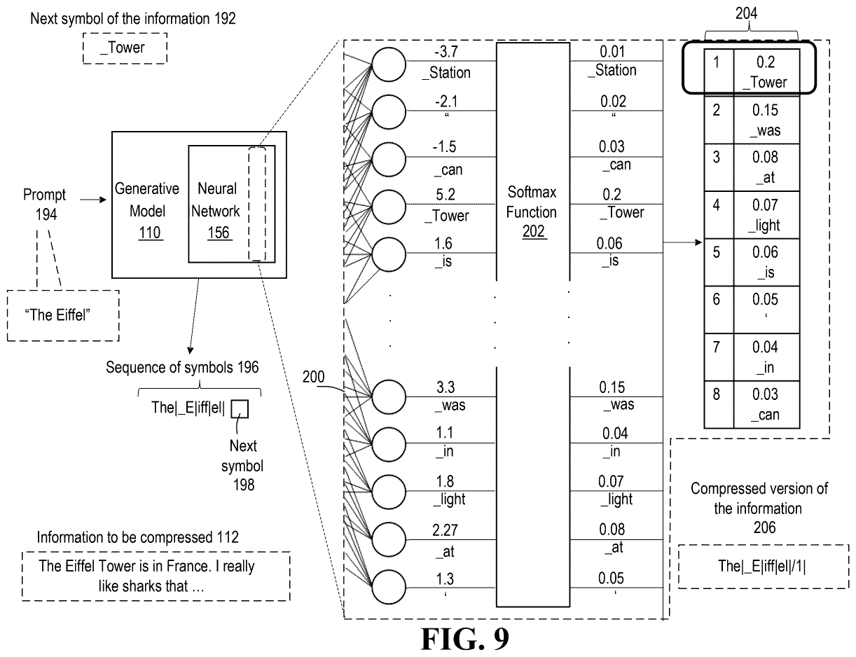

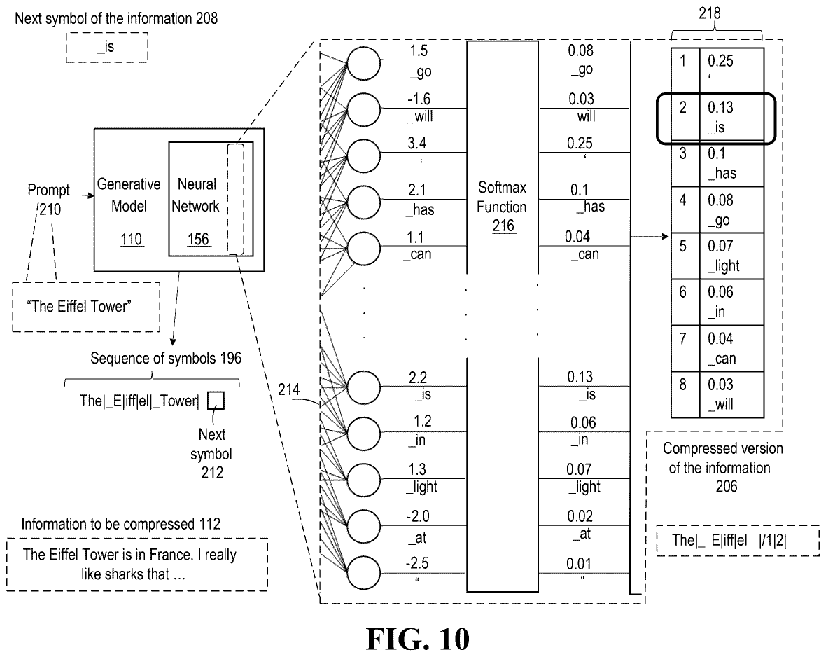

In some implementations, the encoder system 102 may force the generative model 110 to output the next symbol of the information to be compressed 112 as the next symbol in the sequence of symbols generated by the generative model 110 by re-prompting the generative model 110 with the previous symbols in the sequence plus the next symbol of the information to be compressed 112. One example of re-prompting generative model 110 is shown in FIG. 9 and FIG. 10. The example described below in FIGS. 9 and 10 is an example of step 144 of FIG. 5 where, prior to obtaining the array, prompting the generative model 110 using a first portion of the symbols (e.g. “The Eiffel”) and at least one symbol following the first portion (e.g. “Tower” in FIG. 10).

In the example of FIG. 9, generative model 110 determines next symbol 198 in sequence of symbols 196 after being prompted with prompt 194, (“The Eiffel”). As shown in stippled box 200, the neural network 156 includes a layer in which there is a respective node corresponding to each possible next symbol that may be output by the generative model 110. The output from each node is indicative of a probability of the respective symbol being the next symbol 198. The value output from each node may be a number representing an unnormalized probability, as is the case in the illustrated example. The value output from each node may be a logit value, normalized probability, log probability etc. The plurality of values output from the layer of nodes may be or form a tensor, e.g. a tensor of logit values. In the example, a smaller number means a lower probability that the symbol is the next symbol 198. In the illustrated example, the output of the layer is input into a softmax function 202 that maps/scales the numbers into a probability between 0 and 1. Then, in the illustrated example, array 204 is determined based on the output of softmax function 202. Array 204 comprises the eight highest values corresponding to the top eight most probable next symbols in the sequence of symbols 196. The symbol represented by the value at index 1 of array 204 is selected as the appropriate next symbol 198, as it corresponds to the next symbol of the information 192, (“_Tower”). The code word “1” will also therefore be selected as part of the series of code words. Compressed version of the information 206 comprises this code word as the first code word in a series of code words.

In the illustrated example, after selecting the appropriate next symbol 198 the encoder system 102 may re-prompt generative model 110 with prompt 210 to generate a further next symbol 212, as shown in FIG. 10. Prompt 210 comprises prompt 194 as well as the selected next symbol 198. As shown in stippled box 214, the neural network 156 includes a layer in which there is a respective node corresponding to each possible next symbol that may be output by the generative model 110. The output from each node is indicative of a probability of the respective symbol being the next symbol 212. The value output from each node may be a number representing an unnormalized probability, as is the case in the illustrated example. The value output from each node may be a logit value, normalized probability, log probability etc. The plurality of values output from the layer of nodes may be or form a tensor, e.g. a tensor of logit values. In the example, a smaller number means a lower probability that the symbol is the next symbol 212. In the illustrated example, the output of the layer is input into a softmax function 216 that maps/scales the numbers into a probability between 0 and 1. Then, in the illustrated example, array 218 is determined based on the output of softmax function 216. In some implementations, array 218 may be generated from the values before softmax function 216 is applied. Array 218 comprises the eight highest values corresponding to the top eight most probable next symbols in the sequence of symbols 196. The symbol represented by the value at index 2 of array 218 is selected as the appropriate next symbol 212, as it corresponds to the next symbol of the information 208, (“_is”). The code word “2” will also therefore be selected as part of the series of code words. Compressed version of the information 206 comprises this code word as the second code word in a series of code words. With the sequence of symbols 196 now comprising the symbol “_is”, the method illustrated by FIG. 9 and FIG. 10 may then continue for subsequent symbols in the information to be compressed 112.

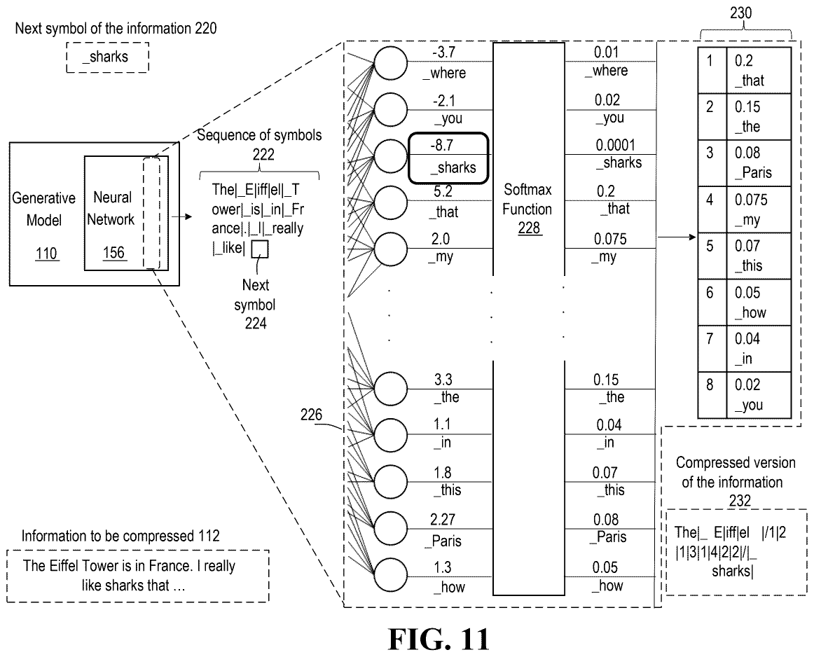

In some implementations, the content of the information to be compressed 112 may drift or change in a way that the generative model 110 does not predict. An example is shown in FIG. 11, where the content of information to be compressed 112 changes in a way that generative model 110 may not predict as probable when the string “The Eiffel Tower is in France. I really like” is followed by the word “sharks”. The next symbol of the information to be compressed 112 may correspond to a value with a low probability of being the next symbol in the sequence of symbols. In these cases, the method of FIG. 5 may further comprise determining that a codeword in the dictionary of code words used to determine the series of code words cannot be used to represent the index of the array at which there is the value corresponding to the next symbol of the information to be compressed 112. Responsive to determining this, the encoder system 102 may include the next symbol of the information to be compressed 112, rather than a code word, as part of the compressed version of the information. As such, the next symbol of the information may form part of a second series of priming symbols. While determining the second series of priming symbols the encoder system 102 may be in priming mode 107. Then, the generative model 110 may be forced to select the next symbol of the information as the next symbol in the sequence of symbols generated, e.g. in one of the ways explained herein, such as by masking. In some implementations, more than one full symbol may be included in the compressed version of the information, in place of code words. Full symbols from the information to be compressed 112 may be included in place of code words, forming the second series of priming symbols, until a code word can be used to represent the index of the array at which there is a value corresponding to a next symbol of the information to be compressed 112. The encoder system 102 may then transition back to indexing mode 109 and may continue determining code words, now forming a second series of code words that begins with a symbol of the information to be compressed 112 that immediately follows the final priming symbol in the second series of priming symbols.

In the example of FIG. 11, generative model 110 determines next symbol 224 in sequence of symbols 222. As shown in stippled box 226, the neural network 156 includes a layer in which there is a respective node corresponding to each possible next symbol that may be output by the generative model 110. The output from each node is indicative of a probability of the respective symbol being the next symbol 224. The value output from each node may be a number representing an unnormalized probability, as is the case in the illustrated example. The value output from each node may be a logit value, normalized probability, log probability etc. The plurality of values output from the layer of nodes may be or form a tensor, e.g. a tensor of logit values. In the example, a smaller number means a lower probability that the symbol is the next symbol 224. In the illustrated example, the output of the layer is input into a softmax function 228 that maps/scales the numbers into a probability between 0 and 1. Then, in the illustrated example, array 230 is determined based on the output of softmax function 228. In some implementations, array 230 may be generated from the values before softmax function 228 is applied. In this example, the code word dictionary contains 8 code words. Array 230 therefore comprises the eight highest values corresponding to the top eight most probable next symbols in the sequence of symbols 224. As shown, array 230 does not include a value corresponding to the next symbol of the information 220, (“_sharks”). The next symbol of the information 220 cannot therefore be represented by a code word in the code word dictionary. As such, encoder system 102 transitions from indexing mode 109 to priming mode 107 and the full symbol “_sharks” is included in the compressed version of the information 232 instead of a code word. Compressed version of the information 232 comprises this full symbol as the first symbol in a second series of priming symbols.

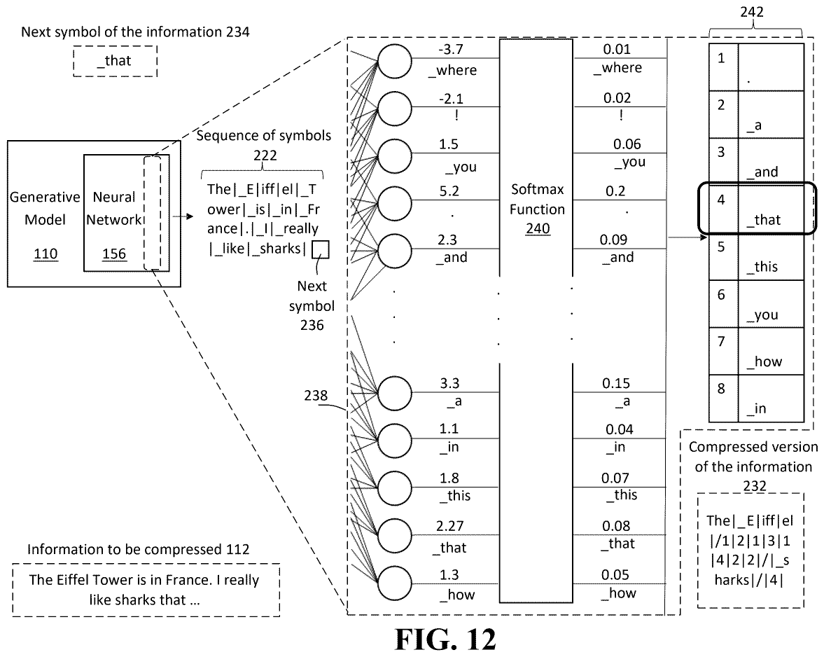

The example of FIG. 12 carries on from the example of FIG. 11. In the example of FIG. 12, generative model 110 determines next symbol 236 in sequence of symbols 222. As shown in stippled box 238, the neural network 156 includes a layer in which there is a respective node corresponding to each possible next symbol that may be output by the generative model 110. The output from each node is indicative of a probability of the respective symbol being the next symbol 236. The value output from each node may be a number representing an unnormalized probability, as is the case in the illustrated example. The value output from each node may be a logit value, normalized probability, log probability etc. The plurality of values output from the layer of nodes may be or form a tensor, e.g. a tensor of logit values. In the example, a smaller number means a lower probability that the symbol is the next symbol 236. In the illustrated example, the output of the layer is input into a softmax function 240 that maps/scales the numbers into a probability between 0 and 1. Then, in the illustrated example, array 242 is determined based on the output of softmax function 240. In some implementations, array 242 may be generated from the values before softmax function 240 is applied. Array 242 therefore comprises the eight highest values corresponding to the top eight most probable next symbols in the sequence of symbols 222. The symbol corresponding to the value at index 4 of array is selected as the appropriate next symbol 236, as it corresponds to the next symbol of the information 234, (“_that”). The code word “4” will also therefore be selected as part of the second series of code words. As a code word can be selected, the encoder system 102 transitions back to indexing mode 109. Compressed version of the information 232 comprises this code word as the first code word in the second series of code words. The encoder system 102 may then resume determining code words.

In some implementations of the method of FIG. 5, prior to prompting the generative model 110, the generative model 110 may be configured based on at least one configuration setting, e.g. configuration settings 114 discussed above. The at least one configuration setting may be a configuration setting as described above with reference to configuration settings 114. While obtaining at least one configuration setting and/or configuring generative model 110, encoder system 102 may be in configuring mode 103. Once the generative model 110 has been configured the encoder system 102 may transition to encoding mode 105.

In some implementations, as discussed above, the at least one configuration setting may comprise fine-tuning data. The generative model 110 may be fine-tuned prior to being prompted at step 142 of the method of FIG. 5.

In some implementations, the method of FIG. 5 may further comprise, prior to prompting the generative model, generating fine-tuning data based on existing weighting information of the generative model 110 and/or at least a portion of the information to be compressed 112, such as a plurality of symbols of the information to be compressed 112. The method of FIG. 5 may further comprise performing fine-tuning of the generative model 110 based on the fine-tuning data. Fine-tuning data may be generated, e.g. by using a LoRA technique, prefix tuning etc. By generating fine-tuning data based on at least a portion of the information to be compressed 112, the generative model 110 may be more likely to predict a next symbol of the information as being within the top few probabilities while generating code words. This may enable a longer series of acceptable code words to be generated, leading to fewer full representations of symbols in the compressed version of the information, and therefore to a more desirable compression ratio.

In some implementations, the fine-tuning data may be based on the entirety of the information to be compressed 112. In some implementations, the fine-tuning data may be generated based on an initial portion of the information to be compressed 112. This initial portion may be of a variable length. For example, the fine-tuning data may be generated based on the first 200 symbols of the information to be compressed 112. In other implementations, the information to be compressed 112 may be sampled to extract a determined number of symbols and then the fine-tuning data may be generated based on the extracted set of symbols. For example, the fine-tuning data may be generated based on 200 symbols sampled randomly from the information to be compressed 112.

In some implementations, the fine-tuning data may be based on other data. In some implementations, different fine-tuning data may be applied to different portions of the information. For example, a web page may contain both HTML and JavaScript™. The HTML portions may be best compressed using an instance of the generative model 110 where fine-tuning data generated by training on a dataset of HTML code has been applied. Meanwhile, the JavaScript™ portions may be best compressed using an instance of the generative model 110 where fine-tuning data generated by training on a dataset of JavaScript™ code has been applied. In such implementations, the generative model 110 may be fine-tuned more than once. In some implementations, a particular instance of fine-tuning data may be applied to more than one segment of the information. For example, if the information were to comprise HTML code followed by JavaScript™ code followed by more HTML code, a first instance of fine-tuning data (e.g. generated by training on a dataset of HTML code) may be applied, then a second instance of fine-tuning data (e.g. generated by training on a dataset of JavaScript™ code) may be applied, and then the first instance of fine-tuning data may be applied again.

Each time the generative model 110 is fine-tuned the encoder system 102 may transition to configuring mode 103. Each change of fine-tuning data applied to the generative model 110, e.g. including each transition to and from configuring mode 103, may be indicated in the compressed version of the information. In some implementations, there may be at least one segment of the information for which no fine-tuning data should be applied. This may be indicated in the compressed version of the information. In some implementations, at least one instance of fine-tuning data may be included in the compressed version of the information. For example, a first segment of the compressed version of the information may comprise configuration settings, including fine-tuning data. In some implementations, at least one instance of fine-tuning data may be transmitted, e.g. to a decoder system, separately from the compressed version of the information. In some implementations, at least one identifier that corresponds to a particular instance of fine-tuning data may be included in the compressed version of the information. In some implementations, the at least one identifier may be transmitted, e.g. to a decoder system, separately from the compressed version of the information.

In some implementations, the at least one configuration setting may comprise an indication of a particular generative model used as generative model 110. In some implementations, the at least one configuration setting may comprise an indication of a particular set of generative models. In such implementations, each change of generative model used by encoder system 102 may be indicated in the compressed version of the information. In some implementations, distillation may be used to generate at least one generative model, to be used as generative model 110, to more efficiently compress specific types or formats of data.

In some implementations, as discussed above, the at least one configuration setting may comprise an identifier that corresponds to a particular set of configuration settings and/or a particular instance of fine-tuning data. Therefore, in some implementations, the method of FIG. 5 may further comprise, prior to configuring the generative model 110, retrieving a particular set of configuration settings and/or a particular instance of fine-tuning data based on the identifier.

In some implementations, an additional grammar-constraining data structure may be used to constrain a set of symbols that could be chosen as the next symbol in the sequence of symbols generated by the generative model 110. For example, if the information to be compressed 112 comprised entirely JavaScript™ code, the grammar-constraining data structure could define what constitutes a valid sequence of symbols in JavaScript™. Then, a mask could be applied that operates on each value in the array of values that corresponds to a symbol that would not form a valid sequence of symbols in JavaScript™. The mask may be applied before the array of values is obtained. More generally, this technique could be employed when the information to be compressed 112 follows a specific, consistent grammar. Applying a grammar-constraining data structure in these cases may make the generative model 110 more likely to predict a next symbol of the information to be compressed as being within the top few probabilities while generating code words. In some implementations, different grammar-constraining data structures may be used while compressing different portions of the information to be compressed 112. Indications of any change in which grammar-constraints should be used may be included in the compressed version of the information. This method of using a grammar-constraining data structure and others are described in, for example, U.S. patent application Ser. No. 18/649,251, which was filed Apr. 29, 2024, and which is incorporated herein by reference in its entirety.

In some implementations, before the array of values is obtained, the additional grammar-constraining data structure may be applied first followed by a grammar-constraining data structure that forces the generative model 110 to select the correct next symbol, as described above.

In some implementations, prior to applying the additional grammar-constraining data structure, the information to be compressed 112 may be checked to ensure it conforms with a specific grammar. For example, if the grammar-constraining data structure defines what constitutes a valid sequence in JavaScript™, the information to be compressed 112 may be checked to ensure it is valid JavaScript™ code. In some implementations, the encoder system 102 have access to a set of known grammar-constraining data structures. For example, in a system that primarily compresses web pages, a known grammar-containing data structure may be obtained for each of HTML, CSS, and JavaScript™ code.

In some implementations, the method of FIG. 5 may further comprise applying a further lossless compression method (e.g. Huffman coding, LZ77, LZW, run-length encoding etc.) to at least a portion of the compressed version of the information. For example, a further lossless compression method may be applied to a first portion of the compressed version of the information where the first portion of the compressed version of the information corresponds to the first portion of the series of symbols representing the information to be compressed 112, e.g. the priming symbols. This may allow for a version of double compression/nested compression, which may achieve a more desirable compression ratio by combining the generative model compression described herein with a traditional lossless compression method. In some implementations, at least one series of code words and/or at least one series of priming symbols may be further compressed using a further lossless compression method. In some implementations, the entirety of the compressed version of the information may be further compressed using a further lossless compression method.

In some implementations, the method of FIG. 5 may further comprise applying a further encoding algorithm to at least a portion of the compressed version of the information, e.g. delta coding. For example, delta coding may be applied to at least one series of code words in the compressed version of the information to achieve a more desirable compression ratio. As an example, in an implementation where the correct next symbol is generally in the top few, e.g. top four, most probable next symbols, delta coding with two bits may allow the encoder system 102 to encode indices outside of the top few, e.g. top four, most probable symbols. Delta coding may allow more index values to be encoded than would otherwise be able to be encoded using fixed-length encoding. For example, instead of a fixed-length encoding of two bits, which could encode four values (e.g. top four indices), delta coding may be used to encode four delta values which may allow encoder system 102 to encode index values outside the top four.

In some implementations, the compressed version of the information may be recorded in an output file as it is generated. In some implementations, the output file may be provided to a decoder, e.g. decoder system 118. In some implementations, the compressed version of the information may be provided to the decoder in another way. In some implementations, the encoder system 102 may stream the compressed version of the information to the decoder. In implementations where the encoder system 102 is streaming the compressed version of the information to the decoder, the encoder system 102 may wait to send a series of priming symbols and/or a series of code words until that series has ended. This buffering may allow the encoder system 102 to indicate to the decoder the length of a series. In some implementations, the compressed version of the information may be provided to the decoder only once it is complete.

In some implementations, at least one configuration setting used to configure generative model 110, e.g. configuration settings 114, may be provided to a decoder, e.g. decoder system 118. In some implementations, the at least one configuration setting may be stored or transmitted, e.g. to the decoder, along with the compressed version of the information. In some implementations, at least one configuration setting may be provided to the decoder in another way. In some implementations, fine-tuning data may be stored or transmitted, e.g. to the decoder, along with the compressed version of the information.

In some implementations of the method of FIG. 5, the generative model 110 does not necessarily have to be prompted by a portion (e.g. first portion) of the information. For example, there might be another prompt that is preconfigured or predefined, e.g. stored in advance at both the encoder and decoder side. However, in the illustrated example, the generative model 110 is prompted using a first portion of the series of symbols of the information (“The Eiffel”), which results in a second portion of the series of symbols (“Tower is in France. I really like”) to be represented by a series of code words (“1|2|1|3|1|4|2|2”).

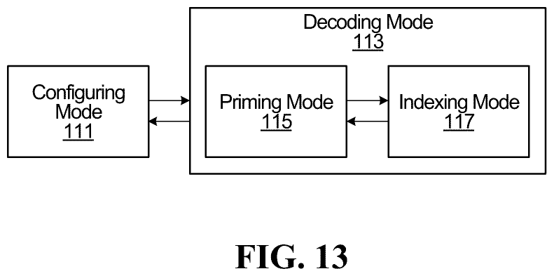

FIG. 13 illustrates an example state diagram for the decoder system 118 of FIG. 3. While performing the methods disclosed herein the decoder system 118 may be in a specific state. The decoder system 118 may be in configuring mode 111 when applying configuration settings 130 to generative model 126. The decoder system 118 may be in decoding mode 113 when performing decompression on compressed information 128. As in the illustrated example, decoding mode 113 may comprise nested states, namely priming mode 115 and indexing mode 117. Decoder system 118 may be in priming mode 115 when prompting generative model 126 and indexing mode 117 when generating symbols. These states and the transitions between them will be further described below.

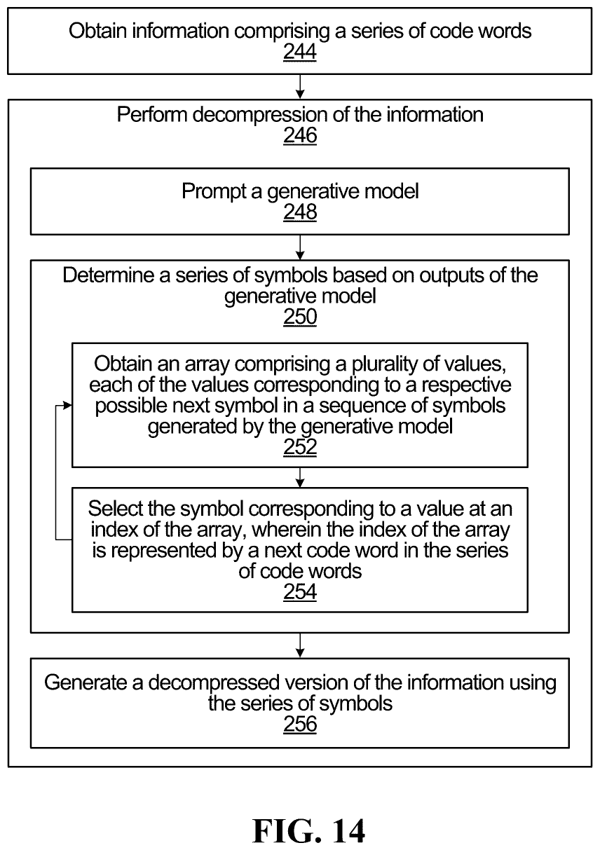

FIG. 14 illustrates an example method performed by decoder system 118, where the decoder system 118 performs lossless decompression of the information that is compressed by the encoder system 102.

At step 244, the decoder system 118 obtains compressed information 128 comprising at least one series of code words. In some implementations, the compressed information 128 may include at least one series of priming symbols. In some implementations, the compressed information 128 may include a first portion, comprising a series of priming symbols, and a second portion, comprising a series of code words. In some implementations, the compressed information 128 may include at least one indication of the length of at least one series of priming symbols. In some implementations, the compressed information 128 may include at least one indication of the length of at least one series of code words. For example, compressed information 128 may comprise a reserved symbol indicating the start and/or end of a series. In some implementations, the decoder system 118 may obtain compressed information 128 and then obtain its representation as a series of symbols. For example, a symbol may be a token, and the information may be represented as a series of symbols by tokenizing the information using the vocabulary of generative model 126.

In some implementations, the compressed information 128 may include a flag, e.g. a reserved symbol, that may indicate where the encoder system 102 had transitioned between modes, e.g. priming mode 107 and indexing mode 109. In some implementations, the compressed information 128 may include a flag, e.g. a reserved symbol, indicating where encoder system 102 had transitioned to or from each mode, e.g. one reserved symbol may indicate a transition to priming mode 107, another reserved symbol may indicate a transition to indexing mode 109, and a further reserved symbol may indicate a transition out of encoding mode 105 and back to configuring mode 103. Decoder system 118 may then mirror these modes while performing the methods described herein. For example, upon encountering an indication that encoder system 102 transitioned from indexing mode 109 to priming mode 107, decoder system 118 may transition from indexing mode 117 to priming mode 115.

At step 246, the decoder system 118 performs decompression of the compressed information 128. The decoder system 118 may be in decoding mode 113 while performing decompression of the compressed information 128.

At step 248, the decoder system 118 prompts generative model 126. In some implementations, the generative model 126 may be prompted with a first portion of the compressed information 128 comprising a series of priming symbols. In some implementations, the generative model 126 may be prompted with a different series of symbols, e.g. with symbols that are not necessarily part of the compressed version of the information. While prompting generative model 126, the decoder system 118 may be in priming mode 115.

At step 250, the decoder system 118 determines a series of symbols, referred to herein as a series of decoded symbols, based on outputs of the generative model 126. When generating decoded symbols, the decoder system 118 may be in indexing mode 117.

At sub-step 252, to determine a decoded symbol (e.g. each decoded symbol) in the series of decoded symbols, the decoder system 118 obtains an array comprising a plurality of values, each of the values corresponding to a respective possible next symbol in a sequence of symbols generated by the generative model 126. In some implementations, each of plurality of values in the array, may be indicative of a probability of the corresponding respective possible next symbol being a next symbol in the symbol sequence generated by the generative model 126.

In some implementations, the array obtained at sub-step 252 may be processed (e.g. sorted) to obtain an ordered list of the top N values corresponding to the top N most probable next symbols in the sequence of symbols generated by the generative model. The value corresponding to the highest probability may be at the first index with the value corresponding to the second highest probability at the second index and so on. In another implementation, another ordering could be employed. For example, the top N probabilities could be identified and then presented in a data structure unsorted. This method may be beneficial in a system that uses code words of a fixed length where sorting the entire array may consume significant computing resources. In some implementations, the array obtained at sub-step 252 may be truncated to a length smaller than the length of the full dictionary of symbols known to the generative model 126. Regardless of how the array is determined and ordered, it may be determined and ordered such that, given the same input, a symbol corresponding to a particular index at the encoder system 102 corresponds to the same particular index at the decoder system 118.

In some implementations, obtaining the array at sub-step 252 may comprise identifying a set of highest probable values based on the output of the generative model 126. The set of highest probable values may contain a number of values equal to a number of code words in the code word dictionary. The next decoded symbol may correspond to one of the values in the set of highest probable values.

At sub-step 254, to determine a decoded symbol or each decoded symbol in the series of decoded symbols, the decoder system 118 selects the symbol corresponding to a value at an index of the array, wherein the index of the array is represented by a next code word in the series of code words.

At step 256, the decoder system generates a decompressed version of the information using the series of priming symbols. In some implementations, the decompressed version of the information may be recorded in an output file as it is generated. In some implementations, the decompressed version of the information may be streamed as it is decompressed. In some implementations, the decompressed version of the information comprises at least one series of priming symbols and at least one series of decoded symbols. In some implementations, the decompressed version of the information is mapped from its symbol representation to its original form, e.g. by tokenizer decoding.

In some implementations, the information obtained at step 244 may comprise at least one of the following: a first reserved symbol preceding the first portion, wherein the first reserved symbol indicates a start of the first portion; a second reserved symbol proceeding the first portion, wherein the second reserved symbol indicates an end of the first portion; a third reserved symbol indicating how many code words are in the series of code words; or a fourth reserved symbol proceeding the series of code words, wherein the fourth reserved symbol indicates an end of the series of code words. An example of a reserved symbol is the symbol “/” discussed herein.

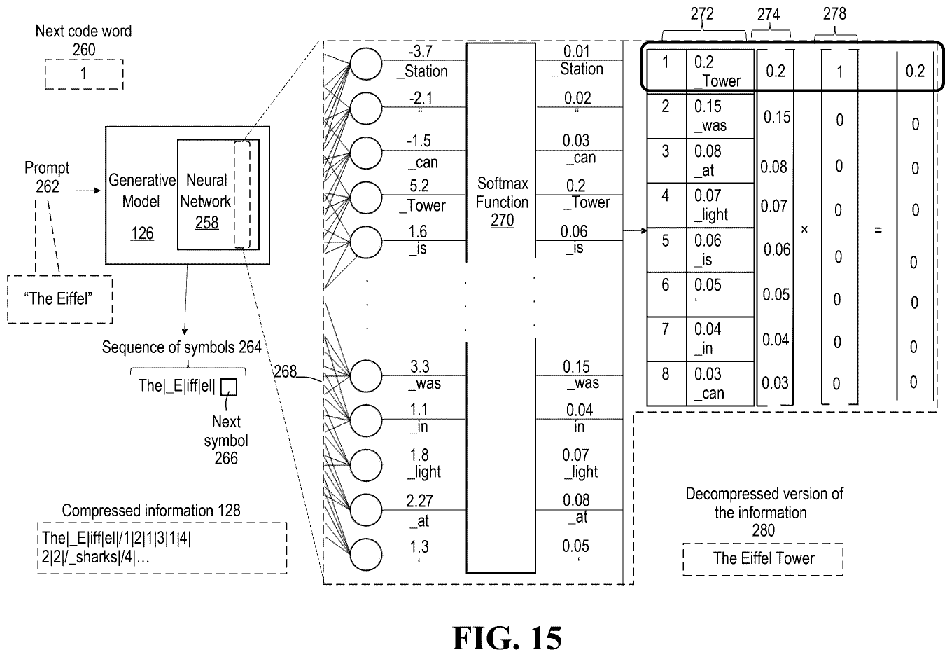

An example of steps 246 to 256 is illustrated in FIG. 15. The generative model 126 is implemented as an LLM. The generative model 126 may have the example LLM structure described earlier in relation to FIG. 1B, or it may have another structure, e.g. it may only implement a decoder or an encoder, rather than both. The exact structure of the generative model 126 is implementation specific, although in the example of FIG. 15 it is assumed that the generative model 126 includes one or more neural networks, although only one is illustrated as neural network 258. As shown in stippled box 268, the neural network 258 includes a layer in which there is a respective node corresponding to each possible next symbol that may be output by the generative model 126. The output from each node is indicative of a probability of the respective symbol being the next symbol 266. The value output from each node may be a number representing an unnormalized probability, as is the case in the illustrated example. The value output from each node may be a logit value, normalized probability, log probability etc. The plurality of values output from the layer of nodes may be or form an array or a tensor, e.g. a tensor of logit values. In the example, a smaller number means a lower probability that the symbol is a next symbol. For example, the node corresponding to the symbol “_Station” outputs the number −3.7, meaning a low probability that “_Station” is the next symbol, whereas the node corresponding to the symbol “_Tower” outputs the number 5.2, meaning a high probability that “_Tower” is the next symbol. In some implementations, other ordering schemes for the values may be used, e.g. one in which a larger number may mean a lower probability that the symbol is a next symbol. In the illustrated example, the output of the layer is input into a softmax function 270 that maps/scales the numbers into a probability between 0 and 1. Then, in the illustrated example, array 272 is determined based on the output of softmax function 270. In some implementations, array 272 may be generated from the values before softmax function 270 is applied. Array 272 comprises the eight highest values corresponding to the top eight most probable next symbols in the sequence of symbols 264. For example, “_Tower” is the most probable next symbol in the sequence of symbols 264 and its corresponding value has an index of 1 in array 272.

In the example of FIG. 15, the compressed information 128, (The|_E|iff|el|/1|2|1|3|1|4|2|2|/_sharks|/4| . . . ), has been obtained. In the illustrated examples, “|” is used to indicate both the end of a symbol and the end of a code word. In the illustrated examples, “/” is used to indicate both the end of a series of priming symbols and the end of a series of code words. The generative model 126 is in priming mode 115 and is prompted with prompt 262, which comprises the first portion of the compressed information 128, (“The Eiffel”). In response to prompt 262, the generative model 126 generates a series of symbols 264 and transitions to indexing mode 117. In generating the series of symbols 264, the generative model 126 generates a next symbol 266 given one or more preceding symbols, e.g. given “The|_E|iff|_el|”. Based on outputs of the generative model 126, a decoded symbol may be determined. In the example shown, the symbol “_Tower” is selected as it corresponds to the value at the index of the array represented by the next code word, namely “1”. A decompressed version of the information 280 is generated comprising the decoded symbol. The process of determining decoded symbols may then continue for subsequent code words in the compressed information 128. For each, an array of probability values may be generated and a symbol that corresponds to a value of the index of the array, where the index is represented by the next code word in the series of code words, may then be located and included in the decompressed version of the information.

In some implementations, the method of FIG. 14 may further comprise, subsequent to determining a decoded symbol in the series of decoded symbols, forcing the generative model 126 to select the decoded symbol as the next symbol in the sequence it generates, instead of another symbol that the generative model 110 would otherwise select (e.g. instead of the most probable next symbol). To help ensure that when given the same input generative model 110 and generative model 126 produce the same or substantially the same output, the forcing may be performed following the same method performed at the encoder system 102.

In some implementations, the decoder system 118 may force the generative model 126 to select a determined decoded symbol as the next symbol in the sequence it generates by using a grammar-constraining data structure, which may be provided to the generative model 126. The “grammar” may be a series of code words of the compressed information 128, constraining the next symbol output by the generative model 126 to only be the symbol corresponding to a next code word of the series of code words. For example, the “grammar” may be a regex or a JSON schema that is able to enforce certain constraints by reducing or zeroing out invalid symbols, e.g. every symbol except for the symbol corresponding to the next code word. In some implementations, the method of FIG. 14 may further comprise applying a mask to the values in the array. The mask may operate on each value at an index of the array other than the index of the array represented by the next code word to reduce or zero the probability of the corresponding symbol being the next symbol in the symbol sequence generated by the generative model 126. The symbol sequence generated by the generative model 126 may be determined based on the values after the mask is applied. The mask could be considered a grammar-constraining data structure, where the mask enforces the grammar.

One example of applying the mask is illustrated in FIG. 15. In this example, a mask 278 is applied to a vector 274, where the vector 274 comprises the values contained in array 272, each value indicative of a probability of the corresponding respective possible next symbol being the next symbol 266 in the sequence of symbols 264 generated by the generative model 126. Mask 278 zeros out each position in the vector 274 corresponding to a symbol other than the symbol represented by the value at the index of the array represented by the next code word 260. The mask 278 is a vector that has an identity element at the position corresponding to the symbol represented by the value at the index of the array represented by the next code word 260 and has a zero at each other position, and the masking is applied by vector multiplication of vector 274 and mask 278. The generative model 126 will therefore select “_Tower” as the next symbol 266 in the sequence of symbols 164 as it is represented by the value at index 1 of array 272. Decompressed version of the information 280 comprises this symbol as the first decoded symbol in the series of decoded symbols.

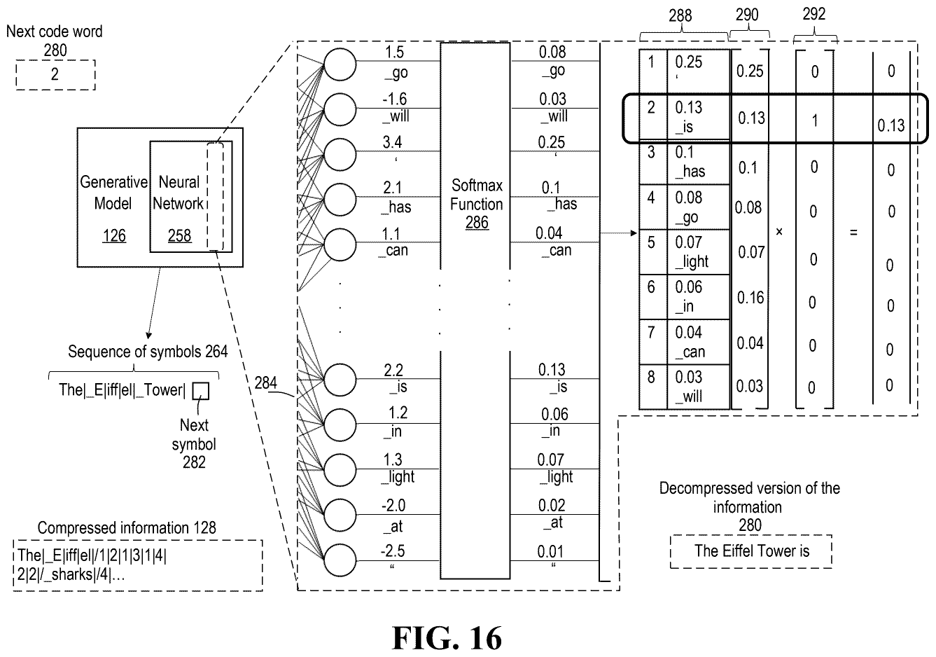

Once the generative model 126 has determined next symbol 266, the generative model 126 may generate a further next symbol. An example of this is shown in FIG. 16. Generative model 126 determines next symbol 282 in sequence of symbols 264. In the illustrated example, the generative model 126 has already generated a sequence with the immediately preceding portion of the sequence being “_Tower”, the symbol that generative model 126 was forced to select in the example of FIG. 15 above. As shown in stippled box 284, the neural network 156 includes a layer in which there is a respective node corresponding to each possible next symbol that may be output by the generative model 126. The output from each node is indicative of a probability of the respective symbol being the next symbol 282. The value output from each node may be a number representing an unnormalized probability, as is the case in the illustrated example. The value output from each node may be a logit value, normalized probability, log probability etc. The plurality of values output from the layer of nodes may be or form a tensor, e.g. a tensor of logit values. In the example, a smaller number means a lower probability that the symbol is the next symbol 282. In the illustrated example, the output of the layer is input into a softmax function 286 that maps/scales the numbers into a probability between 0 and 1. Then, in the illustrated example, array 288 is determined based on the output of softmax function 286. In some implementations, array 288 may be generated from the values before softmax function 286 is applied. Array 288 comprises the eight highest values corresponding to the top eight most probable next symbols in the sequence of symbols 264.

In the example of FIG. 16, a mask 292 is applied to a vector 290, where the vector 290 comprises the values contained in array 288, each value indicative of a probability of the corresponding respective possible next symbol being the next symbol 282 in the sequence of symbols 264 generated by the generative model 126. Mask 292 zeros out each position in the vector 288 corresponding to a symbol other than the symbol represented by the value at the index of the array represented by the next code word 281. The mask 190 is a vector that has an identity element at the position corresponding to the symbol represented by the value at the index of the array represented by the next code word 281 and has a zero at each other position, and the masking is applied by vector multiplication of vector 188 and mask 190. The generative model will therefore select “_is” as the next symbol 282 in the sequence of symbols 264 as it is represented by the value at index 2 of array 288. Decompressed version of the information 280 comprises this symbol as the second decoded symbol in the series of decoded symbols. With the sequence of symbols 264 now comprising the symbol “_is”, the steps illustrated by FIG. 15 and FIG. 16 may then continue for subsequent code words in the compressed information 128.

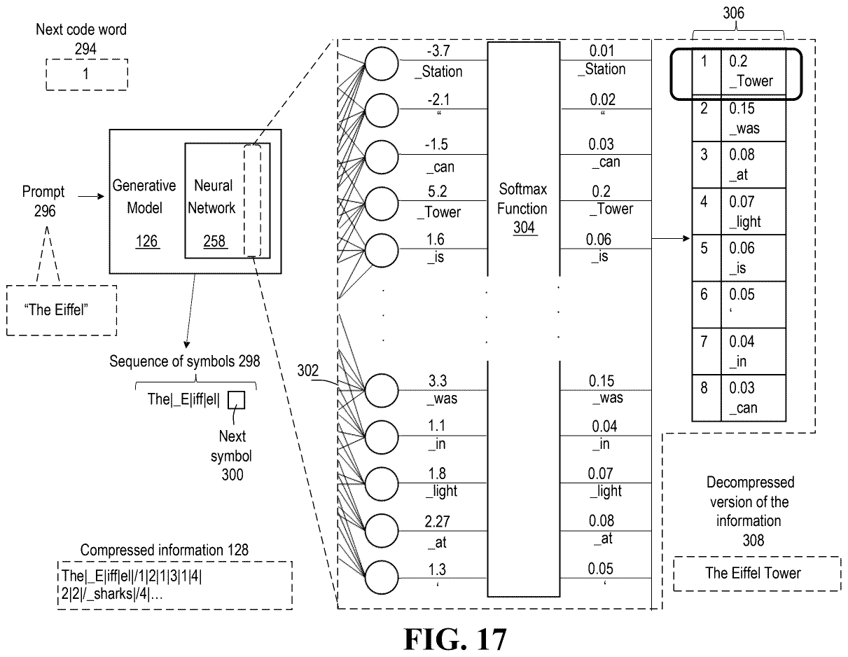

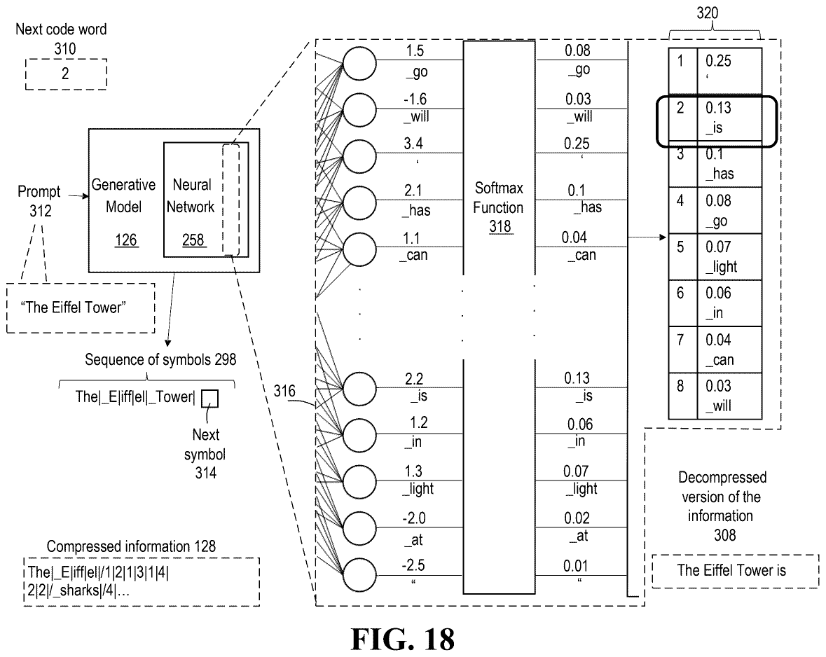

In some implementations, the decoder system 118 may force the generative model 126 to select the symbol corresponding to the index of the array represented by the next code word by re-prompting the generative model 126 with the previous symbols in the sequence generated plus the symbol corresponding to the index of the array represented by the next code word. One example of re-prompting generative model 126 is shown in FIG. 17 and FIG. 18. The example described below in FIGS. 17 and 18 is an example of step 250 of FIG. 14 where, prior to obtaining the array, the generative model 126 is prompted using a first portion of the symbols (e.g. “The Eiffel”) and at least one symbol following the first portion (e.g. “Tower” in FIG. 18).

In the example of FIG. 17, generative model 126 determines next symbol 300 in sequence of symbols 298 after being prompted with prompt 296. As shown in stippled box 302, the neural network 258 includes a layer in which there is a respective node corresponding to each possible next symbol that may be output by the generative model 126. The output from each node is indicative of a probability of the respective symbol being the next symbol 300. The value output from each node may be a number representing an unnormalized probability, as is the case in the illustrated example. The value output from each node may be a logit value, normalized probability, log probability etc. The plurality of values output from the layer of nodes may be or form a tensor, e.g. a tensor of logit values. In the example, a smaller number means a lower probability that the symbol is the next symbol 300. In the illustrated example, the output of the layer is input into a softmax function 304 that maps/scales the numbers into a probability between 0 and 1. Then, in the illustrated example, array 306 is determined based on the output of softmax function 304. In some implementations, array 306 may be generated from the values before softmax function 304 is applied. Array 306 comprises the eight highest values corresponding to the top eight most probable next symbols in the sequence of symbols 298. The symbol represented by the value at index 1 of array is selected as the appropriate next symbol 300, as the next code word 294 is “1”. Decompressed version of the information 308 comprises this symbol as the first decoded symbol in the series of decoded symbols.

In the illustrated example, after selecting the appropriate next symbol 300 the decoder system 118 may re-prompt generative model 126 with prompt 312 to generate a further next symbol 314, as shown in FIG. 18. Prompt 312 comprises prompt 296 (“The Eiffel”) as well as the selected next symbol 300 (“Tower”). As shown in stippled box 316, the neural network 156 includes a layer in which there is a respective node corresponding to each possible next symbol that may be output by the generative model 126. The output from each node is indicative of a probability of the respective symbol being the next symbol 314. The value output from each node may be a number representing an unnormalized probability, as is the case in the illustrated example. The value output from each node may be a logit value, normalized probability, log probability etc. The plurality of values output from the layer of nodes may be or form a tensor, e.g. a tensor of logit values. In the example, a smaller number means a lower probability that the symbol is the next symbol 314. In the illustrated example, the output of the layer is input into a softmax function 318 that maps/scales the numbers into a probability between 0 and 1. Then, in the illustrated example, array 320 is determined based on the output of softmax function 318. In some implementations, array 320 may be generated from the values before softmax function 318 is applied. Array 320 comprises the eight highest values corresponding to the top eight most probable next symbols in the sequence of symbols 298. The symbol represented by the value at index 2 of array is selected as the appropriate next symbol 314, as the next code word 310 is “2”. Decompressed version of the information 280 comprises this symbol as the second decoded symbol in the series of decoded symbols. With the sequence of symbols 298 now comprising the symbol “_is”, the steps illustrated by FIG. 17 and FIG. 18 may then continue for subsequent code words in the compressed information 128.

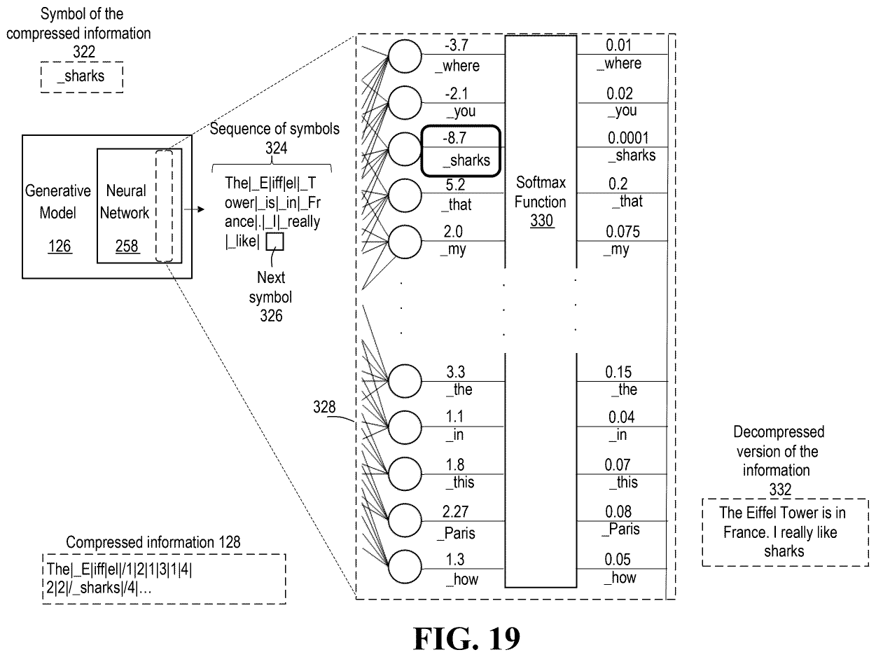

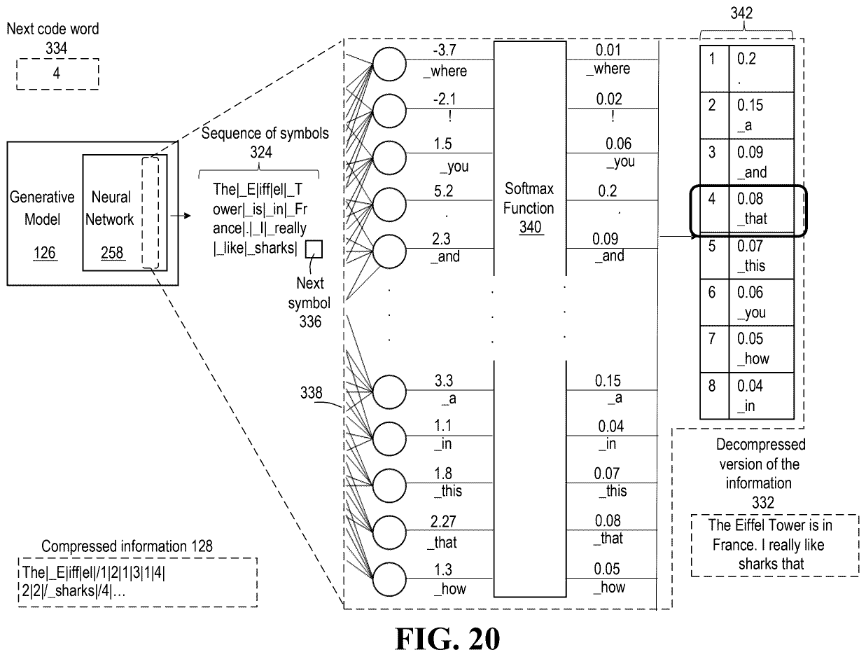

In some implementations, subsequent to determining the series of decoded symbols at step 250 of the method of FIG. 14, the decoder system 118 may encounter a particular symbol in the compressed information 128 rather than a code word. The method of FIG. 14 may further comprise prompting the generative model 126 using at least the first portion of the information, e.g. the first series of priming symbols, and the particular symbol. In some implementations, the decoder system 118 may encounter a second series of priming symbols in compressed information 128. Upon encountering a second series of priming symbols, the decoder system 118 may transition to priming mode 115. In some implementations, the second series of priming symbols may be followed by a second series of code words. In some implementations, encountering a second series of priming symbols may comprise encountering, in the compressed information 128, an indication of the end of the first series of code words and/or the start of the second series of priming symbols. In some implementations, encountering a second series of code words may comprise encountering, in the compressed information 128, an indication of the end of the first series of priming symbols and/or the start of the second series of code words. In some implementations, upon encountering a second series of priming symbols in the compressed information 128, the decoder system 118 may force the generative model to select, as the next symbol in the sequence it generates, each symbol in the second series of priming symbols, as shown in FIG. 19. The decoder system 118 may then transition back to indexing mode 117 and the process of determining decoded symbols may resume, using the second series of code words, as shown in FIG. 20.

In the example of FIG. 19, generative model 126 determines next symbol 326 in sequence of symbols 324. As shown in stippled box 328 the neural network 258 includes a layer in which there is a respective node corresponding to each possible next symbol that may be output by the generative model 126. The output from each node is indicative of a probability of the respective symbol being the next symbol 326. The value output from each node may be a number representing an unnormalized probability, as is the case in the illustrated example. The value output from each node may be a logit value, normalized probability, log probability etc. The plurality of values output from the layer of nodes may be or form a tensor, e.g. a tensor of logit values. In the example, a smaller number means a lower probability that the symbol is the next symbol 326. In the illustrated example, the output of the layer is input into a softmax function 330 that maps/scales the numbers into a probability between 0 and 1. In the illustrated example, the decoder system 118 has encountered, in the compressed information 128, a symbol of the compressed information 322, (“_sharks”). The decoder system 118 therefore transitions from indexing mode 117 to priming mode 115 and forces generative model 126 to select “_sharks” as the next symbol 326 in the sequence of symbols 324. The forcing may be done by the grammar-constraining or re-prompting methods described above. Decompressed version of the information 332 comprises this decoded symbol.

The example of FIG. 20 carries on from the example of FIG. 19. In the example of FIG. 20, generative model 126 determines next symbol 336 in sequence of symbols 324. As shown in stippled box 338, the neural network 258 includes a layer in which there is a respective node corresponding to each possible next symbol that may be output by the generative model 126. The output from each node is indicative of a probability of the respective symbol being the next symbol 336. The value output from each node may be a number representing an unnormalized probability, as is the case in the illustrated example. The value output from each node may be a logit value, normalized probability, log probability etc. The plurality of values output from the layer of nodes may be or form a tensor, e.g. a tensor of logit values. In the example, a smaller number means a lower probability that the symbol is the next symbol 336. In the illustrated example, the output of the layer is input into a softmax function 340 that maps/scales the numbers into a probability between 0 and 1. In the illustrated example, the decoder system 118 has encountered, in the compressed information 128, next code word 334. The decoder system transitions back to indexing mode 117. Returning to the process of determining decoded symbols using code words, array 342 is determined based on the output of softmax function 340. In some implementations, array 342 may be generated from the values before softmax function 340 is applied. Array 342 therefore comprises the eight highest values corresponding to the top eight most probable next symbols in the sequence of symbols 324. The symbol corresponding to the value at index 4 of array is selected as the appropriate next symbol 336, as the next code word 334 is “4”. Decompressed version of the information 332 comprises this decoded symbol. The decoder system 118 may continue to determine decoded symbols using any subsequent code words in the second series of code words.

In some implementations, the method of FIG. 14 may further comprise obtaining at least one configuration setting, e.g. configuration settings 130, for the generative model 126 and, prior to prompting the generative model 126, applying the at least one configuration setting to the generative model 126. For successful decompression, the decoder system 118 must generate the same or substantially the same output as the encoder system 102 has, given the same input/prompting. The decoder may therefore first synchronize the generative model 126 into the correct starting state based on the at least one obtained configuration setting. The at least one configuration setting may be a configuration setting as described above with reference to configuration settings 130. The at least one configuration setting may be used to synchronize generative model 110 with generative model 126, such that both generative models generate the same or substantially the same output given the same input. In some implementations, this may be accomplished by applying identical configuration settings to both generative model 110 and generative model 126. In some implementations, different configuration settings may be applied to each model as long as both generative models, after configuration, generate the same or substantially the same output given the same input. In some implementations, the generative model 110 at the encoder system 102 and the generative model 126 at the decoder system 118 may be configured based on a set of configuration settings known to each system without one system providing the set of configuration settings to the other. While obtaining at least one configuration setting and/or configuring generative model 126, decoder system 118 may be in configuring mode 111. Once generative model 126 has been configured, the decoder system 118 may transition to decoding mode 113.

In some implementations, at least one configuration setting may be obtained from encoder system 102. In some implementations, at least one configuration setting may be obtained together with the compressed information 128. In some implementations, the compressed information 128 may comprise indications of where encoder system 102 had transitioned to configuring mode 103, e.g. where encoder system 102 reconfigured generative model 110. Upon encountering such an indication, decoder system 118 may transition to configuring mode 111 and may reconfigure generative model 126.

In some implementations, as discussed above, the at least one configuration setting may comprise fine-tuning data. In some implementations, the fine-tuning data may be obtained together with the compressed information 128. In some implementations, the method of FIG. 14 may further comprise, prior to prompting the generative model 126, obtaining fine-tuning data based on at least weighting information of the generative model 126. The method of FIG. 14 may then further comprise performing fine-tuning of the generative model 126 based on the fine-tuning data. In some implementations, the at least one configuration setting may comprise a plurality of sets of fine-tuning data. In such implementations, the compressed information 128 may indicate to decoder system 118 when to change the fine-tuning of generative model 126 (e.g. by indicating where encoder system 102 transitioned to configuring mode 103) and decoder system 118 may transition to configuring mode 111 before changing the fine-tuning of generative model 126.

In some implementations, the at least one configuration setting may comprise an indication of a particular generative model to use as generative model 126. In some implementations, the at least one configuration setting may comprise an indication of a particular set of generative models. In such implementations, the compressed information 128 may indicate to decoder system 118 when to change the generative model being used as generative model 126. In some implementations, distillation may be used to generate at least one generative model, to be used as generative model 126, to more efficiently compress specific types or formats of data.

In some implementations, as discussed above, the at least one configuration setting may comprise an identifier that corresponds to a particular set of configuration settings and/or a particular instance of fine-tuning data. Therefore, in some implementations, the method of FIG. 14 may further comprise, prior to configuring the generative model 126, retrieving a particular set of configuration settings and/or a particular instance of fine-tuning data based on the identifier.

In some implementations, at least one additional grammar-constraining data structure may have been used by the encoder in generating compressed information 128, as described above with reference to encoder system 102. The decoder system 118 may receive, as part of the at least one configuration setting or by a different method, at least one additional grammar-constraining data structure that defines what constitutes a valid sequence of symbols. The at least one additional grammar-constraining data structure may be used to constrain the set of symbols that could be chosen as the next symbol in the sequence of symbols generated by the generative model 126. The compressed information 128 may comprise indications of change in grammar-constraints to decoder system 118.

In some implementations, before the array of values is obtained, the additional grammar-constraining data structure may be applied first followed by a grammar-constraining data structure that forces the generative model 126 to select the correct next symbol, as described above.

In some implementations, information may be compressed and decompressed using more than one generative model. For example, a web page may contain a mix of computer readable code (HTML, JavaScript™, CSS, etc.) and human readable content. The code may be best compressed by a first generative model trained or fine-tuned on computer language, while the human paragraphs may be best compressed by a second generative model trained or fine-tuned on readable text. A change of generative models, or a change in configuration of the generative model, may be indicated in the compressed information 128 received by the decoder system 118, so that the appropriate model or configuration of a model may be used in decoding the appropriate portions of the compressed information 128.

In some implementations, obtaining compressed information 128 may comprise obtaining a version of the compressed information where at least a portion has been further compressed by the encoder, e.g. using a further lossless compression method. The method of FIG. 14 may therefore further comprise performing decompression using a lossless decompression method (e.g. Huffman coding, LZ77, LZW, run-length coding etc.) in order to obtain compressed information 128. In some implementations, obtaining compressed information 128 may comprise obtaining a version of the compressed information where at least a portion, e.g. at least one series of code words, has been further encoded by the encoder. The method of FIG. 14 may therefore further comprise performing decoding using a conventional coding algorithm, e.g. delta coding, in order to obtain compressed information 128.

In some implementations of the method of FIG. 14, the generative model 126 does not necessarily have to be prompted by a portion (e.g. first portion) of the information. For example, there might be another prompt that is preconfigured or predefined, e.g. stored in advance at both the encoder and decoder side. However, in the illustrated example, the generative model 126 is prompted using a first portion of the series of symbols of the information (“The Eiffel”) in order to decompress a second series of symbols of the information comprising a series code words (“1|2|1|3|1|4|2|2”) and, as a result, obtain a series of decompressed symbols (“Tower is in France. I really like”).

In the examples described above with respect to FIGS. 7-12 and 15-20, compression is achieved (and decompression is performed) because the number of bits used to represent a code word is less than the number of bits used to represent the symbol itself. In the illustrated example, the code word dictionary size is eight (corresponding to the top eight most probable next symbols), which means a code word size of three bits, assuming fixed-length code words. Three bits is a lot less than the number of bits needed to uniquely represent a symbol. A symbol might require, e.g. 16 bits, to be represented, depending upon the symbol dictionary. Compression from 16 bits to 3 bits is a notable technical improvement. Moreover, in some implementations, the string of bits representing the series of code words (along with or without priming symbols) may be further compressed using another conventional compression algorithm, such as Lempel-Ziv-Welch (LZW) or Huffman, etc. or a using a conventional encoding algorithm such as delta coding, resulting in further overall compression. The compression is lossless, even though a generative model is being used.

Another method of performing the compression/decompression using a generative model is as follows. The generative model 110 of the encoder system 102 may be primed with at least one symbol from the information to be compressed 112, referred to herein as “the priming symbols”. In response, the generative model 110 may provide predictions as to the next symbols of the information to be compressed 112. The priming symbols may then be provided to identically configured generative model 126 at the decoder system 118 so that the generative model 126 would make the same predictions as the generative model 110. The compressed information 128 may comprise the priming symbols, along with an indication that each predicted next symbol is correct. It is mentioned earlier that such a technique might only achieve minimal or poor compression because the prediction provided by the generative model might not be the correct next symbol of the input text. To mitigate this problem and improve the compression, the generative model 110 may first be fine-tuned using fine-tuning data based on the information to be compressed 112 and generated in the manner described earlier, e.g. via a LoRA technique. The fine-tuning data may then be provided to the decoder system 118, and the generative model 126 may be fine-tuned in the same way. The fine-tuning based on the information to be compressed 112 may improve the predictive ability of the generative models 110 and 126 such that they mostly or almost always (or always) correctly predict the next symbol of information given the priming symbols. The code words representing indexes in an array, as described earlier, would not be needed because the generative models 110 and 126 would make the correct top prediction more often and, therefore, a compressed version of the information would only have to include a representation of any series of priming symbols followed by, for each series, how many top predictions are correct before the next series of priming symbols should be used. For example, if, after being prompted with a first series of priming symbols, generative model 110 made 20 correct top predictions in a row, the compressed version of the information would comprise the first series of priming symbols and an indication to that the next 20 top predictions are correct decoded symbols.

In some implementations, generative models 110 and 126 may be multi-purpose models used for more than the methods of performing compression/decompression described herein. For example, generative models 110 and 126 may be models stored on or accessible by a user device and used for a variety of tasks. In some implementations, generative models 110 and 126 may be trained specifically for the compression/decompression described herein. In some implementations, generative models 110 and 126 may be trained to compress/decompress data in general. In some implementations, generative models 110 and 126 may be trained to compress/decompress a specific type of data, e.g. webpages. In some implementations, generative models 110 and 126 may be generated/trained using at least one existing generative model (e.g. using distillation techniques).

The methods of performing compression/decompression described herein may be employed in typical applications of compression/decompression, e.g. compression of data for transmission, compression of data for storage, etc.

Technical benefits of some implementations of the compression and decompression methods described herein include the following. As described earlier, in computer systems there is limited storage to store data and limited bandwidth to transmit data. By performing compression, less data needs to be stored and transmitted, which results in improved computer functionality because fewer memory resources and fewer transmission resources are used to store and transmit the data, once compressed. Moreover, by using a generative machine-learning model for the compression/decompression, a new encoding/decoding method is provided that can leverage existing generative machine-learning models, thereby leveraging existing resources to achieve additional/new technical outcomes (compression and decompression), rather than expending new computer resources. For example, the computer system may already have stored thereon or access to a generative machine-learning model, e.g. for existing applications. The computer system can now interface with that existing computing resource to also compress and/or decompress data, which is an improvement in use of the existing technology of generative machine-learning. The compression/decompression can be lossless, despite the use of generative symbol/token prediction, which is an improvement. Moreover, the use of a code word to represent an index in an array of values associated with symbols/tokens, rather than using a code word to represent a symbol/token itself, is also a technical improvement. This allows for a dynamic code word dictionary in which the symbol/token associated with the code word can change during compression. The result may be, in some implementations, better compression ratio, e.g. ultimately representing symbols/tokens in fewer bits because the code word is associated with an index in an array, and the symbol/token associated with that index in the array can change each iteration, dependent upon how probable it is that the symbol/token is a next symbol/token in the sequence generated by the generative machine-learning model. Encoding/decoding may therefore be improved compared to conventional lossless compression/decompression. That is, the existing technology related to compression/decompression may be improved. Moreover, in some implementations, conventional lossless compression/decompression may be combined with the compression/decompression using the generative machine-learning model to achieve an even better compression ratio. For example, as described earlier, the compressed version of the information of step 150 of FIG. 5 may be further compressed using a conventional method, e.g. Lempel-Ziv-Welch (LZW) or Huffman, etc., which is an improvement compared to the existing technology related to compression/decompression.

In some implementations of the encoder and decoder discussed above, it may be desirable that the compressed version of the information is only able to be decompressed by an authorized party. It may therefore be desirable to encrypt the information before compressing it. However, compression of encrypted data may be difficult and/or inefficient as encrypted data may look completely random, and encryption of the information prior to compression might hinder or prevent compression using a generative model.

To address these problems, a generative model can be further employed to provide encryption/decryption of the information within the compression/decompression methods described above. A generative model may also be used to provide encryption/decryption of information separate from the compression/decompression methods described above.

As described above, the first instance of the generative model, at the encoder, and the second instance of the generative model, at the decoder, are configured such that given the same input will generate the same or substantially the same output. Therefore, if the encoder and decoder keep the necessary at least one configuration setting secret, it can be used as a shared secret, as at least one configuration setting is required to reconstruct the compressed information. An unauthorized party would not be able to decode the code words without at least one configuration setting.

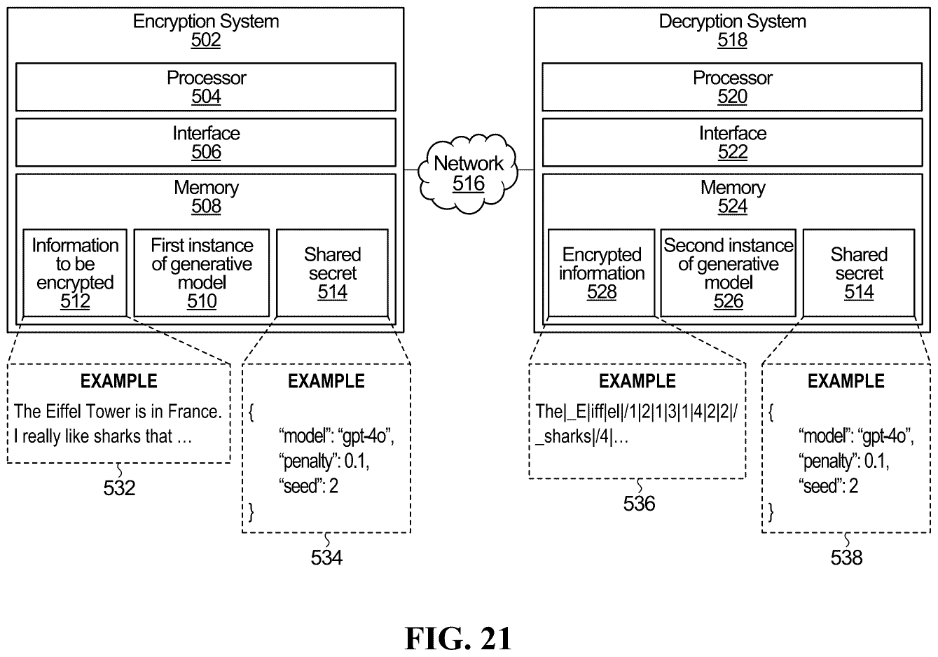

FIG. 21 illustrates an example system for encrypting and decrypting data using a generative model. The system includes an encryption system 502, alternatively referred to as an encoder. The encryption system 502 includes a processor 504, a memory 508, and an interface 506. The processor 504 controls the operations of the encryption system 502. The processor 504 may be implemented by one or more processors that execute instructions stored in the memory 508. Alternatively, some or all of the processor 504 may be implemented using dedicated circuitry, such as an application specific integrated circuit (ASIC), a graphics processing unit (GPU), or a programmed field programmable gate array (FPGA). The memory 508 stores information (e.g. content and/or instructions, etc.). The interface 506 interfaces with a network 516 to perform communication (transmit/receive) over the network 516. The network 516 may be, for example, the Internet or an Intranet or local network. The structure of the interface 506 will depend on how the encryption system 502 interfaces with the network 516. For example, if the encryption system 502 is connected to the network 516 with a network cable, the interface 506 may comprise a network interface card (NIC), and/or a computer port (e.g. a physical outlet to which a plug or cable connects), and/or a network socket, etc. If the encryption system 502 is part of a wireless device, such as a mobile phone or laptop, the interface 506 might be or include a transmitter/receiver with an antenna to send and receive wireless transmissions to/from the network 516.

In some implementations, the encryption system 502 may be distributed, e.g. it may comprise one or more servers or computing devices, in which case processor 504 might actually consist of multiple processors communicating with each other over a communication link (e.g. over a network), and similarly memory 508 might be distributed across multiple servers or computing devices.

In the example system, the memory 508 further stores a first instance of a generative model, referred to as generative model 510. By “storing” the generative model 510, it is meant that the parameters and other values that make up the model and that are required for execution of the model are stored. The parameters depend upon how the generative model 510 is implemented. For example, assuming the generative model 510 utilizes one or more neural networks, the weights and biases of the one or more neural networks are stored.

The generative model 510 may be implemented as an LLM. In some implementations, generative model 510 may have the example LLM structure described earlier in relation to FIG. 1B, or it may have another structure. The exact structure of the generative model 510 is implementation specific, although in the example of system of FIG. 21 it is assumed that the generative model 510 has at least one neural network. The generative model 510 may generate thousands of different symbols, or more. In some implementations, the generative model 510 may have a symbol (e.g. token) dictionary, comprising a list of symbols which may be generated by the generative model 510.

The generative model 510 may be implemented by the processor 504. In some implementations, the processor 504 may be a specialized processing unit, e.g. one designed to accelerate computer operations of a generative model through parallelization of operations, which may allow for faster execution of the generative model compared to a more general-purpose processing unit. For example, the processor 504 may be or include a GPU or a tensor processing unit (TPU) or a neural processing unit (NPU) or a hardware accelerator. In some implementations, the processor 504 may comprise a specialized processing unit paired with a general-purpose processing unit, e.g. a computer, central processing unit (CPU), and/or other computing device such as a server.

In some implementations, the generative model 510 may be stored separately, not on the encryption system 502. For example, the encryption system 502 may communicate with the generative model 510 by sending prompts over a network, e.g. network 516, via a generative model interface, e.g. interface 506 (which may be an API), to the generative model 510 and receiving response back from the generative model. In some implementations, the generative model 510 may be provided by a software-as-a-service (SaaS) provider, e.g. Open AI™, Microsoft Azure™, etc.

The memory 508 may further store information to be encrypted 512. Information to be encrypted 512 may be text, or a representation of text, represented as a series of symbols. Information to be encrypted 512 may be represented as a series of symbols where each symbol is found in the symbol dictionary of generative model 510. The example information to be encrypted shown in box 532 is a string (“The Eiffel Tower is in France. I really like sharks that . . . ”). In the example shown in box 532, the information to be encrypted is truncated. In some implementations, the information to be encrypted 512 may be represented by bits. In some implementations, the information to be encrypted 512 may be represented as a series of symbols, where each symbol is represented by one or more bits, e.g. 16 bits per symbol. In some implementations, information to be encrypted 512 may be stored somewhere other than memory 508. For example, information to be encrypted 512 may be stored in an external data source and may be accessed by encryption system 502 over a network, e.g. network 516, via an interface, e.g. interface 506.

The memory 508 may further store shared secret 514 comprising at least one configuration setting for a generative model. In some implementations, the generative model 510 is configured based on at least one configuration setting. Examples of configuration settings may include settings that control the length, style, and/or content output from the generative model, e.g. maximum or minimum number of tokens, and/or randomness of the output (e.g. temperature), and/or a stopping criteria, and/or a generation seed (such that if the same seed is used, the model returns the same output), and/or a quantization parameter etc. The temperature parameter, minimum length of the output and/or maximum length of the output, the frequency penalty parameter, and the “best of” parameter discussed earlier are examples of configuration settings. In some implementations, the at least one configuration setting may comprise fine-tuning data for a generative model. Fine-tuning data may comprise weights and/or biases. In some implementations, the at least one configuration setting may comprise an identifier that corresponds to a particular set of configuration settings and/or a particular instance of fine-tuning data that is accessible to the encryption system 502. For example, the particular set of configuration settings and/or particular instance of fine-tuning data may be stored in memory 508.

Stippled box 534 shows an example of shared secret 514. In this example, shared secret 514 comprises three configuration settings. The configuration settings that are represented with JSON and comprise key value pairs that define a version of the model, a penalty, and a generation seed. When these configuration settings are applied to the generative model 510, the outputs of generative model 510 are influenced. In the illustrated example, configuration settings are represented with JSON. However, other representations are possible. For example, configuration settings may be represented by any data record with fixed fields and/or by data in a defined order with delimiters, e.g. configuration settings may be represented using Avro, XML, protocol buffers, MessagePack, etc.

The system of FIG. 21 further includes a decryption system 518 which communicates with encryption system 502 via network 516. The decryption system 518 includes a processor 520, a memory 524, and an interface 522. The processor 520 controls the operations of the decryption system 518. The processor 520 may be implemented by one or more processors that execute instructions stored in the memory 524. Alternatively, some or all of the processor 520 may be implemented using dedicated circuitry, such as an application specific integrated circuit (ASIC), a graphics processing unit (GPU), or a programmed field programmable gate array (FPGA). The memory 524 stores information (e.g. content and/or instructions, etc.). The interface 522 interfaces with network 516 to perform communication (transmit/receive) over the network 516. The structure of the interface 522 will depend on how the decryption system 518 interfaces with the network 516. For example, if the decryption system 518 is connected to the network 516 with a network cable, the interface 522 may comprise a network interface card (NIC), and/or a computer port (e.g. a physical outlet to which a plug or cable connects), and/or a network socket, etc. If the decryption system 518 is part of a wireless device, such as a mobile phone or laptop, the interface 522 might be or include a transmitter/receiver with an antenna to send and receive wireless transmissions to/from the network 516.

In some implementations, the decryption system 518 may be distributed, e.g. it may comprise one or more servers or computing devices, in which case processor 520 might actually consist of multiple processors communicating with each other over a communication link (e.g. over a network), and similarly memory 524 might be distributed across multiple servers or computing devices.

In the example system, the memory 524 further stores a second instance of a generative model, referred to as generative model 526. By “storing” the generative model 526, it is meant that the parameters and other values that make up the model and that are required for execution of the model are stored. The parameters depend upon how the generative model 526 is implemented. For example, assuming the generative model 526 utilizes one or more neural networks, the weights and biases of the one or more neural networks are stored.

“First instance of a generative model” and “second instance of a generative model” are used herein to mean separate implementations of the same generative model that are configured in the same way, such that given the same input they produce the same or substantially the same output. Each instance may be stored separately. Each instance may be accessed independently and may take a different form. For example, one instance of the generative model might be stored in memory and accessed directly while another instance of the generative model is accessed via a third-party API.

The generative model 526 may be implemented as an LLM. In some implementations, generative model 526 may have the example LLM structure described earlier in relation to FIG. 1B, or it may have another structure. The exact structure of the generative model 526 is implementation specific, although in the example of system of FIG. 21 it is assumed that the generative model 526 has at least one neural network. The generative model 526 may generate thousands of different symbols, or more. In some implementations, the generative model 526 may have a symbol (e.g. token) dictionary, comprising a list of symbols which may be generated by the generative model 526.

The generative model 526 may be implemented by the processor 520. In some implementations, the processor 520 may be a specialized processing unit, e.g. one designed to accelerate computer operations of a generative model through parallelization of operations, which may allow for faster execution of the generative model compared to a more general-purpose processing unit. For example, the processor 520 may be a GPU or a tensor processing unit (TPU) or a neural processing unit (NPU) or a hardware accelerator. In some implementations, the processor 520 may comprise a specialized processing unit paired with a general-purpose processing unit, e.g. a computer, central processing unit (CPU), and/or other computing device such as a server.

In some implementations, the generative model 526 may be stored separately, not on the decryption system 518. For example, the decryption system 518 may communicate with the generative model 526 by sending prompts over a network, e.g. network 516, via a generative model interface, e.g. interface 522 (which may be an API), to the generative model 526 and receiving response back from the generative model. In some implementations, the generative model 526 may be provided by a software-as-a-service (SaaS) provider, e.g. Open AI™, Microsoft Azure™, etc.

The memory 524 may further store encrypted information 528. The encrypted information 528 may be a string, e.g. a string of bits representing symbols and/or code words. The encrypted information 528 may comprise at least one series of code words. A series of code words may be represented by bits. For example, each code word may comprise a fixed number of bits. The series of code words may be represented by a data structure. For example, the series of code words may be a tree generated by applying a variable length encoding method, e.g. Huffman coding, to a series of values. In some implementations, the encrypted information 528 may additionally comprise at least one symbol. Each symbol may represent a word, a portion of a word, or some other portion of data. For example, the encrypted information 528 may comprise at least one symbol representing a portion of the information used to prime generative model 510. In some implementations, the encrypted information 528 may include at least one reserved symbol. The at least one reserved symbol may be used to represent the length of a series of symbols and/or the length of a series of code words. In some implementations, a reserved symbol may be inserted in the encrypted information 528 to indicate at least one of the start and end of a series and therefore the length of the series. In some implementations, the reserved symbol may represent a numerical value corresponding to the length of a series. In some implementations, another method of indicating the length of a series of symbols and/or a series of code words may be used.

In some implementations, encrypted information 528 may be stored somewhere other than memory 524. For example, encrypted information 528 may be stored in an external data source and may be accessed by decryption system 518 over a network, e.g. network 516, via an interface, e.g. interface 522.

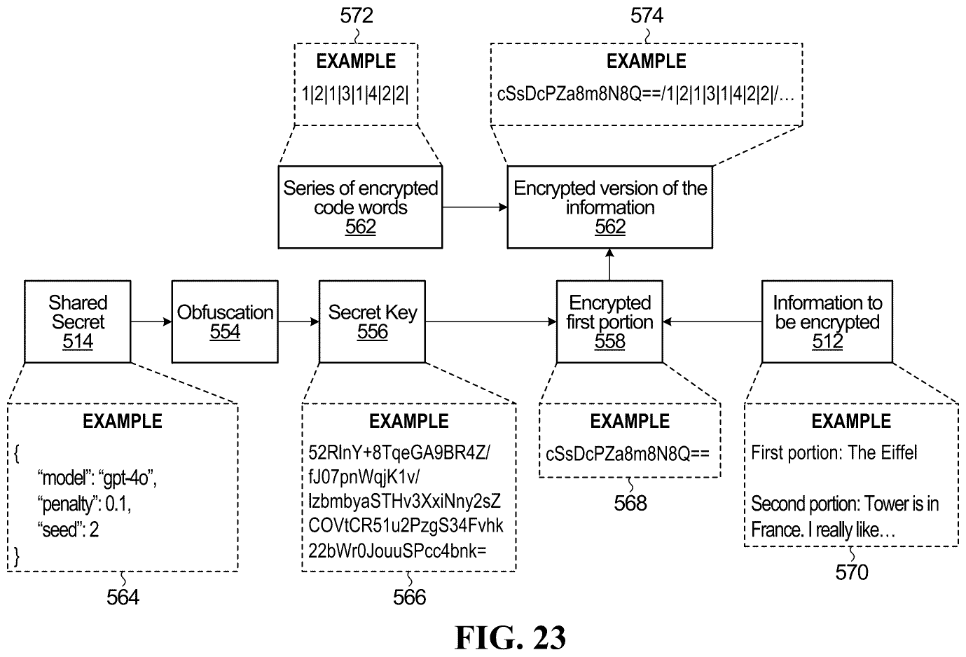

One example of encrypted information 528 is shown in stippled box 536. In the example, the encrypted information comprises a first series of priming symbols, followed by a first reserved symbol (“/”) indicating the length of the first series of priming symbols, followed by a first series of code words, followed by a second reserved symbol (“/”) indicating the length of the first series of code words, followed by a second series of priming symbols (“sharks”), followed by a third reserved symbol (“/”) indicating the length of the second series of code words, followed by the start of a second series of code words. In this example, the code words represent the encrypted portion of the information. The priming symbols are not encrypted in the example in box 536, although they could be encrypted (as is the case in the example in FIG. 23 described below). The use of “/” to represent all four reserved symbols is merely an example. In some implementations, each of the first, second, third, and fourth reserved symbols may each be represented differently, e.g. with different symbols. In some implementations, each reserved symbol may comprise more than one symbol.

In the example shown in stippled box 536, the first series of priming symbols comprises four symbols which break down as follows: “The|_E|iff|el|”, where “|” is used herein to delineate an end of a symbol and the end of a code word, and “_” is used herein to indicate a blank space. The use of “|” and “_” in the illustrated examples are merely depictions used in the drawings to aid in understanding. Other delimiters may be used to indicate the end of a symbol and/or the end of a code word. Blank spaces may be indicated in a different way. This corresponds to the first portion of the example information to be encrypted shown in stippled box 532. In the example shown in stippled box 536, the first series of code words comprises eight code words, each represented by a single digit integer (i.e. the series is 1, 2, 1, 3, 1, 4, 2, 2). Each code word in the example first series of code words corresponds to a symbol of the example information to be encrypted 512 shown in stippled box 532. For example, the first code word in the series (“1”) corresponds to the symbol “_Tower|”, and the second code word in the series (“2”) corresponds to the symbol “_is|”. In the example shown in stippled box 536, the second series of priming symbols includes only the symbol “_sharks”, which corresponds to the symbol of the example information to be encrypted 512 shown in stippled box 532 that immediately follows the symbols represented by the first series of code words. In the example shown in stippled box 536, the second series of code words only contains one code word (“4”) which corresponds to the symbol “_that” as this symbol immediately follows the symbol “_sharks” in the example information to be encrypted shown in stippled box 532.

The memory 524 may further store shared secret 514, comprising at least one configuration setting for a generative model. To ensure that the generative model 510, of the encryption system 502, and the generative model 526, of the decryption system 518, produce the same or substantially the same output when given the same input, shared secret 514 may be common to both systems. In some implementations, the generative model 526 is configured based on at least one configuration setting. Examples of configuration settings may include settings that control the length, style, and/or content output from the generative model, e.g. maximum or minimum number of tokens, and/or randomness of the output (e.g. temperature), and/or a stopping criteria, and/or a generation seed (such that if the same seed is used, the model returns the same output), and/or a quantization parameter etc. The temperature parameter, minimum length of the output and/or maximum length of the output, the frequency penalty parameter, and the “best of” parameter discussed earlier are examples of configuration settings. In some implementations, the at least one configuration setting may comprise fine-tuning data for a generative model. Fine-tuning data may comprise weights and/or biases. In some implementations, the at least one configuration setting may comprise an identifier that corresponds to a particular set of configuration settings and/or a particular instance of fine-tuning data that is accessible to the decryption system 518. For example, the particular set of configuration settings and/or particular instance of fine-tuning data may be stored in memory 524.

Encryption system 502 and decryption system 518 may communicate with each other over network 516. In some implementations, decryption system 518 may receive encrypted information 528 from encryption system 502 via network 516. In some implementations, decryption system 518 may receive configuration settings from encryption system 502 via network 516 in a secure manner since the configuration settings form the shared secret 514. In some implementations, encryption system 502 may encrypt the information to be encrypted 512 to generate an encrypted version of the information, and then transmit the encrypted version of the information to decryption system 518 via network 516. In some implementations, encryption system 502 may transmit shared secret 514 to decryption system 518 via network 516 in a secure manner, whereas in other implementations the shared secret 514 may be issued to decryption system 518 in another manner, e.g. by a trusted authority out-of-band.

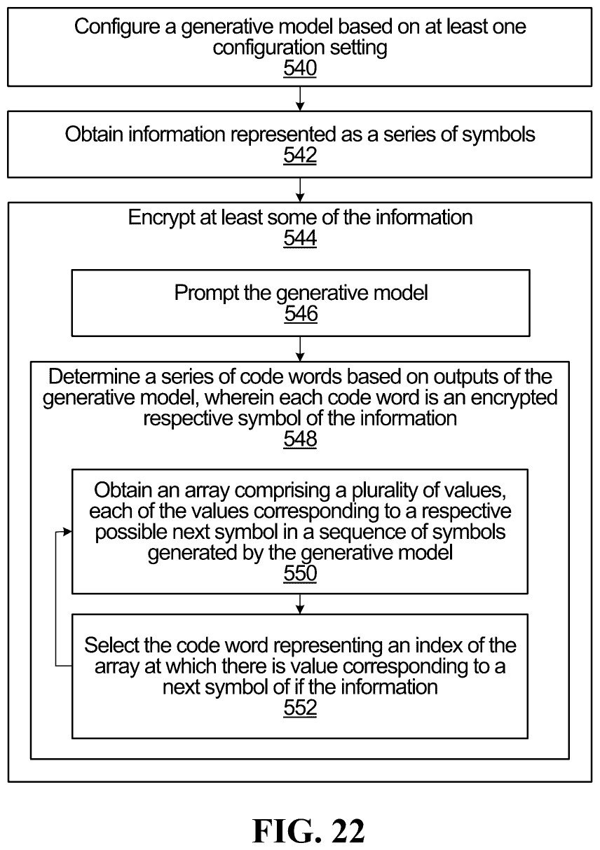

FIG. 22 illustrates an example method performed by encryption system 502.

At step 540, the encryption system 502 configures generative model 510 based on at least one configuration setting, e.g. shared secret 514. The at least one configuration setting may comprise any of the configuration settings described above. In some implementations, the at least one configuration setting, when applied to an instance of the generative model, influences the outputs of the generative model. In some implementations, the at least one configuration setting comprises at least one of a temperature value, a generation seed, a presence penalty, a frequency penalty, or a quantization parameter. In some implementations, the at least one configuration setting may comprise a temperature value of zero. In some implementations, the at least one configuration setting may comprise data used to fine-tune the generative model. In some implementations, the at least one configuration setting may comprise an identifier that corresponds to a particular set of configuration settings.

At step 542, the encryption system 502 obtains information to be encrypted 512 represented as a series of symbols. In some implementations, the information to be encrypted 512 may include a first portion of the series of symbols (e.g. used to prompt the generative model 510) and a second portion of the series of symbols (e.g. which are encrypted to a series of code words using the generative model 510). In some implementations, the encryption system 502 may obtain information to be encrypted 512 and then obtain its representation as a series of symbols. In some implementations, information to be encrypted 512 may be obtained and then tokenized in a method similar to that explained above with reference to FIG. 6. In some implementations, the information to be encrypted 512 may be tokenized in stages. For example, only a first portion of the information to be encrypted 512 may be tokenized before encryption starts with subsequent portions of the information being tokenized on the fly, before encryption of each subsequent portion.

At step 544, the encryption system 502 encrypts at least some of the information to be encrypted 512 by performing the subsequent steps below.

At step 546, the encryption system 502 prompts generative model 510. In some implementations, the generative model 510 may be prompted with the first portion of the series of symbols representing the information to be encrypted 512. In some implementations, the generative model 510 may be prompted with a different series of symbols. In some implementations, the generative model 510 does not necessarily have to be prompted by a portion (e.g. first portion) of the information 512. For example, there might be another prompt that is preconfigured or predefined, e.g. stored in advance at both the encoder and decoder side.

At step 548, the encryption system 502 determines a series of code words based on outputs of the generative model 510, wherein each code word is an encrypted respective symbol of the information to be encrypted 512. In some implementations, the encryption system 502 may determine more than one series of code words. In some implementations, the second portion of the series of symbols representing the information to be encrypted 512 is represented by the series of code words.

In some implementations, a fixed length, e.g. a fixed number of bits, may be used to represent each code word. In some implementations, a variable length encoding may be used for the code words (e.g. prefix code, Huffman code, run-length encoding etc.).

Encryption system 502 may have a list of acceptable code words, referred to herein as a dictionary of code words. The term “code word” as used herein means any representation of which index of the array a particular symbol of the information to be encrypted 512 is mapped to. In some implementations, a single code word may be a combination of more than one code word in the dictionary of code words. In some implementations, a plurality of symbols of the information may be represented by the same code word.

At sub-step 550, to determine a code word (e.g. each code word) in the series of code words, the encryption system 502 obtains an array comprising a plurality of values, each of the values corresponding to a respective possible next symbol in a sequence of symbols generated by the generative model 510. In some implementations, each of plurality of values in the array may be indicative of a probability of the corresponding respective possible next symbol being a next symbol in the symbol sequence generated by the generative model 510.

In some implementations, the array obtained at sub-step 550 may be processed (e.g. sorted) to obtain an ordered list of the top N values corresponding to the top N most probable next symbols in the sequence of symbols generated by the generative model 510. The value corresponding to the highest probability may be at the first index with the value corresponding to the second highest probability at the second index and so on. In another implementation, another ordering could be employed. For example, the top N probabilities could be identified and then presented in a data structure unsorted. This method may be beneficial in a system that uses code words of a fixed length where sorting the entire array may consume significant computing resources. In some implementations, the array obtained at sub-step 550 may be truncated to a length smaller than the length of the full dictionary of symbols known to the generative model 510. In some implementations, the array obtained at sub-step 550 may be sorted in an order established by an encryption key, e.g. secret key 556 described below. This may provide for an additional layer of obfuscation.

In some implementations, obtaining the array at sub-step 550 may comprise identifying a set of highest probable values based on the output of the generative model 510. The set of highest probable values may contain a number of values equal to a number of code words in the code word dictionary. For example, the code word dictionary may comprise eight code words, e.g. the numbers 1-8 or their representations, each representing an index of an array comprises the eight highest probable values.

At sub-step 552, to determine a code word or each code word in the series of code words, the encryption system 502 selects the code word representing the index of the array at which there is a value corresponding to a next symbol of the information to be encrypted 512.

The method of FIG. 22 is applied in conjunction with compression as described above with reference to FIG. 5 and FIG. 7-FIG. 12. That is, the compression explained above in relation to FIG. 5 and FIG. 7-FIG. 12 also provides an encryption because each code word is an encrypted version of its corresponding symbol. To decrypt, the shared secret is required, which is the at least one configuration setting. Therefore, the examples described above in relation to FIG. 5 and FIG. 7-FIG. 12 equally apply to encryption, where the code word not only represents a compressed version of a symbol, but also represents an encrypted version of the symbol. However, this need not necessarily be the case. Regardless of whether the information is or is not to be compressed, the generative model 510 may be used to encrypt at least some of the information to be encrypted 512. Specifically, the series of code words output using the generative model 510 in the way described above can be considered encrypted symbols of the information, where each code word may be an encrypted respective symbol of the information. If the examples explained in relation to FIG. 7-FIG. 12 were modified such that the code word dictionary size was 4096 instead of 8, i.e. 12 bits per code word instead of 3 bits per code word, then each code word would still act as an encrypted version of a symbol, but compression might not necessarily be achieved because each code word would have almost as many bits as it would take to represent the original symbol. If the code word dictionary size was the same size as the number of symbols, then there would be no compression, but each index of the vector/array of (normalized or unnormalized) probability values would have a unique code word, so there would not be a need to have any priming symbols, i.e. each symbol of the information could be represented by a corresponding code word.

In some implementations, as discussed above, the at least one configuration setting may comprise fine-tuning data. In some implementations, the method of FIG. 22 may further comprise, prior to prompting the generative model 510, generating fine-tuning data based on at least weighting information of the generative model 510 and/or a plurality of symbols of the information, e.g. at least a portion of the information to be encrypted 512. The method of FIG. 22 may then further comprise performing fine-tuning of the generative model 510 based on the fine-tuning data. Fine-tuning data may be generated, e.g. by using a LoRA technique, prefix tuning etc. In some implementations, the fine-tuning data may be based on the entirety of the information to be encrypted 512. In some implementations, the fine-tuning data may be generated based on an initial portion of the information to be encrypted 512. This initial portion may be of a variable length. For example, the fine-tuning data may be generated based on the first 200 symbols of the information to be encrypted 512. In other implementations, the information to be encrypted 512 may be sampled to extract a determined number of symbols and then the fine-tuning data may be generated by training on the extracted set of symbols. For example, the fine-tuning data may be generated based on 200 symbols sampled randomly from the information to be encrypted 512.

In some implementations, as discussed above, the at least one configuration setting may comprise an identifier that corresponds to a particular set of configuration settings and/or a particular instance of fine-tuning data. Therefore, in some implementations, the method of FIG. 22 may further comprise, obtaining the identifier and determining the particular set of configuration settings and/or particular instance of fine-tuning data, where the at least one configuration setting comprises the particular set of configuration settings and/or particular instance of fine-tuning data.

In some implementations, the method of FIG. 22 may further comprise obtaining a secret key representative of at least one configuration setting, e.g. shared secret 514. In some implementations, the secret key may be used to at least encrypt the first portion of the series of symbols representative of encrypted information 528. In some implementations, obtaining the secret key may comprise obfuscating at least one configuration setting, e.g. shared secret 514. Obfuscating may involve ciphering, (e.g. using a stream cipher, a block cipher in output feedback (OFB) mode etc.), at least one portion of the at least one configuration setting, and/or hashing at least one portion of the at least one configuration setting, and/or some other method that is agreed upon by the encryption system 502 and the decryption system 518.

In some implementations, the method of FIG. 22 may further comprise generating an encrypted version of the information. The encrypted version of the information may comprise at least one series of encrypted code words. In some implementations, the encrypted version of the information may comprise at least one series of priming symbols. In some implementations, the encrypted version of the information may take any of the forms described above with reference to a compressed version of the information.

In some implementations, the generative model 510 may be prompted, at step 546, with the first portion of the series of symbols, where the second portion of the series of symbols is represented by the series of code words determined at step 548. In some implementations, the method of FIG. 22 may further comprise encrypting the first portion of the series of symbols.

Without further encryption, any full representations of symbols included in the encrypted version of the information, e.g. the series of priming symbols, may be read by any actor with access to the encrypted version of the information. In some implementations, the method of FIG. 22 may further comprise encrypting at least the first portion of the series of symbols (e.g. the priming symbols) of the information to be encrypted 512. In some implementations, after generating the encrypted version of the information, the method of FIG. 22 may further comprise further encrypting at least a portion of the information using the secret key. In some implementations, the encryption system 502 may further encrypt at least one series of priming symbols present in the encrypted version of the information. In some implementations, the entire encrypted version of the information may be further encrypted.

FIG. 23 illustrates an example method of generating an encrypted version of the information, according to some implementations.

Secret key 556 may be obtained by applying obfuscating step 554 to shared secret 514. In the example shown in stippled box 564, shared secret 514 comprises three configuration settings. In the example of FIG. 23, a RC4 stream cipher is applied to the example shared secret 514 shown in box 564. As a result, example secret key 556 shown in box 566 is generated. Then, encrypted first portion 558 is generated based on secret key 556 and the first portion of information to be encrypted 512. The first portion of the information may comprise a series of priming symbols. Specifically, secret key 556 is used to encrypt the first portion of information to be encrypted 512. In the example of FIG. 23, a RC4 stream cipher using the example secret key 556 shown in box 566 is applied to the example first portion of the information to be encrypted 512 shown in box 570, (“The Eiffel”). As a result, example encrypted first portion 558 shown in box 568 is generated. Encrypted version of the information 562 is then generated based on encrypted first portion 558 and series of encrypted code words 560, where series of encrypted code words 560 is generated by the method of FIG. 22. In the illustrated example, the character “|” is used to denote the end of a code word. Specifically, to generate the example encrypted version of the information 562 shown in box 574, the example encrypted first portion 558 shown in box 568 is followed by a reserved symbol (“/”) indicating the end of the first portion. This is followed by the example series of encrypted code words 560 shown in box 572. Finally, the code words are followed by a second reserved symbol (“/”) indicating the end of the series of code words. The use of “/” to represent both reserved symbols is merely an example. In some implementations, the first and second reserved symbols may be different symbols.

To perform decryption, a second instance of the generative model, e.g. generative model 526, is used again in the way described above to map encrypted code words back to full symbols. However, this is only possible if the generative model used for decryption has the same configuration setting(s) as the generative model used for encryption. Therefore, the configuration setting(s) can be considered the secret (e.g. secret “key”) used to decrypt. If the decryption system does not know the secret (the configuration setting(s)), then the decryption system cannot successfully decrypt.

Therefore, in some implementations, the method of FIG. 22 may further comprise securely providing, e.g. from a trusted system, out-of-band, via a key exchange protocol etc., the secret key to a decryption system implementing a generative model, e.g. decryption system 518. In some implementations, information used to obtain the secret key, e.g. the shared secret 514, may be securely provided to the decryption system. In other implementations, the secret key or information used to obtain the secret key may be securely obtained by the decryption system in another way. For example, the decryption system may obtain the secret key by querying another computing system. In some implementations, a decryption system, e.g. decryption system 518, may obtain the secret key by obfuscating an agreed-upon shared secret, e.g. an agreed-upon shared secret comprising at least one configuration setting.

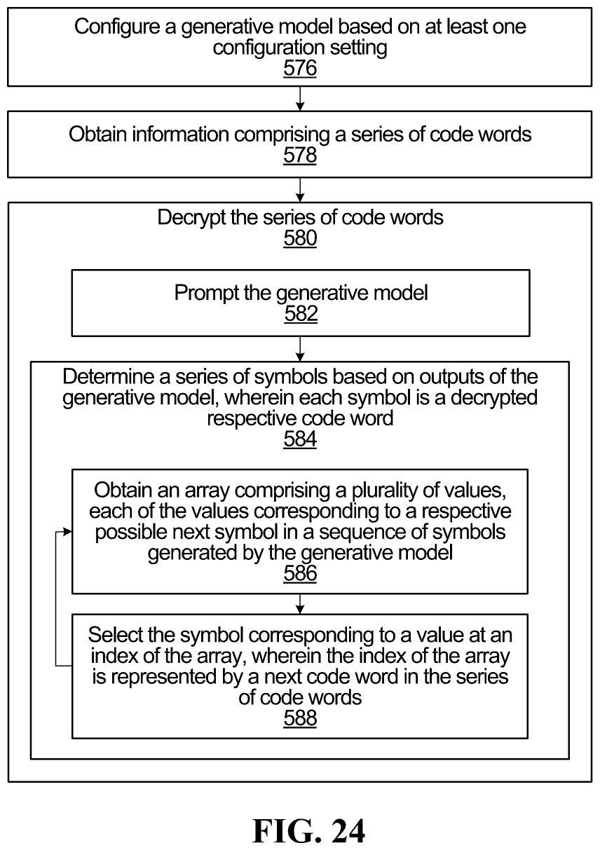

FIG. 24 illustrates an example method performed by decryption system 518.

At step 576, the decryption system 518 configures generative model 526 based on at least one configuration setting, e.g. shared secret 514. The at least one configuration setting may comprise any of the configuration settings described above. In some implementations, the at least one configuration setting, when applied to an instance of the generative model, influences the outputs of the generative model. In some implementations, the at least one configuration setting comprises at least one of a temperature value, a generation seed, a presence penalty, a frequency penalty, or a quantization parameter. In some implementations, the at least one configuration setting may comprise a temperature value of zero. In some implementations, the at least one configuration setting may comprise data used to fine-tune the generative model. In some implementations, the at least one configuration setting may comprise an identifier that corresponds to a particular set of configuration settings.

At step 578, the decryption system 518 obtains encrypted information 528 comprising at least one series of code words. In some implementations, the encrypted information 528 may include at least one series of priming symbols. In some implementations, the encrypted information may include a first portion, comprising a series of priming symbols, and a second portion, comprising a series of code words.

In some implementations, the encrypted information 528 may include at least one indication of the length of at least one series of priming symbols. In some implementations, the encrypted information 528 may include at least one indication of the length of at least one series of code words. For example, encrypted information 528 may comprise a reserved symbol indicating the start and/or end of a series.

At step 580, the decryption system 518 decrypts the series of code words by performing the subsequent steps.

At step 582, the decryption system 518 prompts generative model 526. In some implementations, the generative model 526 may be prompted with a first portion of the encrypted information 528 comprising a series of priming symbols. In some implementations, the generative model 526 may be prompted with a different series of symbols.

At step 584, the decryption system 518 determines a series of symbols, referred to herein as decrypted symbols, based on outputs of the generative model 526, wherein each symbol is a decrypted respective code word.

At sub-step 586, to determine a decrypted symbol (e.g. each decrypted symbol) in the series of decrypted symbols, the decryption system 518 obtains an array comprising a plurality of values, each of the values corresponding to a respective possible next symbol in a sequence of symbols generated by the generative model 526. In some implementations, each of plurality of values in the array is indicative of a probability of the corresponding respective possible next symbol being a next symbol in the symbol sequence generated by the generative model 526.

In some implementations, the array obtained at sub-step 586 may be processed (e.g. sorted) to obtain an ordered list of the top N values corresponding to the top N most probable next symbols in the sequence of symbols generated by the generative model. The value corresponding to the highest probability may be at the first index with the value corresponding to the second highest probability at the second index and so on. In another implementation, another ordering could be employed. For example, the top N probabilities could be identified and then presented in a data structure unsorted. This method may be beneficial in a system that uses code words of a fixed length where sorting the entire array may consume significant computing resources. In some implementations, the array obtained at sub-step 586 may be truncated to a length smaller than the length of the full dictionary of symbols known to the generative model 526. In some implementations, the array obtained at sub-step 586 may be sorted in an order established by an encryption key, e.g. secret key 556, Regardless of how the array is determined and ordered, it may be determined and ordered such that, given the same input, a symbol corresponding to a particular index at the encryption system 502 corresponds to the same particular index at the decryption system 518.

At sub-step 588, to determine a decrypted symbol or each decrypted symbol in the series of decrypted symbols, the decryption system 518 selects the symbol corresponding to a value at an index of the array, wherein the index of the array is represented by a next code word in the series of code words.

The method of FIG. 24 is applied in conjunction with decompression as described above with reference to FIG. 14-FIG. 20. That is, the decompression explained above in relation to FIG. 14-FIG. 20 also provides a decryption because each code word is an encrypted version of its corresponding symbol, and so mapping from the code word to the symbol acts to decrypt. However, it need not necessarily be the case that compression/decompression is performed. Regardless of whether the information is or is not to be decompressed, the generative model 526 may be used to decrypt at least some of the encrypted information 528. Specifically, the series of symbols output using the generative model 526 in the way described above can be considered decrypted symbols of the information, where each symbol may be a decrypted respective code word of the encrypted information. As explained above, this is independent of whether or not compression/decompression happens to be performed. If the code word dictionary is large enough, then compression (and hence decompression at the decoder) might not be achieved, but the code words still act as an encrypted version of the symbols, and the decoder decrypts by mapping those code words back to symbols.

In some implementations, the method of FIG. 24 may further comprise obtaining a secret key representative of at least one configuration setting, e.g. shared secret 514. In some implementations, obtaining the secret key may comprise obfuscating at least some of the at least one configuration setting, e.g. shared secret 514. Obfuscating may involve ciphering, using a stream cipher, at least one portion of the at least one configuration setting, and/or hashing at least one portion of the at least one configuration setting, and/or some other method that is agreed upon by the encryption system 502 and the decryption system 518. In some implementations, obtaining the secret key may comprise securely receiving the secret key, or information used to obtain the secret key, e.g. shared secret 514, from an encoder, e.g. encryption system 502, implementing another instance of the generative model. In some implementations, the secret key or information used to obtain the secret key, e.g. shared secret 514 may be securely received via another method.

In some implementations, the decryption system 518 may receive encrypted information 528 where at least a portion has been further encrypted using the secret key. In some implementations, the first portion of the encrypted information 528, representing priming symbols, may have been further encrypted using the secret key. In some implementations, the method of FIG. 24 may further comprise, prior to prompting the generative model 526, decrypting at least a portion of the encrypted information 528 with the secret key. In some implementations, the encrypted information may comprise a first portion and a second portion, where the second potion comprises a series of code words. The method of FIG. 24 may further comprise decrypting the first portion. The generative model 526 may then be prompted using the first portion after decryption. In some implementations, the secret key may be used to at least decrypt the first portion.

In some implementations, as discussed above, the at least one configuration setting may comprise fine-tuning data. In some implementations, the method of FIG. 24 may further comprise, prior to prompting the generative model 526, obtaining fine-tuning data and performing fine-tuning of the generative model 526 based on the fine-tuning data. In some implementations, fine-tuning data may be based on at least weighting information of the generative model 526. In some implementations, decryption system 518 may obtain fine-tuning data together with encrypted information 528. In some implementations, decryption system 518 may obtain encrypted fine-tuning data. Therefore, in some implementations, the method of FIG. 24 may further comprise, prior to prompting the generative model, decrypting the fine-tuning data. For example, the fine-tuning data may be encrypted and decrypted with the secret key. In some implementations, secret key used at the decoder may be secret key 556, which may be generated at the decoder in the same way explained in relation FIG. 23 using the shared secret 514.

In some implementations, as discussed above, the at least one configuration setting may comprise an identifier that corresponds to a particular set of configuration settings and/or a particular instance of fine-tuning data. Therefore, in some implementations, the method of FIG. 24 may further comprise, obtaining the identifier and determining the particular set of configuration settings and/or particular instance of fine-tuning data, where the at least one configuration setting comprises the particular set of configuration settings and/or particular instance of fine-tuning data.

In some implementations, the decryption system 518, while decrypting, may reconfigure generative model 526 based on a different set of configuration settings while decrypting. For example, a change in configuration settings to be applied to generative model 526 may be indicated in the encrypted information 528.

Technical benefits of some implementations of the encryption and decryption methods described herein include the following. As described earlier, in computer systems it may be important that data be protected from an unauthorized party. By performing encryption, data protection may be ensured. Moreover, by using a generative machine-learning model for the encryption/decryption, a new encoding/decoding method is provided that can leverage existing generative machine-learning models, thereby leveraging existing resources to achieve additional/new technical outcomes (encryption and decryption), rather than expending new computer resources. For example, the computer system may already have stored thereon or access to a generative machine-learning model, e.g. for existing applications. The computer system can now interface with that existing computing resource to also encrypt and/or decrypt data, which is an improvement in use of the existing technology of generative machine-learning. Moreover, the use of a code word to represent an index in an array of values associated with symbols/tokens, rather than using a code word to represent a symbol/token itself, is also a technical improvement. This allows for a dynamic code word dictionary in which the symbol/token associated with the code word can change during encryption. The result may be, in some implementations, robust encryption because the code word is associated with an index in an array, and the (original unencrypted) symbol/token associated with that index in the array can change each iteration, dependent upon how probable it is that the symbol/token is a next symbol/token in the sequence generated by the generative machine-learning model. Encoding/decoding may therefore be improved compared to conventional encryption/decryption. That is, the existing technology related to encryption/decryption can be improved. Moreover, in some implementations it may not be necessary to generate and store a secret key because one or more configuration settings can be used as the shared secret (e.g. shared secret 514), thereby saving computer resources because a separate key for encryption/decryption does not need to be generated. Having a shared secret based on the configuration setting is an improvement because the existing configuration for a generative machine-learning model can also double as a shared secret. Moreover, in some implementations a secret key can be derived from the configuration setting(s) and used to apply a conventional encryption method in addition to the encryption via the code words generated by the generative machine-learning model. This may provide a form of double or nested encryption/decryption, providing improved encryption/decryption compared to just implementing conventional encryption/decryption. Moreover, in some implementations, the same method provides both compression and encryption, thereby saving computer resources by implementing a single method that both compresses and encrypts. Similarly, on the decoder side the same method both decompresses and decrypts, which saves computer resources.

While the methods described herein have been described with respect to compressing and/or encrypting text, similar methods to those described herein could be employed with respect to other types of input data, e.g. images, video etc. In all instances, the input data is information that can be represented by a series of symbols. The symbols do not necessarily have to map to segments of text, but could map to pixels or other data.

### Conclusion

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The following are examples of the present disclosure.

Example 1—A computer-implemented method for performing compression comprising: obtaining information represented as a series of symbols; prompting a generative model; determining a series of code words based on outputs of the generative model, wherein determining each code word in the series of code words comprises: obtaining an array comprising a plurality of values generated by the generative model, each of the values corresponding to a respective possible next symbol in a sequence generated by the generative model; and selecting the code word representing an index of the array at which there is a value corresponding to a next symbol of the information; and generating a compressed version of the information using the series of code words.

Example 2—The method of example 1, wherein the information includes a first portion of the series of symbols and a second portion of the series of symbols; wherein the generative model is prompted using the first portion of the series of symbols; wherein the second portion of the series of symbols is represented by the series of code words; and wherein the first portion of the series of symbols is also used to generate the compressed version of the information.

Example 3—The method of example 2, wherein for at least one of the code words, the method comprises, prior to obtaining the array, prompting the generative model using the first portion and at least one symbol following the first portion.

Example 4—The method of example 1, wherein each of the values in the array is indicative of a probability of the corresponding respective possible next symbol being a next symbol in the symbol sequence generated by the generative model; the method further comprising applying a mask to the values in the array, the mask operating on each value that corresponds to a symbol other than the next symbol of the information to reduce or zero the probability of the corresponding symbol being the next symbol in the symbol sequence generated by the generative model; and wherein the next symbol in the symbol sequence generated by the generative model is determined based on the values after the mask is applied.

Example 5—The method of example 1, wherein a dictionary of code words is used to determine the series of code words, and wherein the method further comprises, subsequent to determining the series of code words, and for a particular output of the generative model: determining that a code word in the dictionary cannot be used to represent the index of the array at which there is a value corresponding to the next symbol in the information; and responsive to the determining, including the next symbol of the information, rather than a code word in the dictionary, as part of the compressed version of the information.

Example 6—The method of example 1, further comprising, prior to prompting the generative model: generating fine-tuning data that is based on at least weighting information of the generative model and a plurality of symbols of the information; and performing fine-tuning of the generative model based on the fine-tuning data.

Example 7—The method of example 6, further comprising storing or transmitting the fine-tuning data together with the compressed version of the information.

Example 8—The method of example 2, wherein at least the first portion of the series of symbols is compressed using a lossless compression method.

Example 9—The method of example 1, wherein each of the values in the array is indicative of a probability of the corresponding respective possible next symbol being a next symbol in the symbol sequence generated by the generative model; the method further comprising, identifying a set of highest probable values in the array, wherein the set of highest probable values contains a number of the values equal to a number of code words in a code word dictionary; and wherein the next symbol of the information corresponds to one of the values in the set of highest probable values.

Example 10—The method of example 1, further comprising: configuring the generative model based on at least one configuration setting; and storing or transmitting the at least one configuration setting along with the compressed version of the information.

Example 11—The method of example 2, wherein the compressed version of the information comprises at least one of: a first reserved symbol preceding the first portion, wherein the first reserved symbol indicates a start of the first portion; a second reserved symbol proceeding the first portion, wherein the second reserved symbol indicates an end of the first portion; a third reserved symbol indicating how many code words are in the series of code words; or a fourth reserved symbol proceeding the series of code words, wherein the fourth reserved symbol indicates an end of the series of code words.

Example 12—A non-transitory computer-readable medium having stored thereon computer-executable instructions that, when executed by a computer, cause the computer to perform operations comprising: obtaining information represented as a series of symbols; prompting a generative model; determining a series of code words based on outputs of the generative model, wherein determining each code word in the series of code words comprises: obtaining an array comprising a plurality of values generated by the generative model, each of the values corresponding to a respective possible next symbol in a sequence generated by the generative model; and selecting the code word representing an index of the array at which there is a value corresponding to a next symbol of the information; and generating a compressed version of the information using the series of code words.

Example 13—The non-transitory computer-readable medium of example 12, wherein the information includes a first portion of the series of symbols and a second portion of the series of symbols; wherein the generative model is prompted using the first portion of the series of symbols; wherein the second portion of the series of symbols is represented by the series of code words; and wherein the first portion of the series of symbols is also used to generate the compressed version of the information.

Example 14—The non-transitory computer-readable medium of example 13, wherein for at least one of the code words, the instructions, when executed by the computer, cause the computer to perform operations further comprising, prior to obtaining the array, prompting the generative model using the first portion and at least one symbol following the first portion.

Example 15—The non-transitory computer-readable medium of example 12, wherein each of the values in the array is indicative of a probability of the corresponding respective possible next symbol being a next symbol in the symbol sequence generated by the generative model; the instructions, when executed by the computer, cause the computer to perform operations further comprising applying a mask to the values in the array, the mask operating on each value that corresponds to a symbol other than the next symbol of the information to reduce or zero the probability of the corresponding symbol being the next symbol in the symbol sequence generated by the generative model; and wherein the next symbol in the symbol sequence generated by the generative model is determined based on the values after the mask is applied.

Example 16—The non-transitory computer-readable medium of example 12, wherein a dictionary of code words is used to determine the series of code words, and wherein the instructions, when executed by the computer, cause the computer to perform operations further comprising, subsequent to determining the series of code words, and for a particular output of the generative model: determining that a code word in the dictionary cannot be used to represent the index of the array at which there is a value corresponding to the next symbol in the information; and responsive to the determining, including the next symbol of the information, rather than a code word in the dictionary, as part of the compressed version of the information.

Example 17—The non-transitory computer-readable medium of example 12, wherein the instructions, when executed by the computer, cause the computer to perform operations further comprising, prior to prompting the generative model: generating fine-tuning data that is based on at least weighting information of the generative model and a plurality of symbols of the information; and performing fine-tuning of the generative model based on the fine-tuning data.

Example 18—The non-transitory computer-readable medium of example 17, wherein the instructions, when executed by the computer, cause the computer to perform operations further comprising storing or transmitting the fine-tuning data together with the compressed version of the information.

Example 19—The non-transitory computer-readable medium of example 13, wherein at least the first portion of the series of symbols is compressed using a lossless compression method.

Example 20—The non-transitory computer-readable medium of example 12, wherein each of the values in the array is indicative of a probability of the corresponding respective possible next symbol being a next symbol in the symbol sequence generated by the generative model; the instructions, when executed by the computer, cause the computer to perform operations further comprising, identifying a set of highest probable values in the array, wherein the set of highest probable values contains a number of the values equal to a number of code words in a code word dictionary; and wherein the next symbol of the information corresponds to one of the values in the set of highest probable values.

Example 21—The non-transitory computer-readable medium of example 12, wherein the instructions, when executed by the computer, cause the computer to perform operations further comprising: configuring the generative model based on at least one configuration setting; and storing or transmitting the at least one configuration setting along with the compressed version of the information.

Example 22—The non-transitory computer-readable medium of example 13, wherein the compressed version of the information comprises at least one of: a first reserved symbol preceding the first portion, wherein the first reserved symbol indicates a start of the first portion; a second reserved symbol proceeding the first portion, wherein the second reserved symbol indicates an end of the first portion; a third reserved symbol indicating how many code words are in the series of code words; or a fourth reserved symbol proceeding the series of code words, wherein the fourth reserved symbol indicates an end of the series of code words.

Example 23—A system comprising: at least one processor; and a memory storing processor-executable instructions that, when executed by the at least one processor, cause the system to: obtain information represented as a series of symbols; prompt a generative model; determine a series of code words based on outputs of the generative model, wherein determining each code word in the series of code words comprises: obtaining an array comprising a plurality of values generated by the generative model, each of the values corresponding to a respective possible next symbol in a sequence generated by the generative model; and selecting the code word representing an index of the array at which there is a value corresponding to a next symbol of the information; and generate a compressed version of the information using the series of code words.

Example 24—The system of example 23, wherein the information includes a first portion of the series of symbols and a second portion of the series of symbols; wherein the generative model is prompted using the first portion of the series of symbols; wherein the second portion of the series of symbols is represented by the series of code words; and wherein the first portion of the series of symbols is also used to generate the compressed version of the information.

Example 25—The system of example 24, wherein for at least one of the code words, the instructions, when executed by the at least one processor, further cause the system to, prior to obtaining the array, prompt the generative model using the first portion and at least one symbol following the first portion.

Example 26—The system of example 23, wherein each of the values in the array is indicative of a probability of the corresponding respective possible next symbol being a next symbol in the symbol sequence generated by the generative model; wherein the instructions, when executed by the at least one processor, further cause the system to apply a mask to the values in the array, the mask operating on each value that corresponds to a symbol other than the next symbol of the information to reduce or zero the probability of the corresponding symbol being the next symbol in the symbol sequence generated by the generative model; and wherein the next symbol in the symbol sequence generated by the generative model is determined based on the values after the mask is applied.

Example 27—The system of example 23, wherein a dictionary of code words is used to determine the series of code words, and wherein the instructions, when executed by the at least one processor, further cause the system to, subsequent to determining the series of code words, and for a particular output of the generative model: determine that a code word in the dictionary cannot be used to represent the index of the array at which there is a value corresponding to the next symbol in the information; and responsive to the determining, include the next symbol of the information, rather than a code word in the dictionary, as part of the compressed version of the information.

Example 28—The system of example 23, wherein the instructions, when executed by the at least one processor, further cause the system to, prior to prompting the generative model: generate fine-tuning data that is based on at least weighting information of the generative model and a plurality of symbols of the information; and perform fine-tuning of the generative model based on the fine-tuning data.

Example 29—The system of example 27, wherein the instructions, when executed by the at least one processor, further cause the system to store or transmit the fine-tuning data together with the compressed version of the information.

Example 30—The system of example 24, wherein at least the first portion of the series of symbols is compressed using a lossless compression method.

Example 31—The system of example 23, wherein each of the values in the array is indicative of a probability of the corresponding respective possible next symbol being a next symbol in the symbol sequence generated by the generative model; wherein the instructions, when executed by the at least one processor, further cause the system to, identify a set of highest probable values in the array, wherein the set of highest probable values contains a number of the values equal to a number of code words in a code word dictionary; and wherein the next symbol of the information corresponds to one of the values in the set of highest probable values.

Example 32—The system of example 23, wherein the instructions, when executed by the at least one processor, further cause the system to: configure the generative model based on at least one configuration setting; and store or transmit the at least one configuration setting along with the compressed version of the information.

Example 33—The system of example 24, wherein the compressed version of the information comprises at least one of: a first reserved symbol preceding the first portion, wherein the first reserved symbol indicates a start of the first portion; a second reserved symbol proceeding the first portion, wherein the second reserved symbol indicates an end of the first portion; a third reserved symbol indicating how many code words are in the series of code words; or a fourth reserved symbol proceeding the series of code words, wherein the fourth reserved symbol indicates an end of the series of code words.

Example 34—A computer-implemented method for performing decompression comprising: obtaining information comprising a series of code words; performing decompression of the information comprising: prompting a generative model; determining a series of symbols based on outputs of the generative model, wherein determining each symbol in the series of symbols comprises: obtaining an array comprising a plurality of values generated by the generative model, each of the values corresponding to a respective possible next symbol in a sequence generated by the generative model; and selecting the symbol corresponding to a value at an index of the array, wherein the index of the array is represented by a next code word in the series of code words; and generating a decompressed version of the information using the series of symbols.

Example 35—The method of example 34, wherein the information includes a first portion and a second portion; wherein the generative model is prompted using the first portion; wherein the second portion comprises the series of code words; and wherein the decompressed version of the information is generated using both the first portion and the series of symbols.

Example 36—The method of example 35, wherein the first portion is a first portion of symbols of the information, and wherein for at least one of the symbols in the series of symbols, the method comprises, prior to obtaining the array, prompting the generative model using the first portion and at least one symbol following the first portion.

Example 37—The method of example 34, wherein each of the values in the array is indicative of a probability of the corresponding respective possible next symbol being a next symbol in the symbol sequence generated by the generative model; the method further comprising applying a mask to the values in the array, the mask operating on each value at an index of the array other than the index of the array represented by the next code word to reduce or zero the probability of the corresponding symbol being the next symbol in the symbol sequence generated by the generative model; and wherein the next symbol in the symbol sequence generated by the generative model is determined based on the values after the mask is applied.

Example 38—The method of example 35, further comprising, subsequent to determining the series of symbols: obtaining a particular symbol from the information rather than a code word; and prompting the generative model using at least the first portion and the particular symbol.

Example 39—The method of example 34, further comprising, prior to prompting the generative model: obtaining fine-tuning data that is based on at least weighting information of the generative model; and performing fine-tuning of the generative model based on the fine-tuning data.

Example 40—The method of example 39, wherein the fine-tuning data is obtained together with the information.

Example 41—The method of example 34, wherein obtaining the information comprises: obtaining an at least partially compressed version of the information, and performing decompression of the at least partially compressed version of the information using a lossless decompression method in order to obtain the information.

Example 42—The method of example 34, wherein each of the values in the array is indicative of a probability of the corresponding respective possible next symbol being a next symbol in the symbol sequence generated by the generative model; the method further comprising, identifying a set of highest probable values in the array, wherein the set of highest probable values contains a number of the values equal to a number of code words in a code word dictionary; and wherein the selected symbol corresponds to one of the values in the set of highest probable values.

Example 43—The method of example 34, further comprising: obtaining at least one configuration setting for the generative model; and prior to prompting the generative model, applying the at least one configuration setting to the generative model.

Example 44—The method of example 35, wherein the information further comprises at least one of: a first reserved symbol preceding the first portion, wherein the first reserved symbol indicates a start of the first portion; a second reserved symbol proceeding the first portion, wherein the second reserved symbol indicates an end of the first portion; a third reserved symbol indicating how many code words are in the series of code words; or a fourth reserved symbol proceeding the series of code words, wherein the fourth reserved symbol indicates an end of the series of code words.

Example 45—A non-transitory computer-readable medium having stored thereon computer-executable instructions that, when executed by a computer, cause the computer to perform operations comprising: obtaining information comprising a series of code words; performing decompression of the information comprising: prompting a generative model; determining a series of symbols based on outputs of the generative model, wherein determining each symbol in the series of symbols comprises: obtaining an array comprising a plurality of values generated by the generative model, each of the values corresponding to a respective possible next symbol in a sequence generated by the generative model; and selecting the symbol corresponding to a value at an index of the array, wherein the index of the array is represented by a next code word in the series of code words; and generating a decompressed version of the information using the series of symbols

Example 46—The non-transitory computer-readable medium of example 45, wherein the information includes a first portion and a second portion; wherein the generative model is prompted using the first portion; wherein the second portion comprises the series of code words; and wherein the decompressed version of the information is generated using both the first portion and the series of symbols.

Example 47—The non-transitory computer-readable medium of example 46, wherein the first portion is a first portion of symbols of the information, and wherein for at least one of the symbols in the series of symbols, the instructions, when executed by the computer, cause the computer to perform operations further comprising, prior to obtaining the array, prompting the generative model using the first portion and at least one symbol following the first portion.

Example 48—The non-transitory computer-readable medium of example 45, wherein each of the values in the array is indicative of a probability of the corresponding respective possible next symbol being a next symbol in the symbol sequence generated by the generative model; wherein the instructions, when executed by the computer, cause the computer to perform operations further comprising applying a mask to the values in the array, the mask operating on each value at an index of the array other than the index of the array represented by the next code word to reduce or zero the probability of the corresponding symbol being the next symbol in the symbol sequence generated by the generative model; and wherein the next symbol in the symbol sequence generated by the generative model is determined based on the values after the mask is applied.

Example 49—The non-transitory computer-readable medium of example 46, wherein the instructions, when executed by the computer, cause the computer to perform operations further comprising, subsequent to determining the series of symbols: obtaining a particular symbol from the information rather than a code word; and prompting the generative model using at least the first portion and the particular symbol.

Example 50—The non-transitory computer-readable medium of example 45, wherein the instructions, when executed by the computer, cause the computer to perform operations further comprising, prior to prompting the generative model: obtaining fine-tuning data that is based on at least weighting information of the generative model; and performing fine-tuning of the generative model based on the fine-tuning data.

Example 51—The non-transitory computer-readable medium of example 50, wherein the fine-tuning data is obtained together with the information.

Example 52—The non-transitory computer-readable medium of example 45, wherein obtaining the information comprises: obtaining an at least partially compressed version of the information, and performing decompression of the at least partially compressed version of the information using a lossless decompression method in order to obtain the information.

Example 53—The non-transitory computer-readable medium of example 45, wherein each of the values in the array is indicative of a probability of the corresponding respective possible next symbol being a next symbol in the symbol sequence generated by the generative model; wherein the instructions, when executed by the computer, cause the computer to perform operations further comprising identifying a set of highest probable values in the array, wherein the set of highest probable values contains a number of the values equal to a number of code words in a code word dictionary; and wherein the selected symbol corresponds to one of the values in the set of highest probable values.

Example 54—The non-transitory computer-readable medium of example 45, wherein the instructions, when executed by the computer, cause the computer to perform operations further comprising: obtaining at least one configuration setting for the generative model; and prior to prompting the generative model, applying the at least one configuration setting to the generative model.

Example 55—The non-transitory computer-readable medium of example 46, wherein the information further comprises at least one of: a first reserved symbol preceding the first portion, wherein the first reserved symbol indicates a start of the first portion; a second reserved symbol proceeding the first portion, wherein the second reserved symbol indicates an end of the first portion; a third reserved symbol indicating how many code words are in the series of code words; or a fourth reserved symbol proceeding the series of code words, wherein the fourth reserved symbol indicates an end of the series of code words.

Example 56—A system comprising: at least one processor; and a memory storing processor-executable instructions that, when executed by the at least one processor, cause the system to: obtain information comprising a series of code words; perform decompression of the information comprising: prompting a generative model; determining a series of symbols based on outputs of the generative model, wherein determining each symbol in the series of symbols comprises: obtaining an array comprising a plurality of values generated by the generative model, each of the values corresponding to a respective possible next symbol in a sequence generated by the generative model; and selecting the symbol corresponding to a value at an index of the array, wherein the index of the array is represented by a next code word in the series of code words; and generating a decompressed version of the information using the series of symbols.

Example 57—The system of example 56, wherein the information includes a first portion and a second portion; wherein the generative model is prompted using the first portion; wherein the second portion comprises the series of code words; and wherein the decompressed version of the information is generated using both the first portion and the series of symbols.

Example 58—The system of example 57, wherein the first portion is a first portion of symbols of the information, and wherein for at least one of the symbols in the series of symbols, the instructions, when executed by the at least one processor, further cause the system to, prior to obtaining the array, prompt the generative model using the first portion and at least one symbol following the first portion.

Example 59—The system of example 56, wherein each of the values in the array is indicative of a probability of the corresponding respective possible next symbol being a next symbol in the symbol sequence generated by the generative model; wherein the instructions, when executed by the at least one processor, further cause the system to apply a mask to the values in the array, the mask operating on each value at an index of the array other than the index of the array represented by the next code word to reduce or zero the probability of the corresponding symbol being the next symbol in the symbol sequence generated by the generative model; and wherein the next symbol in the symbol sequence generated by the generative model is determined based on the values after the mask is applied.

Example 60—The system of example 57, wherein the instructions, when executed by the at least one processor, further cause the system to, subsequent to determining the series of symbols: obtain a particular symbol from the information rather than a code word; and prompt the generative model using at least the first portion and the particular symbol.

Example 61—The system of example 56, wherein the instructions, when executed by the at least one processor, further cause the system to, prior to prompting the generative model: obtain fine-tuning data that is based on at least weighting information of the generative model; and perform fine-tuning of the generative model based on the fine-tuning data.

Example 62—The system of example 61, wherein the fine-tuning data is obtained together with the information.

Example 63—The system of example 56, wherein obtaining the information comprises: obtaining an at least partially compressed version of the information, and performing decompression of the at least partially compressed version of the information using a lossless decompression method in order to obtain the information.

Example 64—The system of example 56, wherein each of the values in the array is indicative of a probability of the corresponding respective possible next symbol being a next symbol in the symbol sequence generated by the generative model; wherein the instructions, when executed by the at least one processor, further cause the system to, identify a set of highest probable values in the array, wherein the set of highest probable values contains a number of the values equal to a number of code words in a code word dictionary; and wherein the selected symbol corresponds to one of the values in the set of highest probable values.

Example 65—The system of example 56, wherein the instructions, when executed by the at least one processor, further cause the system to: obtain at least one configuration setting for the generative model; and prior to prompting the generative model, apply the at least one configuration setting to the generative model.

Example 66—The system of example 57, wherein the information further comprises at least one of: a first reserved symbol preceding the first portion, wherein the first reserved symbol indicates a start of the first portion; a second reserved symbol proceeding the first portion, wherein the second reserved symbol indicates an end of the first portion; a third reserved symbol indicating how many code words are in the series of code words; or a fourth reserved symbol proceeding the series of code words, wherein the fourth reserved symbol indicates an end of the series of code words.

Example 67—A computer-implemented method for performing encryption comprising: configuring a generative model based on at least one configuration setting; obtaining information represented as a series of symbols; encrypting at least some of the information by: prompting the generative model; and determining a series of code words based on outputs of the generative model, wherein each code word is an encrypted respective symbol of the information, and wherein determining each code word in the series of code words comprises: obtaining an array comprising a plurality of values generated by the generative model, each of the values corresponding to a respective possible next symbol in a sequence generated by the generative model; and selecting the code word representing an index of the array at which there is a value corresponding to a next symbol of the information.

Example 68—The method of example 67, wherein the information includes a first portion of the series of symbols and a second portion of the series of symbols; wherein the generative model is prompted using the first portion of the series of symbols; wherein the second portion of the series of symbols is represented by the series of code words; and the method further comprises encrypting the first portion of the series of symbols.

Example 69—The method of example 68, further comprising obtaining a secret key representative of the at least one configuration setting, and wherein the secret key is used to at least encrypt the first portion of the series of symbols.

Example 70—The method of example 69, wherein obtaining the secret key comprises obfuscating at least some of the at least one configuration setting.

Example 71—The method of example 67, wherein the at least one configuration setting, when applied to an instance of the generative model, influences outputs of the generative model.

Example 72—The method of example 71, wherein the at least one configuration setting comprises at least one of a temperature value, a generation seed, a presence penalty, a frequency penalty, or a quantization parameter.

Example 73—The method of example 71, wherein the at least one configuration setting comprises a temperature value of zero.

Example 74—The method of example 67, further comprising, prior to prompting the generative model: generating fine-tuning data that is based on at least weighting information of the generative model and a plurality of symbols of the information; and performing fine-tuning of the generative model based on the fine-tuning data.

Example 75—The method of example 74, wherein the plurality of symbols of the information comprises an initial portion of the information.

Example 76—The method of example 74, wherein the plurality of symbols of the information comprises sampled symbols of the information.

Example 77—The method of example 67, further comprising: obtaining an identifier corresponding to a particular set of configuration settings; and determining the particular set of configuration settings corresponding to the identifier, wherein the at least one configuration setting comprises the particular set of configuration settings.

Example 78—The method of example 69, wherein the generative model is a first instance of the generative model, further comprising securely providing the secret key to a decoder implementing a second instance of the generative model.

Example 79—A non-transitory computer-readable medium having stored thereon computer-executable instructions that, when executed by a computer, cause the computer to perform operations comprising: configuring a generative model based on at least one configuration setting; obtaining information represented as a series of symbols; encrypting at least some of the information by: prompting the generative model; and determining a series of code words based on outputs of the generative model, wherein each code word is an encrypted respective symbol of the information, and wherein determining each code word in the series of code words comprises: obtaining an array comprising a plurality of values generated by the generative model, each of the values corresponding to a respective possible next symbol in a sequence generated by the generative model; and selecting the code word representing an index of the array at which there is a value corresponding to a next symbol of the information.

Example 80—The non-transitory computer-readable medium of example 79, wherein the information includes a first portion of the series of symbols and a second portion of the series of symbols; wherein the generative model is prompted using the first portion of the series of symbols; wherein the second portion of the series of symbols is represented by the series of code words; and wherein the instructions, when executed by the computer, cause the computer to perform operations further comprising encrypting the first portion of the series of symbols.

Example 81—The non-transitory computer-readable medium of example 80, wherein the instructions, when executed by the computer, cause the computer to perform operations further comprising obtaining a secret key representative of the at least one configuration setting, and wherein the secret key is used to at least encrypt the first portion of the series of symbols.

Example 82—The non-transitory computer-readable medium of example 81, wherein obtaining the secret key comprises obfuscating at least some of the at least one configuration setting.

Example 83—The non-transitory computer-readable medium of example 79, wherein the at least one configuration setting, when applied to an instance of the generative model, influences outputs of the generative model.

Example 84—The non-transitory computer-readable medium of example 83, wherein the at least one configuration setting comprises at least one of a temperature value, a generation seed, a presence penalty, a frequency penalty, or a quantization parameter.

Example 85—The non-transitory computer-readable medium of example 83, wherein the at least one configuration setting comprises a temperature value of zero.

Example 86—The non-transitory computer-readable medium of example 79, wherein the instructions, when executed by the computer, cause the computer to perform operations further comprising, prior to prompting the generative model: generating fine-tuning data that is based on at least weighting information of the generative model and a plurality of symbols of the information; and performing fine-tuning of the generative model based on the fine-tuning data.

Example 87—The non-transitory computer-readable medium of example 86, wherein the plurality of symbols of the information comprises an initial portion of the information.

Example 88—The non-transitory computer-readable medium of example 86, wherein the plurality of symbols of the information comprises sampled symbols of the information.

Example 89—The non-transitory computer-readable medium of example 79, wherein the instructions, when executed by the computer, cause the computer to perform operations further comprising: obtaining an identifier corresponding to a particular set of configuration settings; and determining the particular set of configuration settings corresponding to the identifier, wherein the at least one configuration setting comprises the particular set of configuration settings.

Example 90—The non-transitory computer-readable medium of example 81, wherein the generative model is a first instance of the generative model; and wherein the instructions, when executed by the computer, cause the computer to perform operations further comprising securely providing the secret key to a decoder implementing a second instance of the generative model.

Example 91—A system comprising: at least one processor; and a memory storing processor-executable instructions that, when executed by the at least one processor, cause the system to: configure a generative model based on at least one configuration setting; obtain information represented as a series of symbols; encrypt at least some of the information by: prompting the generative model; and determining a series of code words based on outputs of the generative model, wherein each code word is an encrypted respective symbol of the information, and wherein determining each code word in the series of code words comprises: obtaining an array comprising a plurality of values generated by the generative model, each of the values corresponding to a respective possible next symbol in a sequence generated by the generative model; and selecting the code word representing an index of the array at which there is a value corresponding to a next symbol of the information.

Example 92—The system of example 91, wherein the information includes a first portion of the series of symbols and a second portion of the series of symbols; wherein the generative model is prompted using the first portion of the series of symbols; wherein the second portion of the series of symbols is represented by the series of code words; and wherein the instructions, when executed by the at least one processor, further cause the system to encrypt the first portion of the series of symbols.

Example 93—The system of example 92, wherein the instructions, when executed by the at least one processor, further cause the system to obtain a secret key representative of the at least one configuration setting, and wherein the secret key is used to at least encrypt the first portion of the series of symbols.

Example 94—The system of example 93, wherein obtaining the secret key comprises obfuscating at least some of the at least one configuration setting.

Example 95—The system of example 91, wherein the at least one configuration setting, when applied to an instance of the generative model, influences outputs of the generative model.

Example 96—The system of example 95, wherein the at least one configuration setting comprises at least one of a temperature value, a generation seed, a presence penalty, a frequency penalty, or a quantization parameter.

Example 97—The system of example 95, wherein the at least one configuration setting comprises a temperature value of zero.

Example 98—The system of example 91, wherein the instructions, when executed by the at least one processor, further cause the system to, prior to prompting the generative model: generate fine-tuning data that is based on at least weighting information of the generative model and a plurality of symbols of the information; and perform fine-tuning of the generative model based on the fine-tuning data.

Example 99—The system of example 98, wherein the plurality of symbols of the information comprises an initial portion of the information.

Example 100—The system of example 98, wherein the plurality of symbols of the information comprises sampled symbols of the information.

Example 101—The system of example 91, wherein the instructions, when executed by the at least one processor, further cause the system to: obtain an identifier corresponding to a particular set of configuration settings; and determine the particular set of configuration settings corresponding to the identifier, wherein the at least one configuration setting comprises the particular set of configuration settings.

Example 102—The system of example 93, wherein the generative model is a first instance of the generative model, wherein the instructions, when executed by the at least one processor, further cause the system to securely provide the secret key to a decoder implementing a second instance of the generative model.

Example 103—A computer-implemented method for performing decryption, comprising: configuring a generative model based on at least one configuration setting; obtaining information comprising a series of code words; decrypting the series of code words by: prompting the generative model; and determining a series of symbols based on outputs of the generative model, wherein each symbol is a decrypted respective code word, and wherein determining each symbol in the series of symbols comprises: obtaining an array comprising a plurality of values generated by the generative model, each of the values corresponding to a respective possible next symbol in a sequence generated by the generative model; and selecting the symbol corresponding to a value at an index of the array, wherein the index of the array is represented by a next code word in the series of code words.

Example 104—The method of example 103, wherein the information includes a first portion and a second portion; wherein the second portion comprises the series of code words; and the method further comprises decrypting the first portion, and wherein the generative model is prompted using the first portion after decryption of the first portion.

Example 105—The method of example 104, further comprising obtaining a secret key representative of the at least one configuration setting, and wherein the secret key is used to at least decrypt the first portion.

Example 106—The method of example 105, wherein obtaining the secret key comprises obfuscating at least some of the at least one configuration setting.

Example 107—The method of example 103, wherein the at least one configuration setting, when applied to an instance of the generative model, influences outputs of the generative model.

Example 108—The method of example 107, wherein the at least one configuration setting comprises at least one of a temperature value, a generation seed, a presence penalty, a frequency penalty, or a quantization parameter.

Example 109—The method of example 107, wherein the at least one configuration setting comprises a temperature value of zero.

Example 110—The method of example 103, further comprising, prior to prompting the generative model: obtaining fine-tuning data that is based on at least weighting information of the generative model; and performing fine-tuning of the generative model based on the fine-tuning data.

Example 111—The method of example 110, wherein the fine-tuning data is obtained together with the information.

Example 112—The method of example 110, wherein the fine-tuning data has been encrypted, and the method further comprises: prior to performing fine-tuning of the generative model, decrypting the fine-tuning data.

Example 113—The method of example 103, further comprising: obtaining an identifier corresponding to a particular set of configuration settings; and determining the particular set of configuration settings corresponding to the identifier, wherein the at least one configuration setting comprises the particular set of configuration settings.

Example 114—The method of example 105, wherein the generative model is a second instance of the generative model, wherein obtaining the secret key comprises securely receiving the secret key from an encoder implementing a first instance of the generative model.

Example 115—A non-transitory computer-readable medium having stored thereon computer-executable instructions that, when executed by a computer, cause the computer to perform operations comprising: configuring a generative model based on at least one configuration setting; obtaining information comprising a series of code words; decrypting the series of code words by: prompting the generative model; and determining a series of symbols based on outputs of the generative model, wherein each symbol is a decrypted respective code word, and wherein determining each symbol in the series of symbols comprises: obtaining an array comprising a plurality of values generated by the generative model, each of the values corresponding to a respective possible next symbol in a sequence generated by the generative model; and selecting the symbol corresponding to a value at an index of the array, wherein the index of the array is represented by a next code word in the series of code words.

Example 116—The non-transitory computer-readable medium of example 115, wherein the information includes a first portion and a second portion; wherein the second portion comprises the series of code words; and wherein the instructions, when executed by the computer, cause the computer to perform operations further comprising decrypting the first portion, and wherein the generative model is prompted using the first portion after decryption of the first portion.

Example 117—The non-transitory computer-readable medium of example 116, wherein the instructions, when executed by the computer, cause the computer to perform operations further comprising obtaining a secret key representative of the at least one configuration setting, and wherein the secret key is used to at least decrypt the first portion.

Example 118—The non-transitory computer-readable medium of example 117, wherein obtaining the secret key comprises obfuscating at least some of the at least one configuration setting.

Example 119—The non-transitory computer-readable medium of example 115, wherein the at least one configuration setting, when applied to an instance of the generative model, influences outputs of the generative model.

Example 120—The non-transitory computer-readable medium of example 119, wherein the at least one configuration setting comprises at least one of a temperature value, a generation seed, a presence penalty, a frequency penalty, or a quantization parameter.

Example 121—The non-transitory computer-readable medium of example 119, wherein the at least one configuration setting comprises a temperature value of zero.

Example 122—The non-transitory computer-readable medium of example 115, wherein the instructions, when executed by the computer, cause the computer to perform operations further comprising, prior to prompting the generative model: obtaining fine-tuning data that is based on at least weighting information of the generative model; and performing fine-tuning of the generative model based on the fine-tuning data.

Example 123—The non-transitory computer-readable medium of example 122, wherein the fine-tuning data is obtained together with the information.

Example 124—The non-transitory computer-readable medium of example 122, wherein the fine-tuning data has been encrypted, and wherein the instructions, when executed by the computer, cause the computer to perform operations further comprising, prior to performing fine-tuning of the generative model, decrypting the fine-tuning data.

Example 125—The non-transitory computer-readable medium of example 115, wherein the instructions, when executed by the computer, cause the computer to perform operations further comprising: obtaining an identifier corresponding to a particular set of configuration settings; and determining the particular set of configuration settings corresponding to the identifier, wherein the at least one configuration setting comprises the particular set of configuration settings.

Example 126—The non-transitory computer-readable medium of example 117, wherein the generative model is a second instance of the generative model, wherein obtaining the secret key comprises securely receiving the secret key from an encoder implementing a first instance of the generative model.

Example 127—A system comprising: at least one processor; and a memory storing processor-executable instructions that, when executed by the at least one processor, cause the system to: configure a generative model based on at least one configuration setting; obtain information comprising a series of code words; decrypt the series of code words by: prompting the generative model; and determining a series of symbols based on outputs of the generative model, wherein each symbol is a decrypted respective code word, and wherein determining each symbol in the series of symbols comprises: obtaining an array comprising a plurality of values generated by the generative model, each of the values corresponding to a respective possible next symbol in a sequence generated by the generative model; and selecting the symbol corresponding to a value at an index of the array, wherein the index of the array is represented by a next code word in the series of code words.

Example 128—The system of example 127, wherein the information includes a first portion and a second portion; wherein the second portion comprises the series of code words; and wherein the instructions, when executed by the at least one processor, further cause the system to decrypt the first portion, and wherein the generative model is prompted using the first portion after decryption of the first portion.

Example 129—The system of example 128, wherein the instructions, when executed by the at least one processor, further cause the system to obtain a secret key representative of the at least one configuration setting, and wherein the secret key is used to at least decrypt the first portion.

Example 130—The system of example 129, wherein obtaining the secret key comprises obfuscating at least some of the at least one configuration setting.

Example 131—The system of example 127, wherein the at least one configuration setting, when applied to an instance of the generative model, influences outputs of the generative model.

Example 132—The system of example 131, wherein the at least one configuration setting comprises at least one of a temperature value, a generation seed, a presence penalty, a frequency penalty, or a quantization parameter.

Example 133—The system of example 131, wherein the at least one configuration setting comprises a temperature value of zero.

Example 134—The system of example 127, wherein the instructions, when executed by the at least one processor, further cause the system to, prior to prompting the generative model: obtain fine-tuning data that is based on at least weighting information of the generative model; and perform fine-tuning of the generative model based on the fine-tuning data.

Example 135—The system of example 134, wherein the fine-tuning data is obtained together with the information.

Example 136—The system of example 134, wherein the fine-tuning data has been encrypted, and wherein the instructions, when executed by the at least one processor, further cause the system to: prior to performing fine-tuning of the generative model, decrypt the fine-tuning data.

Example 137—The system of example 127, wherein the instructions, when executed by the at least one processor, further cause the system to: obtain an identifier corresponding to a particular set of configuration settings; and determine the particular set of configuration settings corresponding to the identifier, wherein the at least one configuration setting comprises the particular set of configuration settings.

Example 138—The system of example 129, wherein the generative model is a second instance of the generative model, wherein obtaining the secret key comprises securely receiving the secret key from an encoder implementing a first instance of the generative model.

1. A computer-implemented method for performing decryption, comprising:
configuring a generative model based on at least one configuration setting;
obtaining information comprising a series of code words;
decrypting the series of code words by:
prompting the generative model; and
determining a series of symbols based on outputs of the generative model, wherein each symbol is a decrypted respective code word, and wherein determining each symbol in the series of symbols comprises:
obtaining an array comprising a plurality of values generated by the generative model, each of the values corresponding to a respective possible next symbol in a sequence generated by the generative model; and
selecting the symbol corresponding to a value at an index of the array, wherein the index of the array is represented by a next code word in the series of code words.

2. The method of claim 1:
wherein the information includes a first portion and a second portion;
wherein the second portion comprises the series of code words; and
the method further comprises decrypting the first portion, and wherein the generative model is prompted using the first portion after decryption of the first portion.

3. The method of claim 2, further comprising obtaining a secret key representative of the at least one configuration setting, and wherein the secret key is used to at least decrypt the first portion.

4. The method of claim 3, wherein obtaining the secret key comprises obfuscating at least some of the at least one configuration setting.

5. The method of claim 1, wherein the at least one configuration setting, when applied to an instance of the generative model, influences outputs of the generative model.

6. The method of claim 5, wherein the at least one configuration setting comprises at least one of a temperature value, a generation seed, a presence penalty, a frequency penalty, or a quantization parameter.

7. The method of claim 5, wherein the at least one configuration setting comprises a temperature value of zero.

8. The method of claim 1, further comprising, prior to prompting the generative model:
obtaining fine-tuning data that is based on at least weighting information of the generative model; and
performing fine-tuning of the generative model based on the fine-tuning data.

9. The method of claim 8, wherein the fine-tuning data is obtained together with the information.

10. The method of claim 8, wherein the fine-tuning data has been encrypted, and the method further comprises: prior to performing fine-tuning of the generative model, decrypting the fine-tuning data.

11. The method of claim 1, further comprising:
obtaining an identifier corresponding to a particular set of configuration settings; and
determining the particular set of configuration settings corresponding to the identifier, wherein the at least one configuration setting comprises the particular set of configuration settings.

12. The method of claim 3, wherein the generative model is a second instance of the generative model, wherein obtaining the secret key comprises securely receiving the secret key from an encoder implementing a first instance of the generative model.

13. A non-transitory computer-readable medium having stored thereon computer-executable instructions that, when executed by a computer, cause the computer to perform operations comprising:
configuring a generative model based on at least one configuration setting;
obtaining information comprising a series of code words;
decrypting the series of code words by:
prompting the generative model; and
determining a series of symbols based on outputs of the generative model, wherein each symbol is a decrypted respective code word, and wherein determining each symbol in the series of symbols comprises:
obtaining an array comprising a plurality of values generated by the generative model, each of the values corresponding to a respective possible next symbol in a sequence generated by the generative model; and
selecting the symbol corresponding to a value at an index of the array, wherein the index of the array is represented by a next code word in the series of code words.

14. The non-transitory computer-readable medium of claim 13:
wherein the information includes a first portion and a second portion;
wherein the second portion comprises the series of code words; and
wherein the instructions, when executed by the computer, cause the computer to perform operations further comprising decrypting the first portion, and wherein the generative model is prompted using the first portion after decryption of the first portion.

15. The non-transitory computer-readable medium of claim 14, wherein the instructions, when executed by the computer, cause the computer to perform operations further comprising obtaining a secret key representative of the at least one configuration setting, and wherein the secret key is used to at least decrypt the first portion.

16. The non-transitory computer-readable medium of claim 15, wherein obtaining the secret key comprises obfuscating at least some of the at least one configuration setting.

17. The non-transitory computer-readable medium of claim 13, wherein the at least one configuration setting, when applied to an instance of the generative model, influences outputs of the generative model.

18. The non-transitory computer-readable medium of claim 17, wherein the at least one configuration setting comprises at least one of a temperature value, a generation seed, a presence penalty, a frequency penalty, or a quantization parameter.

19. The non-transitory computer-readable medium of claim 13, wherein the instructions, when executed by the computer, cause the computer to perform operations further comprising, prior to prompting the generative model:
obtaining fine-tuning data that is based on at least weighting information of the generative model; and
performing fine-tuning of the generative model based on the fine-tuning data.

20. A system comprising:
at least one processor; and
a memory storing processor-executable instructions that, when executed by the at least one processor, cause the system to:
configure a generative model based on at least one configuration setting;
obtain information comprising a series of code words;
decrypt the series of code words by:
prompting the generative model; and
determining a series of symbols based on outputs of the generative model, wherein each symbol is a decrypted respective code word, and wherein determining each symbol in the series of symbols comprises:
obtaining an array comprising a plurality of values generated by the generative model, each of the values corresponding to a respective possible next symbol in a sequence generated by the generative model; and
selecting the symbol corresponding to a value at an index of the array, wherein the index of the array is represented by a next code word in the series of code words.
